(19) United States
(12) Patent Application Publication
(10) Pub. No.: US 2025/0350768 A1
(43) Pub. Date: Nov. 13, 2025

(54) SYSTEMS AND METHODS FOR SIGNALING PICTURE INFORMATION IN VIDEO CODING

(71) Applicant: Sharp Kabushiki Kaisha, Sakai City (JP)

(72) Inventors: Sachin G. DESHPANDE, Vancouver, WA (US); Jonatan SAMUELSSON, Vancouver, WA (US)

(21) Appl. No.: 19/273,823

(22) Filed: Jul. 18, 2025

Related U.S. Application Data
(63) Continuation of application No. 17/771,031, filed on Apr. 22, 2022, now Pat. No. 12,407,864.
(60) Provisional application No. 62/926,299, filed on Oct. 25, 2019.
(60) Provisional application No. 62/944,217, filed on Dec. 5, 2019.
(60) Provisional application No. 62/952,255, filed on Dec. 21, 2019.

(51) Int. Cl. H04N 19/70; H04N 19/105; H04N 19/139; H04N 19/172; H04N 19/52

(52) U.S. Cl. CPC H04N 19/70; H04N 19/105; H04N 19/139; H04N 19/172; H04N 19/52

(57) ABSTRACT

This disclosure relates to video coding and more particularly to techniques for signaling picture information for coded video. According to an aspect of an invention, first syntax element specifying an index corresponding to a collocated picture used for temporal motion vector prediction is parsed from a picture header in a case that both (a) first flag indicating whether temporal motion vector predictor can be enabled for a picture associated with the picture header and (b) second flag indicating information associated with reference picture list are equal to 1.

### TECHNICAL FIELD

This disclosure relates to video coding and more particularly to techniques for signaling picture information for coded video.

### BACKGROUND ART

Digital video capabilities can be incorporated into a wide range of devices, including digital televisions, laptop or desktop computers, tablet computers, digital recording devices, digital media players, video gaming devices, cellular telephones, including so-called smartphones, medical imaging devices, and the like. Digital video may be coded according to a video coding standard. Video coding standards define the format of a compliant bitstream encapsulating coded video data. A compliant bitstream is a data structure that may be received and decoded by a video decoding device to generate reconstructed video data. Video coding standards may incorporate video compression techniques. Examples of video coding standards include ISO/IEC MPEG-4 Visual and ITU-T H.264 (also known as ISO/IEC MPEG-4 AVC) and High-Efficiency Video Coding (HEVC). HEVC is described in High Efficiency Video Coding (HEVC), Rec. ITU-T H.265, December 2016, which is incorporated by reference, and referred to herein as ITU-T H.265. Extensions and improvements for ITU-T H.265 are currently being considered for the development of next generation video coding standards. For example, the ITU-T Video Coding Experts Group (VCEG) and ISO/IEC (Moving Picture Experts Group (MPEG) (collectively referred to as the Joint Video Exploration Team (JVET)) are working to standardized video coding technology with a compression capability that significantly exceeds that of the current HEVC standard. The Joint Exploration Model 7 (JEM 7), Algorithm Description of Joint Exploration Test Model 7 (JEM 7), ISO/IEC JTCI/SC29/WG11 Document: JVET-G1001, July 2017, Torino, IT, which is incorporated by reference herein, describes the coding features that were under coordinated test model study by the JVET as potentially enhancing video coding technology beyond the capabilities of ITU-T H.265. It should be noted that the coding features of JEM 7 are implemented in JEM reference software. As used herein, the term JEM may collectively refer to algorithms included in JEM 7 and implementations of JEM reference software. Further, in response to a “Joint Call for Proposals on Video Compression with Capabilities beyond HEVC,” jointly issued by VCEG and MPEG, multiple descriptions of video coding tools were proposed by various groups at the 10th Meeting of ISO/IEC JTCI/SC29/WG11 16-20 Apr. 2018, San Diego, CA. From the multiple descriptions of video coding tools, a resulting initial draft text of a video coding specification is described in “Versatile Video Coding (Draft 1),” 10th Meeting of ISO/IEC JTC1/SC29/WG11 16-20 Apr. 2018, San Diego, CA, document JVET-J1001-v2, which is incorporated by reference herein, and referred to as JVET-J1001. The current development of a next generation video coding standard by the VCEG and MPEG is referred to as the Versatile Video Coding (VVC) project. “Versatile Video Coding (Draft 7),” 16th Meeting of ISO/IEC JTC1/SC29/WG11 1-11 Oct. 2019, Geneva, CH, document JVET-P2001-v9, which is incorporated by reference herein, and referred to as JVET-P2001, represents the current iteration of the draft text of a video coding specification corresponding to the VVC project.

Video compression techniques enable data requirements for storing and transmitting video data to be reduced. Video compression techniques may reduce data requirements by exploiting the inherent redundancies in a video sequence. Video compression techniques may sub-divide a video sequence into successively smaller portions (i.e., groups of pictures within a video sequence, a picture within a group of pictures, regions within a picture, sub-regions within regions, etc.). Intra prediction coding techniques (e.g., spatial prediction techniques within a picture) and inter prediction techniques (i.e., inter-picture techniques (temporal)) may be used to generate difference values between a unit of video data to be coded and a reference unit of video data. The difference values may be referred to as residual data. Residual data may be coded as quantized transform coefficients. Syntax elements may relate residual data and a reference coding unit (e.g., intra-prediction mode indices, and motion information). Residual data and syntax elements may be entropy coded. Entropy encoded residual data and syntax elements may be included in data structures forming a compliant bitstream.

### SUMMARY OF INVENTION

In one example, a method of decoding video data, the method comprises: receiving a picture header; and in a case that both (a) first flag indicating whether temporal motion vector predictor can be enabled for a picture associated with the picture header and (b) second flag indicating information associated with reference picture list are equal to 1; parsing from the picture header first syntax element specifying an index corresponding to a collocated picture used for temporal motion vector prediction.

In one example, a device of comprises one or more processors configured to: receive a picture header; in a case that both (a) first flag indicating whether temporal motion vector predictor can be enabled for a picture associated with the picture header and (b) second flag indicating information associated with reference picture list are equal to 1; parse from the picture header first syntax element specifying an index corresponding to a collocated picture used for temporal motion vector prediction.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example of a system that may be configured to encode and decode video data according to one or more techniques of this disclosure.

FIG. 2 is a conceptual diagram illustrating coded video data and corresponding data structures according to one or more techniques of this disclosure.

FIG. 3 is a conceptual diagram illustrating a data structure encapsulating coded video data and corresponding metadata according to one or more techniques of this disclosure.

FIG. 4 is a conceptual drawing illustrating an example of components that may be included in an implementation of a system that may be configured to encode and decode video data according to one or more techniques of this disclosure.

FIG. 5 is a block diagram illustrating an example of a video encoder that may be configured to encode video data according to one or more techniques of this disclosure.

FIG. 6 is a block diagram illustrating an example of a video decoder that may be configured to decode video data according to one or more techniques of this disclosure.

### DESCRIPTION OF EMBODIMENTS

In general, this disclosure describes various techniques for coding video data. In particular, this disclosure describes techniques for signaling picture information for coded video data. That is, for example, picture information may include information indicating whether one or more video coding tools (e.g., prediction techniques, filtering techniques, etc.) are enabled for a picture and/or portions thereof. It should be noted that although techniques of this disclosure are described with respect to ITU-T H.264, ITU-T H.265, JEM, and JVET-P2001, the techniques of this disclosure are generally applicable to video coding. For example, the coding techniques described herein may be incorporated into video coding systems, (including video coding systems based on future video coding standards) including video block structures, intra prediction techniques, inter prediction techniques, transform techniques, filtering techniques, and/or entropy coding techniques other than those included in ITU-T H.265, JEM, and JVET-P2001. Thus, reference to ITU-T H.264, ITU-T H.265, JEM, and/or JVET-P2001 is for descriptive purposes and should not be construed to limit the scope of the techniques described herein. Further, it should be noted that incorporation by reference of documents herein is for descriptive purposes and should not be construed to limit or create ambiguity with respect to terms used herein. For example, in the case where an incorporated reference provides a different definition of a term than another incorporated reference and/or as the term is used herein, the term should be interpreted in a manner that broadly includes each respective definition and/or in a manner that includes each of the particular definitions in the alternative.

Video content includes video sequences comprised of a series of frames (or pictures). A series of frames may also be referred to as a group of pictures (GOP). Each video frame or picture may divided into one or more regions. Regions may be defined according to a base unit (e.g., a video block) and sets of rules defining a region. For example, a rule defining a region may be that a region must be an integer number of video blocks arranged in a rectangle. Further, video blocks in a region may be ordered according to a scan pattern (e.g., a raster scan). As used herein, the term video block may generally refer to an area of a picture or may more specifically refer to the largest array of sample values that may be predictively coded, sub-divisions thereof, and/or corresponding structures. Further, the term current video block may refer to an area of a picture being encoded or decoded. A video block may be defined as an array of sample values. It should be noted that in some cases pixel values may be described as including sample values for respective components of video data, which may also be referred to as color components, (e.g., luma (Y) and chroma (Cb and Cr) components or red, green, and blue components). It should be noted that in some cases, the terms pixel value and sample value are used interchangeably. Further, in some cases, a pixel or sample may be referred to as a pel. A video sampling format, which may also be referred to as a chroma format, may define the number of chroma samples included in a video block with respect to the number of luma samples included in a video block. For example, for the 4:2:0 sampling format, the sampling rate for the luma component is twice that of the chroma components for both the horizontal and vertical directions.

A video encoder may perform predictive encoding on video blocks and sub-divisions thereof. Video blocks and sub-divisions thereof may be referred to as nodes. ITU-T H.264 specifies a macroblock including 16×16 luma samples. That is, in ITU-T H.264, a picture is segmented into macroblocks. ITU-T H.265 specifics an analogous Coding Tree Unit (CTU) structure (which may be referred to as a largest coding unit (LCU)). In ITU-T H.265, pictures are segmented into CTUs. In ITU-T H.265, for a picture, a CTU size may be set as including 16×16, 32×32, or 64×64 luma samples. In ITU-T H.265, a CTU is composed of respective Coding Tree Blocks (CTB) for each component of video data (e.g., luma (Y) and chroma (Cb and Cr). It should be noted that video having one luma component and the two corresponding chroma components may be described as having two channels, i.e., a luma channel and a chroma channel. Further, in ITU-T H.265, a CTU may be partitioned according to a quadtree (QT) partitioning structure, which results in the CTBs of the CTU being partitioned into Coding Blocks (CB). That is, in ITU-T H.265, a CTU may be partitioned into quadtree leaf nodes. According to ITU-T H.265, one luma CB together with two corresponding chroma CBs and associated syntax elements are referred to as a coding unit (CU). In ITU-T H.265, a minimum allowed size of a CB may be signaled. In ITU-T H.265, the smallest minimum allowed size of a luma CB is 8×8 luma samples. In ITU-T H.265, the decision to code a picture area using intra prediction or inter prediction is made at the CU level.

In ITU-T H.265, a CU is associated with a prediction unit structure having its root at the CU. In ITU-T H.265, prediction unit structures allow luma and chroma CBs to be split for purposes of generating corresponding reference samples. That is, in ITU-T H.265, luma and chroma CBs may be split into respective luma and chroma prediction blocks (PBs), where a PB includes a block of sample values for which the same prediction is applied. In ITU-T H.265, a CB may be partitioned into 1, 2, or 4 PBs. ITU-T H.265 supports PB sizes from 64×64 samples down to 4×4 samples. In ITU-T H.265, square PBs are supported for intra prediction, where a CB may form the PB or the CB may be split into four square PBs. In ITU-T H.265, in addition to the square PBs, rectangular PBs are supported for inter prediction, where a CB may be halved vertically or horizontally to form PBs. Further, it should be noted that in ITU-T H.265, for inter prediction, four asymmetric PB partitions are supported, where the CB is partitioned into two PBs at one quarter of the height (at the top or the bottom) or width (at the left or the right) of the CB. Intra prediction data (e.g., intra prediction mode syntax elements) or inter prediction data (e.g., motion data syntax elements) corresponding to a PB is used to produce reference and/or predicted sample values for the PB.

JEM specifies a CTU having a maximum size of 256×256 luma samples. JEM specifies a quadtree plus binary tree (QTBT) block structure. In JEM, the QTBT structure enables quadtree leaf nodes to be further partitioned by a binary tree (BT) structure. That is, in JEM, the binary tree structure enables quadtree leaf nodes to be recursively divided vertically or horizontally. In JVET-P2001, CTUs are partitioned according a quadtrec plus multi-type tree (QTMT or QT+MTT) structure. The QTMT in JVET-P2001 is similar to the QTBT in JEM. However, in JVET-P2001, in addition to indicating binary splits, the multi-type tree may indicate so-called ternary (or triple tree (TT)) splits. A ternary split divides a block vertically or horizontally into three blocks. In the case of a vertical TT split, a block is divided at one quarter of its width from the left edge and at one quarter its width from the right edge and in the case of a horizontal TT split a block is at one quarter of its height from the top edge and at one quarter of its height from the bottom edge.

As described above, each video frame or picture may be divided into one or more regions. For example, according to ITU-T H.265, each video frame or picture may be partitioned to include one or more slices and further partitioned to include one or more tiles, where each slice includes a sequence of CTUs (e.g., in raster scan order) and where a tile is a sequence of CTUs corresponding to a rectangular area of a picture. It should be noted that a slice, in ITU-T H.265, is a sequence of one or more slice segments starting with an independent slice segment and containing all subsequent dependent slice segments (if any) that precede the next independent slice segment (if any). A slice segment, like a slice, is a sequence of CTUs. Thus, in some cases, the terms slice and slice segment may be used interchangeably to indicate a sequence of CTUs arranged in a raster scan order. Further, it should be noted that in ITU-T H.265, a tile may consist of CTUs contained in more than one slice and a slice may consist of CTUs contained in more than one tile. However, ITU-T H.265 provides that one or both of the following conditions shall be fulfilled: (1) All CTUs in a slice belong to the same tile; and (2) All CTUs in a tile belong to the same slice.

With respect to 1 VET-P2001, slices are required to consist of an integer number of complete tiles or an integer number of consecutive complete CTU rows within a tile, instead of only being required to consist of an integer number of CTUs. It should be noted that in JVET-P2001, the slice design does not include slice segments (i.e., no in-dependent/dependent slice segments). Thus, in JVET-P2001, a picture may include a single tile, where the single tile is contained within a single slice or a picture may include multiple tiles where the multiple tiles (or CTU rows thereof) may be contained within one or more slices. In JVET-P2001, the partitioning of a picture into tiles is specified by specifying respective heights for tile rows and respective widths for tile columns. Thus, in JVET-P2001 a tile is a rectangular region of CTUs within a particular tile row and a particular tile column position. Further, it should be noted that JVET-P2001 provides where a picture may be partitioned into subpictures, where a subpicture is a rectangular region of a CTUs within a picture. The top-left CTU of a subpicture may be located at any CTU position within a picture with subpictures being constrained to include one or more slices Thus, unlike a tile, a subpicture is not necessarily limited to a particular row and column position. It should be noted that subpictures may be useful for encapsulating regions of interest within a picture and a sub-bitstream extraction process may be used to only decode and display a particular region of interest. That is, as described in further detail below, a bitstream of coded video data includes a sequence of network abstraction layer (NAL) units, where a NAL unit encapsulates coded video data, (i.e., video data corresponding to a slice of picture) or a NAL unit encapsulates metadata used for decoding video data (e.g., a parameter set) and a sub-bitstream extraction process forms a new bitstream by removing one or more NAL units from a bitstream.

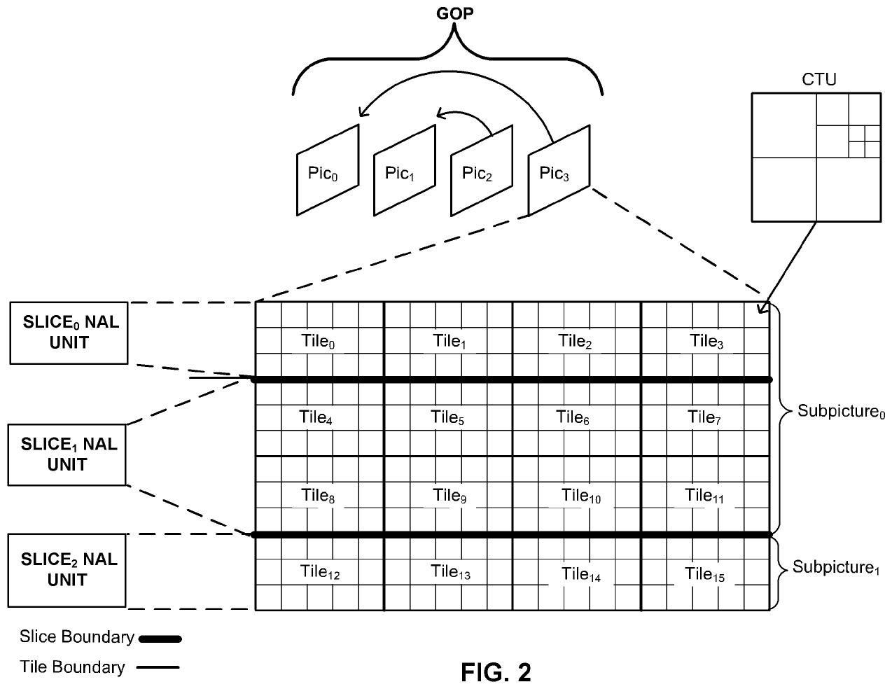

FIG. 2 is a conceptual diagram illustrating an example of a picture within a group of pictures partitioned according to tiles, slices, and subpictures. It should be noted that the techniques described herein may be applicable to tiles, slices, subpictures, sub-divisions thereof and/or equivalent structures thereto. That is, the techniques described herein may be generally applicable regardless of how a picture is partitioned into regions. For example, in some cases, the techniques described herein may be applicable in cases where a tile may be partitioned into so-called bricks, where a brick is a rectangular region of CTU rows within a particular tile. Further, for example, in some cases, the techniques described herein may be applicable in cases where one or more tiles may be included in so-called tile groups, where a tile group includes an integer number of adjacent tiles. In the example illustrated in FIG. 2, Pic₃ is illustrated as including 16 tiles (i.e., Tile₀ to Tile₁₅) and three slices (i.e., Slice₀ to Slice₂). In the example illustrated in FIG. 2, Slice₀ includes four tiles (i.e., Tile₀ to Tile₃), Slice₁ includes eight tiles (i.e., Tile₄ to Tile₁₁), and Slice₂ includes four tiles (i.e., Tile₁₂ to Tile₁₅). Further, as illustrated in the example of FIG. 2, Pic₃ is illustrated as including two subpictures (i.e., Subpicture₁ and Subpicture₁), where Subpicture₀ includes Slice₀ and Slice₁ and where Subpicture₁ includes Slice₂. As described above, subpictures may be useful for encapsulating regions of interest within a picture and a sub-bitstream extraction process may be used in order to selectively decode (and display) a region interest. For example, referring to FIG. 2, Subpicture₀ may corresponding to an action portion of a sporting event presentation (e.g., a view of the field) and Subpicture₁ may corresponding to a scrolling banner displayed during the sporting event presentation. By using organizing a picture into subpictures in this manner, a viewer may be able to disable the display of the scrolling banner. That is, through a sub-bitstream extraction process Slice₂ NAL unit may be removed from a bitstream (and thus not decoded) and Slice₀ NAL unit and Slice₁ NAL unit may be decoded and displayed. The encap-sulation of slices of a picture into respective NAL unit data structures and sub-bitstream extraction are described in further detail below.

For intra prediction coding, an intra prediction mode may specify the location of reference samples within a picture. In ITU-T H.265, defined possible intra prediction modes include a planar (i.e., surface fitting) prediction mode, a DC (i.e., flat overall averaging) prediction mode, and 33 angular prediction modes (predMode: 2-34). In JEM, defined possible intra-prediction modes include a planar prediction mode, a DC prediction mode, and 65 angular prediction modes. It should be noted that planar and DC prediction modes may be referred to as non-directional prediction modes and that angular prediction modes may be referred to as directional prediction modes. It should be noted that the techniques described herein may be generally applicable regardless of the number of defined possible prediction modes.

For inter prediction coding, a reference picture is determined and a motion vector (MV) identifies samples in the reference picture that are used to generate a prediction for a current video block. For example, a current video block may be predicted using reference sample values located in one or more previously coded picture(s) and a motion vector is used to indicate the location of the reference block relative to the current video block. A motion vector may describe, for example, a horizontal displacement component of the motion vector (i.e., MVₓ), a vertical displacement component of the motion vector (i.e., MV_{y}), and a resolution for the motion vector (e.g., one-quarter pixel precision, one-half pixel precision, one-pixel precision, two-pixel precision, four-pixel precision). Previously decoded pictures, which may include pictures output before or after a current picture, may be organized into one or more to reference pictures lists and identified using a reference picture index value. Further, in inter prediction coding, uni-prediction refers to generating a prediction using sample values from a single reference picture and bi-prediction refers to generating a prediction using respective sample values from two reference pictures. That is, in uni-prediction, a single reference picture and corresponding motion vector are used to generate a prediction for a current video block and in bi-prediction, a first reference picture and corresponding first motion vector and a second reference picture and corresponding second motion vector are used to generate a prediction for a current video block. In bi-prediction, respective sample values are combined (e.g., added, rounded, and clipped, or averaged according to weights) to generate a prediction. Pictures and regions thereof may be classified based on which types of prediction modes may be utilized for encoding video blocks thereof. That is, for regions having a B type (e.g., a B slice), bi-prediction, uni-prediction, and intra prediction modes may be utilized, for regions having a P type (e.g., a P slice), uni-prediction, and intra prediction modes may be utilized, and for regions having an I type (e.g., an I slice), only intra prediction modes may be utilized. As described above, reference pictures are identified through reference indices. For example, for a P slice, there may be a single reference picture list, RefPicList0 and for a B slice, there may be a second independent reference picture list. RefPicList1, in addition to RefPicList0. It should be noted that for uni-prediction in a B slice, one of RefPicList0 or RefPicList1 may be used to generate a prediction. Further, it should be noted that during the decoding process, at the onset of decoding a picture, reference picture list(s) are generated from previously decoded pictures stored in a decoded picture buffer (DPB).

Further, a coding standard may support various modes of motion vector prediction. Motion vector prediction enables the value of a motion vector for a current video block to be derived based on another motion vector. For example, a set of candidate blocks having associated motion information may be derived from spatial neighboring blocks and temporal neighboring blocks to the current video block. Further, generated (or default) motion information may be used for motion vector prediction. Examples of motion vector prediction include advanced motion vector prediction (AMVP), temporal motion vector prediction (TMVP), so-called “merge” mode, and “skip” and “direct” motion inference. Further, other examples of motion vector prediction include advanced temporal motion vector prediction (ATMVP) and Spatial-temporal motion vector prediction (STMVP). For motion vector prediction, both a video encoder and video decoder perform the same process to derive a set of candidates. Thus, for a current video block, the same set of candidates is generated during encoding and decoding.

As described above, for inter prediction coding, reference samples in a previously coded picture are used for coding video blocks in a current picture. Previously coded pictures which are available for use as reference when coding a current picture are referred as reference pictures. It should be noted that the decoding order does not necessary correspond with the picture output order, i.e., the temporal order of pictures in a video sequence. In ITU-T H.265, when a picture is decoded it is stored to a decoded picture buffer (DPB) (which may be referred to as frame buffer, a reference buffer, a reference picture buffer, or the like). In ITU-T H.265, pictures stored to the DPB are removed from the DPB when they been output and are no longer needed for coding subsequent pictures. In ITU-T H.265, a determination of whether pictures should be removed from the DPB is invoked once per picture, after decoding a slice header, i.e., at the onset of decoding a picture. For example, referring to FIG. 2, Pic₂ is illustrated as referencing Pic₁. Similarly, Pic₁, is illustrated as referencing Pic₀. With respect to FIG. 2, assuming the picture number corresponds to the decoding order, the DPB would be populated as follows: after decoding Pic₀, the DPB would include {Pic₀}; at the onset of decoding Pic₁ the DPB would include {Pic₀]; after decoding Pic₁ the DPB would include {Pic₀, Pic₁}; at the onset of decoding Pic₂, the DPB would include {Pic₀, Pic₁}. Pic₂ would then be decoded with reference to Pic₁ and after decoding Pics, the DPB would include {Pic₀, Pic₁, Pic₂]. At the onset of decoding Pic₃, pictures Pic₀ and Pic₁ would be marked for removal from the DPB. as they are not needed for decoding Pic₃ (or any subsequent pictures, not shown) and assuming Pic₁ and Pic₂ have been output, the DPB would be updated to include [Pic₀]. Pic₃ would then be decoded by referencing Pic₀. The process of marking pictures for removal from a DPB may be referred to as reference picture set (RPS) management.

As described above, intra prediction data or inter prediction data is used to produce reference sample values for a block of sample values. The difference between sample values included in a current PB, or another type of picture area structure, and associated reference samples (e.g., those generated using a prediction) may be referred to as residual data. Residual data may include respective arrays of difference values corresponding to each component of video data. Residual data may be in the pixel domain. A transform, such as, a discrete cosine transform (DCT), a discrete sine transform (DST), an integer transform, a wavelet transform, or a conceptually similar transform, may be applied to an array of difference values to generate transform coefficients. It should be noted that in ITU-T H.265 and JVET-P2001, a CU is associated with a transform tree structure having its root at the CU level. The transform tree is partitioned into one or more transform units (TUs). That is, an array of difference values may be partitioned for purposes of generating transform coefficients (e.g., four 8×8 transforms may be applied to a 16×16 array of residual values). For each component of video data, such sub-divisions of difference values may be referred to as Transform Blocks (TBs). It should be noted that in some cases, a core transform and a subsequent secondary transforms may be applied (in the video encoder) to generate transform coefficients. For a video decoder, the order of transforms is reversed.

A quantization process may be performed on transform coefficients or residual sample values directly (e.g., in the case, of palette coding quantization). Quantization approximates transform coefficients by amplitudes restricted to a set of specified values. Quantization essentially scales transform coefficients in order to vary the amount of data required to represent a group of transform coefficients. Quantization may include division of transform coefficients (or values resulting from the addition of an offset value to transform coefficients) by a quantization scaling factor and any associated rounding functions (e.g., rounding to the nearest integer). Quantized transform coefficients may be referred to as coefficient level values. Inverse quantization (or “dequantization”) may include multiplication of coefficient level values by the quantization scaling factor, and any reciprocal rounding or offset addition operations. It should be noted that as used herein the term quantization process in some instances may refer to division by a scaling factor to generate level values and multiplication by a scaling factor to recover transform coefficients in some instances. That is, a quantization process may refer to quantization in some cases and inverse quantization in some cases. Further, it should be noted that although in some of the examples below quantization processes are described with respect to arithmetic operations associated with decimal notation, such descriptions are for illustrative purposes and should not be construed as limiting. For example, the techniques described herein may be implemented in a device using binary operations and the like. For example, multiplication and division operations described herein may be implemented using bit shifting operations and the like.

Quantized transform coefficients and syntax elements (e.g., syntax elements indicating a coding structure for a video block) may be entropy coded according to an entropy coding technique. An entropy coding process includes coding values of syntax elements using lossless data compression algorithms. Examples of entropy coding techniques include content adaptive variable length coding (CAVLC), context adaptive binary arithmetic coding (CABAC), probability interval partitioning entropy coding (PIPE), and the like. Entropy encoded quantized transform coefficients and corresponding entropy encoded syntax elements may form a compliant bitstream that can be used to reproduce video data at a video decoder. An entropy coding process, for example, CABAC, may include performing a binarization on syntax elements. Binarization refers to the process of converting a value of a syntax element into a series of one or more hits. These bits may be referred to as “bins.” Binarization may include one or a combination of the following coding techniques: fixed length coding, unary coding, truncated unary coding, truncated Rice coding, Golomb coding, k-th order exponential Golomb coding, and Golomb-Rice coding. For example, binarization may include representing the integer value of 5 for a syntax element as 00000101 using an 8-bit fixed length binarization technique or representing the integer value of 5 as 11110 using a unary coding binarization technique. As used herein each of the terms fixed length coding, unary coding, truncated unary coding, truncated Rice coding, Golomb coding, k-th order exponential Golomb coding, and Golomb-Rice coding may refer to general implementations of these techniques and/or more specific implementations of these coding techniques. For example, a Golomb-Rice coding implementation may be specifically defined according to a video coding standard. In the example of CABAC, for a particular bin, a context provides a most probable state (MPS) value for the bin (i.e., an MPS for a bin is one of 0 or 1) and a probability value of the bin being the MPS or the least probably state (LPS). For example, a context may indicate, that the MPS of a bin is 0 and the probability of the bin being 1 is 0.3. It should be noted that a context may be determined based on values of previously coded bins including bins in the current syntax element and previously coded syntax elements. For example, values of syntax elements associated with neighboring video blocks may be used to determine a context for a current bin.

With respect to the equations used herein, the following arithmetic operators may be used:
+ Addition
− Subtraction
*Multiplication, including matrix multiplication
x^{y} Exponentiation. Specifies x to the power of y. In other contexts, such notation is used for superscripting not intended for interpretation as exponentiation.
/Integer division with truncation of the result toward zero. For example, 7/4 and −7/−4 are truncated to 1 and −7/4 and 7/−4 are truncated to −1.
÷ Used to denote division in mathematical equations where no truncation or rounding is intended.
x/y Used to denote division in mathematical equations where no truncation or rounding is intended.

Further, the following mathematical functions may be used:

$$Log 2 ( x ) the base - 2 logarithm of x :$$

$$Min ( x , y ) = \{ \begin{matrix}x ; & x <= y \\ y ; & x > y\end{matrix} :$$

$$Max ( x , y ) = \{ \begin{matrix}x ; & x >= y \\ y ; & x < y\end{matrix}$$

$$Ceil ( x ) the smallest integer greater than or equal to x .$$

With respect to the example syntax used herein, the following definitions of logical operators may be applied:
x&&y Boolean logical “and” of x and y
x∥y Boolean logical “or” of x and y
! Boolean logical “not”
x?y: z If x is TRUE or not equal to 0, evaluates to the value of y: otherwise, evaluates to the value of z.

Further, the following relational operators may be applied:
> Greater than
>= Greater than or equal to
< Less than
<= Less than or equal to
== Equal to
!= Not equal to

Further, it should be noted that in the syntax descriptors used herein, the following descriptors may be applied:
b(8): byte having any pattern of bit string (8 bits). The parsing process for this descriptor is specified by the return value of the function read_bits (8).
f(n): fixed-pattern bit string using n bits written (from left to right) with the left bit first. The parsing process for this descriptor is specified by the return value of the function read bits(n).
se(v): signed integer 0-th order Exp-Golomb-coded syntax element with the left bit first.
tb(v): truncated binary using up to max Val bits with max Val defined in the semantics of the syntax element.
tu(v): truncated unary using up to max Val bits with max Val defined in the semantics of the syntax element.
u(n); unsigned integer using n bits. When n is “v” in the syntax table, the number of bits varies in a manner dependent on the value of other syntax elements. The parsing process for this descriptor is specified by the return value of the function read_bits(n) interpreted as a binary representation of an unsigned integer with most significant bit written first
ue(v): unsigned integer 0-th order Exp-Golomb-coded syntax element with the left bit first.

As described above, video content includes video sequences comprised of a series of pictures and each picture may be divided into one or more regions. In JVET-P2001, a coded representation of a picture is referred to as a coded picture and all CTUs of the coded picture are encapsulated in one or more coded slice NAL units. That is, one or more corresponding coded slice NAL units encapsulate a coded representation of a picture. For example, referring again to FIG. 2, the coded representation of Pic₃ is encapsulated in three coded slice NAL units (i.e., Slice₀ NAL unit, Slice₁ NAL unit, and Slice₂ NAL unit). It should be noted that the term video coding layer (VCL) NAL unit is used as a collective term for coded slice NAL units, i.e., VCL NAL is a collective term which includes all types of slice NAL units. As described above, and in further detail below, a NAL unit may encapsulate metadata used for decoding video data. A NAL unit encapsulating metadata used for decoding a video sequence is generally referred to as a non-VCL NAL unit. Thus, in JVET-P2001, a NAL unit may be a VCL NAL unit or a non-VCL NAL unit. It should be noted that a VCL NAL unit includes slice header data, which provides information used for decoding the particular slice. Thus, in JVET-P2001, information used for decoding video data, which may be referred to as metadata in some cases, is not limited to being included in non-VCL NAL units. JVET-P2001 provides where a picture unit (PU) is a set of NAL units that contain all VCL NAL units of a coded picture and their associated non-VCL NAL units and where an access unit (AU) is a set of NAL units that are associated with each other according to a specified classification rule, are consecutive in decoding order, and contain exactly one coded picture for each present picture unit. A PU consists of one picture header NAL unit, one coded picture, which comprises of one or more VCL NAL units, and zero or more non-VCL NAL units. Thus, in JVET-P2001 an access unit includes one or more coded pictures. In some cases, an access unit may include pictures included in different layers of video. Layers of video are described in further detail below. Further, in JVET-P2001, a coded video sequence (CVS) is a sequence of AUs that consists, in decoding order, of a CVSS AU, followed by zero or more AUs that are not CVSS AUs, including all subsequent AUs up to but not including any subsequent AU that is a CVSS AU, where a coded video sequence start (CVSS) AU is an AU in which there is a picture unit for each layer in the CVS and the coded picture in each present picture unit is a coded layer video sequence start (CLVSS) picture. In JVET-P2001, a coded layer video sequence (CLVS) is a sequence of PUs within the same layer that consists, in decoding order, of a CLVSS PU, followed by zero or more PUs that are not CLVSS PUs, including all subsequent PUs up to but not including any subsequent PU that is a CLVSS PU. This is, in JVET-P2001, a bitstream may be described as including a sequence of NAL units forming a CVS, where a CVS includes AUs and each AU may include respective pictures for each of a plurality of layers for coded video.

Multi-layer video coding enables a video presentation to be decoded/displayed as a presentation corresponding to a base layer of video data and decoded/displayed one or more additional presentations corresponding to enhancement layers of video data. For example, a base layer may enable a video presentation having a basic level of quality (e.g., a High Definition rendering and/or a 30 Hz frame rate) to be presented and an enhancement layer may enable a video presentation having an enhanced level of quality (e.g., an Ultra High Definition rendering and/or a 60 Hz frame rate) to be presented. An enhancement layer may be coded by referencing a base layer. That is, for example, a picture in an enhancement layer may be coded (e.g., using inter-layer prediction techniques) by referencing one or more pictures (including scaled versions thereof) in a base layer. It should be noted that layers may also be coded independent of each other. In this case, there may not be inter-layer prediction between two layers. Each NAL unit may include an identifier indicating a layer of video data the NAL unit is associated with. As described above, a sub-bitstream extraction process may be used to only decode and display a particular region of interest of a picture. Further, a sub-bitstream extraction process may be used to only decode and display a particular layer of video. Sub-bitstream extraction may refer to a process where a device receiving a compliant or conforming bitstream forms a new compliant or conforming bitstream by discarding and/or modifying data in the received bitstream. For example, sub-bitstream extraction may be used to form a new compliant or conforming bitstream corresponding to a particular representation of video (e.g., a high quality representation).

In JVET-P2001, each of a video sequence, a GOP, a picture, a slice, and CTU may be associated with metadata that describes video coding properties and some types of metadata an encapsulated in non-VCL NAL units. JVET-P2001 defines parameters sets that may be used to describe video data and/or video coding properties. In particular, JVET-P2001 includes the following five types of parameter sets: decoding parameter set (DPS), video parameter set (VPS), sequence parameter set (SPS), picture parameter sct (PPS), and adaption parameter sct (APS), where a SPS applies to apply to zero or more entire CVSs, a PPS applies to zero or more entire coded pictures, a APS applies to zero or more slices, and a DPS and a VPS may be optionally referenced by a SPS. A PPS applies to an individual coded picture that refers to it. In JVET-P2001, parameter sets may be encapsulated as a non-VCL NAL unit and/or may be signaled as a message. JVET-P2001 also includes a picture header (PH) which is encapsulated as a non-VCL NAL unit. In JVET-P2001, a picture header applies to all slices of a coded picture. JVET-P2001 further enables supplemental enhancement information (SEI) messages to be signaled. In JVET-P2001, SEI messages assist in processes related to decoding, display or other purposes, however, SEI messages may not be required for constructing the luma or chroma samples according to a decoding process. In JVET-P2001, SEI messages may be signaled in a bitstream using non-VCL NAL units. Further, SEI messages may be conveyed by some mechanism other than by being present in the bitstream (i.e., signaled out-of −band).

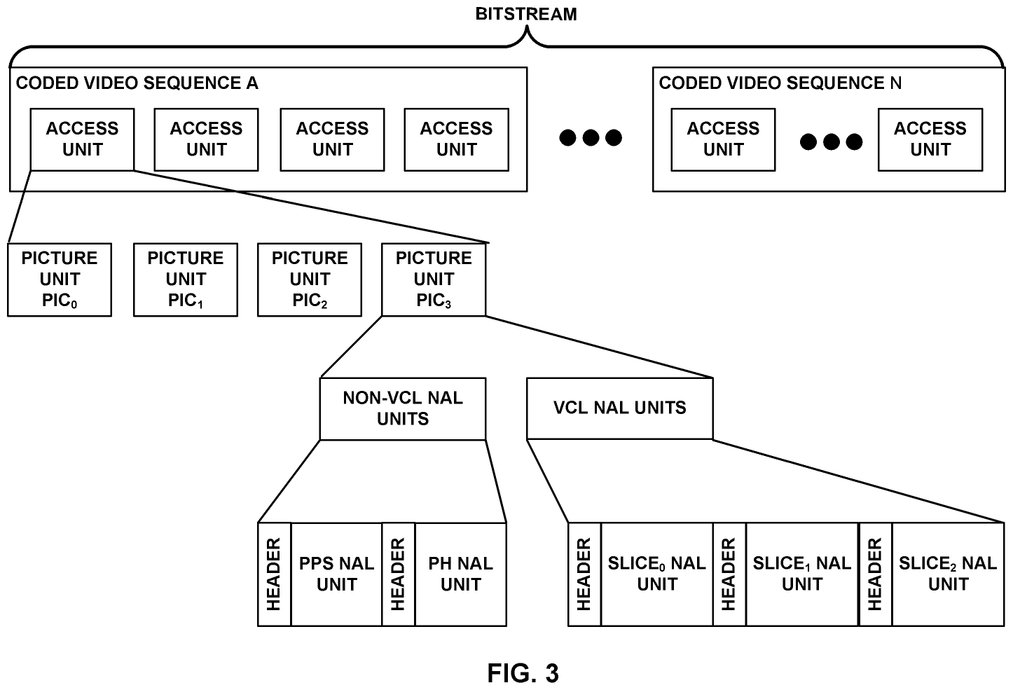

FIG. 3 illustrates an example of a bitstream including multiple CVSs, where a CVS includes AUs, and AUs include picture units. The example illustrated in FIG. 3 corresponds to an example of encapsulating the slice NAL units illustrated in the example of FIG. 2 in a bitstream. In the example illustrated in FIG. 3, the corresponding picture unit for Pic₃ includes the three VCL NAL coded slice NAL units, i.e., Slice₀ NAL unit, Slice₁ NAL unit, and Slice₂ NAL unit and two non-VCL NAL units, i.e., a PPS NAL Unit and a PH NAL unit. It should be noted that in FIG. 3, HEADER is a NAL unit header (i.e., not to be confused with a slice header). Further, it should be noted that in FIG. 3, other non-VCL NAL units, which are not illustrated may be included in the CVSs, e.g., SPS NAL units, VPS NAL units, SEI message NAL units, etc. Further, it should be noted that in other examples, a PPS NAL Unit used for decoding Pics may be included elsewhere in the bitstream, e.g., in the picture unit corresponding to Pic₀ or may be provided by an external mechanism. However, it should be note that in JVET-P2001, the picture header for each picture is required to be in the picture unit corresponding to the picture.

JVET-P2001 defines NAL unit header semantics that specify the type of Raw Byte Sequence Payload (RBSP) data structure included in the NAL unit. Table 1 illustrates the syntax of the NAL unit header provided in JVET-P2001.

TABLE 1

| nal_unit_header( ) { | Descriptor |
|---|---|
| forbidden_zero_bit | f(1) |
| nuh_reserved_zero_bit | u(1) |
| pub_layer_id | u(6) |
| nal_unit_type | u(5) |
| nuh_temporal_id_plus1 | u(3) |
| } | |

JVET-P2001 provides the following definitions for the respective syntax elements illustrated in Table 1.
forbidden_zero_bit shall be equal to 0.
nuh_reserved_zero bit shall be equal to ‘0’. The value I of nul_reserved_zero_bit may be specified in the future by ITU-T|ISO/IEC. Decoders shall ignore (i.e. remove from the bitstream and discard) NAL units with nuh_reserved_zero bit equal to ‘1’.
nuh_layer_id specifies the identifier of the layer to which a VCL NAL unit belongs or the identifier of a layer to which a non-VCL NAL unit applies. The value of nuh_layer_id shall be in the range of 0 to 56, inclusive. Other values for nuh_layer_id are reserved for future use by ITU-T] ISO/IEC.

The value of nuh_layer_id shall be the same for all VCL NAL units of a coded picture. The value of nuh_layer_id of a coded picture or a PU is the value of the nuh_layer_id of the VCL NAL units of the coded picture or the PU.

The value of nuh_layer_id for non-VCL NAL units is constrained as follows:
If nal_unit_type is equal to PPS_NUT, PREFIX_APS_NUT, or SUFFIX_APS_NUT, nuh_layer_id shall be equal to the lowest nuh_layer_id value of the coded slice NAL. units that refer to the NAL unit.
Otherwise if nal_unit_type is equal to SPS_NUT, mih_layer_id shall be equal to the lowest nuh_layer_id value of the PPS NAL units that refer to the SPS NAL unit
Otherwise when nal_unit_type is equal to PH_NUT, EOS_NUT, or FD_NUT, nuh_layer_id shall be equal to the nuh_layer_id of associated VCL NAL unit.
NOTE—The value of nuh_layer_id of DPS, VPS, EOB. and AUD NAL units is not constrained.

The value of nal_unit_type shall be the same for all pictures of a CVSS AU. nuh_temporal_id_plus1 minus 1 specifies a temporal identifier for the NAL unit.

The value of nuh_temporal_id_plus1 shall not be equal to 0.

The variable TemporalId is derived as follows:

$$TemporalId = nuh\_temporal \_id \_plus 1 - 1$$

When nal_unit_type is in the range of IDR_W_RADL to RSV_IRAP_12, inclusive, TemporalId shall be equal to 0.

When nal_unit_type is equal to STSA_NUT, Temporalld shall not be equal to 0.

The value of Temporalld shall be the same for all VCL NAL units of an AU. The value of TemporalId of a coded picture, a PU, or an AU is the value of the TemporalId of the VCL NAL units of the coded picture, PU, or AU. The value of TemporalId of a sub-layer representation is the greatest value of TemporalId of all VCL NAL units in the sub-layer representation.

The value of Temporalld for non-VCL NAL units is constrained as follows:
If nal_unit_type is equal to DPS_NUT, VPS_NUT, or SPS_NUT, TemporalId shall be equal to 0 and the TemporalId of the AU containing the NAL unit shall be equal to 0.
Otherwise, if nal_unit_type is equal to PH_NUT, Temporalld shall be equal to the Temporalld of the PU containing the NAL unit.
Otherwise if nal_unit_type is equal to EOS_NUT or EOB_NUT. Temporalld shall be equal to 0.
Otherwise, if nal_unit type is equal to AUD_NUT, FD_NUT. PREFIX_SEI_NUT, or SUFFIX SEI NUT, TemporalId shall be equal to the Temporalld of the AU containing the NAL unit.
Otherwise, when nal_unit_type is equal to PPS_NUT, PREFIX_APS_NUT, or SUFFIX_APS_NUT, TemporalId shall be greater than or equal to the Temporalld of the PU containing the NAL unit.

NOTE—When the NAL unit is a non-VCL NAL unit, the value of TemporalId is equal to the minimum value of the Temporalld values of all AUs to which the non-VCL NAL unit applies. When nal_unit_type is equal to PPS_NUT, PREFIX APS NUT, or SUFFIX_APS_NUT. Temporalld may be greater than or equal to the Temporalld of the containing AU, as all PPSs and APSs may be included in the beginning of the bitstream (e.g., when they are transported out-of −band, and the receiver places them at the beginning of the bitstream), wherein the first coded picture bas Temporalld equal to 0.

nal_unit_type specifies the NAL unit type, i.e., the type of RBSP data structure contained in the NAL unit as specified in Table 2.

NAL units that have nal_unit_type in the range of UNSPEC28 . . . . UNSPEC31, inclusive, for which semantics are not specified, shall not affect the decoding process specified in this Specification.

NOTE—NAL unit types in the range of UNSPEC28 . . . . UNSPEC31 may be used as determined by the application. No decoding process for these values of nal_unit_type is specified in this Specification. Since different applications might use these NAL unit types for different purposes, particular care must be exercised in the design of encoders that generate NAL units with these nal_unit_type values, and in the design of decoders that interpret the content of NAL units with these nal_unit_type values. This Specification does not define any management for these values. These nal_unit_type values might only be suitable for use in contexts in which “collisions” of usage (i.e., different definitions of the meaning of the NAL unit content for the same nal_unit_type value) are unimportant, or not possible, or are managed—e.g., defined or managed in the controlling application or transport specification, or by controlling the environment in which bitstreams are distributed.

For purposes other than determining the amount of data in the decoding units of the bitstream, decoders shall ignore (remove from the bitstream and discard) the contents of all NAL units that use reserved values of nal_unit_type.

NOTE—This requirement allows future definition of compatible extensions to this Specification.

TABLE 2

| | Name of | Content of NAL unit and RBSP syntax | NAL unit |
|---|---|---|---|
| nal_unit_type | nal_unit_type | structure | type class |
| 0 | TRAIL_NUT | Coded slice of a trailing picture | VCL |
| | | slice_layer_rbsp( ) | |
| 1 | STSA_NUT | Coded slice of an STSA picture | VCL |
| | | slice_layer_rbsp( ) | |
| 2 | RADL_NUT | Coded slice of a RADL picture | VCL |
| | | slice_layer_rbsp( ) | |
| 3 | RASL_NUT | Coded slice of a RASL picture | VCL |
| | | slice_layer_rbsp( ) | |
| 4 . . . 6 | RSV_VCL_4 . . . | Reserved non-IRAP VCL NAL unit types | VCL |
| | RSV_VCL_6 | | |
| 7 | IDR_W_RADL | Coded slice of an IDR picture | VCL |
| 8 | IDR_N_LP | slice_layer_rbsp( ) | |
| 9 | CRA_NUT | Coded slice of a CRA picture | VCL |
| | | silce_layer_rbsp( ) | |
| 10 | GDR_NUT | Coded slice of a GDR picture | VCL |
| | | slice_layer_rbsp( ) | |
| 11 | RSV_IRAP_11 | Reserved IRAP VCL NAL unit types | VCL |
| 12 | RSV_IRAP_12 | | |
| 13 | DPS_NUT | Decoding parameter set | non-VCL |
| | | decoding_parameter_set_rbsp( ) | |
| 14 | VPS_NUT | Video parameter set | non-VCL |
| | | video_parameter_set_rbsp( ) | |
| 15 | SPS_NUT | Sequence parameter set | non-VCL |
| | | seq_parameter_set_rbsp( ) | |
| 16 | PPS_NUT | Picture parameter set | non-VCL |
| | | pic_parameter_set_rbsp( ) | |
| 17 | PREFIX_APS_NUT | Adaptation parameter set | non-VCL |
| 18 | SUFFIX_APS_NUT | adaptation_parameter_set_rbsp( ) | |
| 19 | PH_NUT | Picture header | non-VCL |
| | | picture_header_rbsp( ) | |
| 20 | AUD_NUT | AU delimiter | non-VCL |
| | | access_unit_delimiter_rbsp( ) | |
| 21 | EOS_NUT | End of sequence | non-VCL |
| | | end_of_seq_rbsp( ) | |
| 22 | EOB_NUT | End of bitstream | non-VCL |
| | | end_of_bitstream_rbsp( ) | |
| 23 | PREFIX_SEI_NUT | Supplemental enhancement information | non-VCL |
| 24 | SUFFIX_SEI_NUT | sei_rbsp( ) | |
| 25 | FD_NUT | Filler data | non-VCL |
| | | filler_data_rbsp( ) | |
| 26 | RSV_NVCL_26 | Reserved non-VCL NAL unit types | non-VCL |
| 27 | RSV_NVCL_27 | | |
| 28 . . . 31 | UNSPEC_28 . . . | Unspecified non-VCL NAL unit types | non-VCL |
| | UNSPEC_31 | | |

NOTE -
A clean random access (CRA) picture may have associated RASL or RADL pictures present in the bitstream.
NOTE -
An instantaneous decoding refresh (IDR) picture having nal_unit_type equal to IDR_N_LP does not have associated leading pictures present in the bitstream. An IDR picture having nal_unit_type equal to IDR_W_RADL does not have associated RASL pictures present in the bitstream, but may have associated RADL pictures in the bitstream.

For VCL NAL units of any particular picture, the following applies:
If mixed_nalu_types_in_pic_flag is equal to 0, the value of nal_unit_type shall be the same for all coded slice NAL units of a picture. A picture or a PU is referred to as having the same NAL unit type as the coded slice NAL units of the picture or PU.
Otherwise (mixed_nalu_types_in_pic_flag equal to 1), one or more of the VCL NAL units shall all have a particular value of nal_unit_type in the range of IDR_W_RADL to CRA_NUT, inclusive, and the other VCL NAL units shall all have a particular value of nal_unit_type in the range of TRAIL_NUT to RSV_VCL_6. inclusive, or equal to GRA_NUT.

For a single-layer bitstream, the following constraints apply:
Each picture, other than the first picture in the bitstream in decoding order, is considered to be associated with the previous IRAP picture in decoding order.
When a picture is a leading picture of an TRAP picture, it shall be a RADL or RASL picture.
When a picture is a trailing picture of an IRAP picture, it shall not be a RADL or RASL picture.
No RASL pictures shall be present in the bitstream that are associated with an IDR picture.
No RADL pictures shall be present in the bitstream that are associated with an IDR picture having nal_unit_type equal to IDR_N_LP.
NOTE—It is possible to perform random access at the position of an IRAP PU by discarding all PUs before the IRAP PU (and to correctly decode the IRAP picture and all the subsequent non-RASL pictures in decoding order), provided each parameter set is available (either in the bitstream or by external means not specified in this Specification) when it is referenced.
Any picture that precedes an IRAP picture in decoding order shall precede the IRAP picture in output order and shall precede any RADL picture associated with the IRAP picture in output order.
Any RASL picture associated with a CRA picture shall precede any RADL picture associated with the CRA picture in output order.
Any RASL. picture associated with a CRA picture shall follow, in output order, any IRAP picture that precedes the CRA picture in decoding order.
If field_seq_flag is equal to 0 and the current picture is a leading picture associated with an IRAP picture, it shall precede, in decoding order, all non-leading pictures that are associated with the same IRAP picture. Otherwise. let picA and picB be the first and the last leading pictures, in decoding order, associated with an IRAP picture, respectively, there shall be at most one non-leading picture preceding picA in decoding order, and there shall be no non-leading picture between picA and picB in decoding order.

It should be noted that generally, an Intra Random Access Point (IRAP) picture is a picture that does not refer to any pictures other than itself for prediction in its decoding process. In JVET-P2001, an IRAP picture may be a clean random access (CRA) picture or an instantaneous decoder refresh (IDR) picture. In JVET-P2001, the first picture in the bitstream in decoding order must be an IRAP or a gradual decoding refresh (GDR) picture. JVET-P2001 describes the concept of a leading picture, which is a picture that precedes the associated IRAP picture in output order. JVET-P2001 further describes the concept of a trailing picture which is a non-IRAP picture that follows the associated IRAP picture in output order. Trailing pictures associated with an IRAP picture also follow the IRAP picture in decoding order. For IDR pictures, there are no trailing pictures that require reference to a picture decoded prior to the IDR picture. JVET-P2001 provides where a CRA picture may have leading pictures that follow the CRA picture in decoding order and contain inter picture prediction references to pictures decoded prior to the CRA picture. Thus, when the CRA picture is used as a random access point these leading pictures may not be decodable and are identified as random access skipped leading (RASL) pictures. The other type of picture that can follow an IRAP picture in decoding order and precede it in output order is the random access decodable leading (RADL) picture, which cannot contain references to any pictures that precede the IRAP picture in decoding order. A GDR picture, is a picture for which each VCL NAL unit has nal_unit_type equal to GDR_NUT. If the current picture is a GDR picture that is associated with a picture header which signals a syntax element receovery_poc_cnt and there is a picture picA that follows the current GDR picture in decoding order in the CLVS and that has PicOrderCntVal equal to the PicOrderCntVal of the current GDR picture plus the value of recovery_poc_ent, the picture picA is referred to as the recovery point picture.

As provided in Table 2, a NAL unit may include a sequence parameter set syntax structure. Table 3 illustrates the sequence parameter set syntax structure as provided in JVET-P2001.

TABLE 3

| | Descriptor |
|---|---|
| seq_parameter_set_rbsp( ) { | |
| sps_decoding_parameter_set_id | u(4) |
| sps_video_parameter_set_id | u(4) |
| sps_max_sub_layers_minus1 | u(3) |
| sps_reserved_zero_4bits | u(4) |
| sps_ptl_dpb_hrd_params_present_flag | u(1) |
| if( sps_ptl_dpb_hrd_params_present_flag ) | |
| profile_tier_level( 1, sps_max_sub_layers_minus1 ) | |
| gdr_enabled_flag | u(1) |
| sps_seq_parameter_set_id | u(4) |
| chroma_format_idc | u(2) |
| if( chroma_format_idc = = 3 ) | |
| separate_colour_plane_flag | u(1) |
| ref_pic_resampling_enabled_flag | u(1) |
| sps_seq_parameter_set_id | ue(v) |
| chroma_format_idc | ue(v) |
| if( chroma_format_idc = = 3 ) | |
| separate_colour_plane_flag | u(1) |
| pic_width_max_in_luma_samples | ue(v) |
| pic_height_max_in_luma_samples | ue(v) |
| sps_log2_ctu_size_minus5 | u(2) |
| subpics_present_flag | u(1) |
| sps_num_subpics_minus1 | u(8) |
| for( i = 0; i <= sps_num_subpics_minus1; i++ ) { | |
| subpic_ctu_top_left_x[ i ] | u(v) |
| subpic_ctu_top_left_y[ i ] | u(v) |
| subpic_width_minus1[ i ] | u(v) |
| subpic_height_minus1[ i ] | u(v) |
| subpic_treated_as_pic_flag[ i ] | u(1) |
| loop_filter_across_subpic_enabled_flag[ i ] | u(1) |
| } | |
| } | |
| sps_subpic_id_present_flag | u(1) |
| if( sps_subpics_id_present_flag ) { | |
| sps_subpic_id_signalling_present_flag | u(1) |
| if( sps_subpics_id_signalling_present_flag ) { | |
| sps_subpic_id_len_minus1 | ue(v) |
| for( i = 0; i <= sps_num_subpics_minus1; i++ ) | |
| sps_subpic_id[ i ] | u(v) |
| } | |
| } | |
| bit_depth_minus8 | ue(v) |
| min_qp_prime_ts_minus4 | ue(v) |
| sps_weighted_pred_flag | u(1) |
| sps_weighted_bipred_flag | u(1) |
| log2_max_pic_order_cnt_lsb_minus4 | u(4) |
| sps_poc_msb_flag | u(1) |
| if( sps_poc_msb_flag ) | |
| poc_msb_len_minus1 | ue(v) |
| if( sps_max_sub_layers_minus1 > 0 ) | |
| sps_sub_layer_dpb_params_flag | u(1) |
| if( sps_ptl_dpb_hrd_params_present_flag ) | |
| dpb_parameters( 0, sps_max_sub_layers_minus1, sps_sub_layer_dpb_params_flag ) | |
| long_term_ref_pics_flag | u(1) |
| inter_layer_ref_pics_present_flag | u(1) |
| sps_idr_rpl_present_flag | u(1) |
| rpl1_same_as_rpl0_flag | u(1) |
| for( i = 0; i < !rpl1_same_as_rpl0_flag ? 2 : 1; i++ ) { | |
| num_ref_pic_lists_in_sps[ i ] | ue(v) |
| for( j = 0; j < num_ref_pic_lists_in_sps[ i ]; j++) | |
| ref_pic_list_struct( i, j ) | |
| } | |
| if( ChromaArrayType != 0 ) | |
| qtbtt_dual_tree_intra_flag | u(1) |
| log2_min_luma_coding_block_size_minus2 | ue(v) |
| partition_constraints_override_enabled_flag | u(1) |
| sps_log2_diff_min_qt_min_cb_intra_slice_luma | ue(v) |
| sps_log2_diff_min_qt_min_cb_inter_slice | ue(v) |
| sps_max_mtt_hierarchy_depth_inter_slice | ue(v) |
| sps_max_mtt_hierarchy_depth_intra_slice_luma | ue(v) |
| if( sps_max_mtt_hierarchy_depth_intra_slice_luma != 0 ) { | |
| sps_log2_diff_max_bt_min_qt_intra_slice_luma | ue(v) |
| sps_log2_diff_max_tt_min_qt_intra_slice_luma | ue(v) |
| } | |
| if( sps_max_mtt_hierarchy_depth_inter_slice != 0 ) { | |
| sps_log2_diff_max_bt_min_qt_inter_slice | ue(v) |
| sps_log2_diff_max_tt_min_qt_inter_slice | ue(v) |
| } | |
| if( qtbtt_dual_tree_intra_flag ) { | |
| sps_log2_diff_min_qt_min_cb_intra_slice_chroma | ue(v) |
| sps_max_mtt_hierarchy_depth_intra_slice_chroma | ue(v) |
| if( sps_max_mtt_hierarchy_depth_intra_slice_chroma != 0 ) { | |
| sps_log2_diff_max_bt_min_qt_intra_slice_chroma | ue(v) |
| sps_log2_diff_max_tt_min_qt_intra_slice_chroma | ue(v) |
| } | |
| } | |
| sps_max_luma_transform_size_64_flag | u(1) |
| sps_joint_cbcr_enabled_flag | u(1) |
| if( ChromaArrayType != 0 ) { | |
| same_qp_table_for_chroma | u(1) |
| numQpTables = same_qp_table_for_chroma ? 1 : ( sps_joint_cbcr_enabled_flag ? 3 : | |
| 2 ) | |
| for( i = 0; i < numQpTables; i++ ) { | |
| qp_table_start_minus26[ i ] | se(v) |
| num_points_in_qp_table_minus1[ i ] | ue(v) |
| for( j = 0; j <= num_points_in_qp_table_minus1[ i ]; j++ ) { | |
| delta_qp_in_val_minus1[ i ][ j ] | ue(v) |
| delta_qp_diff_val[ i ][ j ] | ue(v) |
| } | |
| } | |
| } | |
| sps_sao_enabled_flag | u(1) |
| sps_alf_enabled_flag | u(1) |
| sps_transform_skip_enabled_flag | u(1) |
| if( sps_transform_skip_enabled_flag ) | |
| sps_bdpcm_enabled_flag | u(1) |
| if( sps_bdpcm_enabled_flag && chroma_format_idc = = 3 ) | |
| sps_bdpcm_chroma_enabled_flag | u(1) |
| sps_ref_wraparound_enabled_flag | u(1) |
| if( sps_ref_wraparound_enabled_flag ) | |
| sps_ref_wraparound_offset_minus1 | ue(v) |
| sps_temporal_mvp_enabled_flag | u(1) |
| if( sps_temporal_mvp_enabled_flag ) | |
| sps_sbtmvp_enabled_flag | u(1) |
| sps_amvr_enabled_flag | u(1) |
| sps_bdof_enabled_flag | u(1) |
| if( sps_bdof_enabled_flag ) | |
| sps_bdof_pic_present_flag | |
| sps_smvd_enabled_flag | u(1) |
| sps_dmvr_enabled_flag | u(1) |
| if( sps_dmvr_enabled_flag) | |
| sps_dmvr_pic_present_flag | u(1) |
| sps_mmvd_enabled_flag | u(1) |
| sps_isp_enabled_fag | u(1) |
| sps_mrl_enabled_flag | |
| sps_mip_enabled_flag | u(1) |
| if( ChromaArrayType != 0 ) | |
| sps_cclm_enabled_flag | u(1) |
| if( sps_cclm_enabled_flag && chroma_format_idc = = 1 ) | |
| sps_cclm_colocated_chroma_flag | |
| sps_mts_enabled_flag | u(1) |
| if( sps_mts_enabled flag ) { | |
| sps_explicit_mts_intra_enabled_flag | u(1) |
| sps_explicit_mts_inter_enabled_flag | u(1) |
| } | |
| sps_sbt_enabled_flag | u(1) |
| sps_affine_enabled_flag | u(1) |
| if( sps_affine_enabled_flag ) { | |
| sps_affine_type_flag | u(1) |
| sps_affine_amvr_enabled_flag | u(1) |
| sps_affine_prof_enabled_flag | u(1) |
| if( sps_affine_prof_enabled_flag ) | |
| sps_prof_pic_present_flag | u(1) |
| } | |
| if( chroma_format_idc = = 3 ) { | |
| sps_palette_enabled_flag | u(1) |
| sps_act_enabled_flag | u(1) |
| } | |
| sps_bcw_enabled_flag | u(1) |
| sps_ibc_enabled_flag | u(1) |
| sps_ciip_enabled_flag | u(1) |
| if( sps_mmvd_enabled_flag ) | |
| sps_fpel_mmvd_enabled_flag | u(1) |
| sps_triangle_enabled_flag | u(1) |
| sps_lmcs_enabled_flag | u(1) |
| sps_lfnst_enabled_flag | u(1) |
| sps_ladf_enabled_flag | u(1) |
| if( sps_ladf_enabled_flag ) { | |
| sps_num_ladf_intervals_minus2 | u(2) |
| sps_ladf_lowest_interval_qp_offset | se(v) |
| for( i = 0; i < sps_num_ladf_intervals_minus2 + 1; i++ ) { | |
| sps_ladf_qp_offset[ i ] | se(v) |
| sps_ladf_delta_threshold_minus1[ i ] | ue(v) |
| } | |
| } | |
| sps_scaling_list_enabled_flag | u(1) |
| sps_loop_filter_across_virtual_boundaries_disabled_present_flag | u(1) |
| if( sps_loop_filter_across_virtual_boundaries_disabled_present_flag ) { | |
| sps_num_ver_virtual_boundaries | u(2) |
| for( i = 0; i < sps_num_ver_virtual_boundaries; i++ ) | |
| sps_virtual_boundaries_pos_x[ i ] | u(13) |
| sps_num_hor_virtual_boundaries | u(2) |
| for( i = 0; i < sps_num_hor_virtual_boundaries; i++ ) | |
| sps_virtual_boundaries_pos_y[ i ] | u(13) |
| } | |
| if( sps_ptl_dpb_hrd_params_present_flag ) { | |
| sps_general_hrd_params_present_flag | u(1) |
| if( sps_general_hrd_params_present_flag ) { | |
| general_hrd_parameters( ) | |
| if( sps_max_sub_layers_minus1 > 0 ) | |
| sps_sub_layer_cpb_params_present_flag | u(1) |
| firstSubLayer = sps_sub_layer_cpb_params_present_flag ? 0 : | |
| sps_max_sub_layers_minus1 | |
| ols_hrd_parameters( firstSubLayer, sps_max_sub_layers_minus1 ) | |
| } | |
| } | |
| vui_parameters_present_flag | u(1) |
| if( vui_parameters_present_flag ) | |
| vui_parameters( ) | |
| sps_extension_flag | u(1) |
| if( sps_extension_flag ) | |
| while( more_rbsp_data( ) ) | |
| sps_extension_data_flag | u(1) |
| rbsp_trailing_bits( ) | |
| } | |

With respect to Table 3, JVET-P2001 provides the following semantics:

An SPS RBSP shall be available to the decoding process prior to it being referenced, included in at least one AU with Temporalld equal to 0 or provided through external means.

All SPS NAL units with a particular value of sps_seq_parameter_set_id in a CVS shall have the same content.
sps_decoding_parameter_set_id. when greater than 0, specifies the value of dps_decoding_parameter_set_id for the DPS referred to by the SPS. When sps_decoding_parameter_set_id is equal to 0. the SPS does not refer to a DPS and no DPS is referred to when decoding each CLVS referring to the SPS. The value of sps_decoding_parameter_set_id shall be the same in all SPSs that are referred to by coded pictures in a bitstream.
sps_video_parameter_set_id, when greater than 0, specifies the value of vps_video_parameter_set_id for the VPS referred to by the SPS.

When sps_video_parameter_set_id is equal to 0, the following applies:
The SPS does not refer to a VPS.
No VPS is referred to when decoding each CLVS referring to the SPS.
The value of vps_max_layers_minus1 is inferred to be equal to 0.
The CVS shall contain only one layer (i.e., all VCL NAL unit in the CVS shall have the same value of nuh_layer_id).
The value of GeneralLayerIdx[nuh_layer_id] is inferred to be equal to 0.
The value of vps_independent_layer_flag [GeneralLayeridx[nuh_layer_id]] is inferred to be equal to 1. When vps_independent_layer_flag[GeneralLayerIdx[nuh_layer_id]] is equal to 1, the SPS referred to by a CLVS with a partieluar nuh_layer_id value nuhLayerId shall have nuh_layer_id equal to nuhLayerId.
sps_max_sub_layers_minus1 plus 1 specifics the maximum number of temporal sub-layers that may be present in each CLVS referring to the SPS. The value of sps_max_sub_layers_minus1 shall be in the range of 0 to vps_max_sub_layers_minus1, inclusive.
sps_reserved_zero_4bits shall be equal to 0 in bitstreams conforming to this version of this Specification. Other values for sps_reserved_zero_4bits are reserved for future use by ITU-T|ISO/IEC.
sps_ptl_dpb_hrd_params present_flag equal to 1 specifics that a profile_tier_level( ) syntax structure and a dpb_parameters( ) syntax structure are present in the SPS, and a general_hrd_parameters( ) syntax structure and an ols_hrd_parameters( ) syntax structure may also be present in the SPS. sps_ptl_dpb_hrd_params_present_flag equal to 0 specifies that none of these syntax structures is present in the SPS. The value of sps_ptl_dpb_hrd_params_present_flag shall be equal to vps_independent_layer_flag [nuh_layer_id]
If vps_independent_layer_flag[GeneralLayerIdx[auth_layer_id]] is equal equal to 1, the variable MaxDecPicBuffMinus is sct equal to max_dec_pic_buffering_minus1[sps_max_sub_layers_minus1] in the dpb_parameters( ) syntax structure in the SPS. Otherwise, MaxDecPicBuffMinus1 is set equal to max_dec_pic_buffering_minus1] sps_max_sub_layers_minus 1] in the layer_nonoutput_dpb_params_idx [GeneralLayerIdx[nuh_layer_id]]-th dpb_parameters( ) syntax structure in the VPS.
gdr_enabled_flag equal to 1 specifies that GDR. pictures may be present in CLVSs referring to the SPS. gdr_enabled_flag equal to 0 specifies that GDR pictures are not present in CLVSs referring to the SPS.
sps_seq_parameter_set_id provides an identifier for the SPS for reference by other syntax elements.

SPS NAL units, regardless of the nuh_layer_id values, share the same value space of sps_seq_parameter_set_id.
chroma_format_id specifies the chroma sampling relative to the luma sampling.
separate_colour_plane_flag equal to 1 specifies that the three colour components of the 4:4:4 chroma format are coded separately. separate_colour_plane_flag equal to 0 specifies that the colour components are not coded separately. When separate_colour_plane_flag is not present, it is inferred 10 be equal to 0. When separate_colour_plane_flag is equal to 1, the coded picture consists of three separate components, each of which consists of coded samples of one colour plane (Y, Cb, of Cr) and uses the monochrome coding syntax. In this case, each colour plane is associated with a specific colour_plane_id value.
NOTE—There is no dependency in decoding processes between the colour planes having different colour_plane_id values. For example, the decoding process of a monochrome picture with one value of colour plane id does not use any data from monochrome pictures having different values of colour plane_id for inter prediction.

Depending on the value of separate_colour_plane_flag, the value of the variable ChromaArrayType is assigned as follows:
If separate colour plane flag is equal to 0, ChromaArrayType is set equal to chroma format idc.
Otherwise (separate_colour_plane_flag is equal to 1), ChromaArrayType is set equal to 0.
ref_pic_resampling_enabled_flag equal to 1 specifies that reference picture resampling may be applied when decoding coded pictures in the CLVSs referring to the SPS. ref_pic_resampling_enabled_flag equal to 0 specifics that reference picture resampling is not applied when decoding pictures in CLVSs referring to the SPS.
pic_width_max_in_luma_samples specifies the maximum width, in units of luma samples, of each decoded picture referring to the SPS. pic_width_max_in_luma_samples shall not be equal to 0 and shall be an integer multiple of Max (8, MinCbSizeY).
pic_height_max_in_lama_samples specifies the maximum height, in units of loma samples, of each decoded picture referring to the SPS. pic_height_max_in_luma_samples shall not be equal to 0 and shall be an integer multiple of Max (8, MinCbSizeY).
sps_log 2_ctu_size_minus5 plus 5 specifies the luma coding tree block size of each CTU. It is a requirement of bitstream conformance that the value of sps_log 2_clu_size_minus5 be less than or equal to 2.

The variables CtbLog 2SizeY and CtbSizeY are derived as follows:

$$CtbLog 2 SizeY = sps\_log 2 \_ctu \_size \_minus 5 + 5$$

$$CtbSizeY = 1 << CtbLog 2 SizeY$$

subpics_present_flag equal to 1 indicates that subpicture parameters are present in the present in the SPS RBSP syntax. subpics_present_flag equal to 0) indicates that subpicture parameters are not present in the present in the SPS RBSP syntax.
   NOTE—When a bitstream is the result of a sub-bitstream extraction process and contains only a subset of the subpictures of the input bitstream to the sub-bitstream extraction process, it might be required to set the value of subpics present flag equal to 1 in the RBSP of the SPSs.
sps_num_subpics_minus1 plus 1 specifies the number of subpictures. sps_num_subpics_minus1 shall be in the range of 0 to 254. When not present, the value of sps_num_subpics minus1 is inferred to be equal to 0.
subpic_ctu_top_left_x[i] specifies horizontal position of top left CTU of i-th subpicture in unit of CtbSizeY. The length of the syntax element is Ceil (Log 2(pic_width_max_in_luma_samples/CtbSizeY)) bits. When not present, the value of subpic_ctu_top_left_x[i] is inferred to be equal to 0.
subpic_etu_top_left_v[i] specifics vertical position of top left CTU of i-th subpicture in unit of CtbSizeY. The length of the syntax element is Ceil (Log 2 (pic_height_max_in_luma_samples/CtbSizeY)) bits. When not present, the value of subpic_ctu_top_left_v[i] is inferred to be equal to 0.
subpic_width_minus1[i] plus 1 specifies the width of the i-th subpicture in units of CtbSizeY. The length of the syntax element is Ceil (Log 2 (pic_width_max_in_luma_samples/CtbSizeY))bits. When not present, the value of subpic_width_minus1[i] is inferred to be equal to Ceil (pic_width_max_in_luma_samples/CtbSizeY)−1.
subpic_height_minus1[i] plus 1 specifies the height of the i-th subpicture in units of CtbSizeY. The length of the syntax element is Ceil (Log 2 (pic_height_max_in_luma_samples/CtbSizeY)) bits. When not present, the value of subpic_height_minus1[i] is inferred to be equal to Ceil (pic height max_in_luma_samples/CtbSizeY)−1.
subpic_treated_as_pic_flag[i] equal to 1 specifies that the i-th subpicture of each coded picture in the CLVS is treated as a picture in the decoding process excluding in-loop filtering operations. subpic_treated_as_pic_flag[i] equal to 0 specifics that the i-th subpicture of each coded picture in the CLVS is not treated as a picture in the decoding process excluding in-loop filtering operations. When not present, the value of subpic_treated as pic_flagl i] is inferred to be equal to( )
loop_filter_across_subpic_enabled_flag[i] equal to 1 specifies that in-loop filtering operations may be performed across the boundaries of i-th subpicture in each coded picture in the CLVS. the loop_filter across subpic_enabled_flag[i] equal to 0 specifies that in-loop filtering operations are not performed across the boundaries of the i-th subpicture in each coded picture in the CLVS. When not present, the value of loop_filter_across_subpic enabled pic flag[i] is inferred to be equal to 1.

It is a requirement of bitstream conformance that the following constraints apply:
For any two subpictures subpicA and subpicB, when the index of subpicA is less than the index of subpicB, any coded NAL unit of subPicA shall succeed any coded NAL unit of subPicB in decoding order.
The shapes of the subpictures shall be such that each subpicture, when decoded, shall have its entire left boundary and entire top boundary consisting of picture boundaries or consisting of boundaries of previously decoded subpictures.
sps_subpic_id_present_flag equal to 1 specifies that subpicture ID mapping is present in the SPS sps_subpic_id_present_flag equal to 0 specifies that subpicture ID mapping is not present in the SPS.
sps_subpic_id_signalling_present_flag equal to 1 specifies that subpicture ID mapping is signalled in the SPS. sps_subpic_id signalling present_flag equal to 0) specifies that subpicture ID mapping is not signalled in the SPS When not present, the value of sps_subpic_id_signalling_present_flag is inferred to be equal to 0.
sps_subpic_id_len_minus1 plus 1 specifies the number of bits used to represent the syntax element sps_subpic_id [i]. The value of sps_subpic_id_len_minus1 shall be in the range of 0 to 15, inclusive.
sps_subpic_id [1] specifies that subpicture ID of the i-th subpicture. The length of the sps_subpic_id [i] syntax element is sps_subpic_id_len_minus1+1 bits. When not present, and when sps_subpic_id_present_flag equal to 0. the value of sps_subpic_id[i] is inferred to be equal to i, for each i in the range of 0 to sps_num_subpics_minus1, inclusive
bit_depth_minus8 specifies the bit depth of the samples of the luma and chroma arrays, BitDepth, and the value of the luma and chroma quantization parameter range offset. QpBdOffset, as follows:

$$BitDepth = 8 + bit\_depth \_minus 8$$

$$QpBdOffset = 6 * bit\_depth \_minus 8$$

bit_depth_minus8 shall be in the range of 0 to 8, inclusive.
min_qp_prime_is_minus4 specifies the minimum allowed quantization parameter for transform skip mode as follows:

$$QpPrimeTsMin = 4 + min\_qp \_prime \_ts \_minus 4$$

The value of min_qp_prime_is_minus4 shall be in the range of 0 to 48. inclusive.
sps_weighted_pred_nag equal to 1 specifies that weighted prediction may be applied to P slices referring to the SPS. sps_weighted_pred_flag equal to 0 specifies that weighted prediction is not applied to P slices referring to the SPS.
sps_weighted_bipred_flag equal to 1 specifies that explicit weighted prediction may be applied to B slices referring to the SPS. sps_weighted_bipred_flag equal to 0 specifies that explicit weighted prediction is not applied to B slices referring to the SPS.
log 2_max pic_order_cut_Isb_minus4 specifics the value of the variable MaxPicOrderCntLsb that is used in the decoding process for picture order count as follows:

$$MaxPicOrderCntLsb = {2}^{( log 2 \_ max \_ pic \_ order \_ cnt \_ lsb \_ minus 4 ( 4 )}$$

The value of log 2_max_pic_order_cnt_lsb_minus4 shall be in the range of 0 to 12, inclusive.
sps_poc_msb_flag equal to 1 specifies that the ph_poc_msb_cycle_present_flag syntax element is present in PHs referring to the SPS. sps_poc_msb_flag equal to 0 specifies that the ph_poc_msb_cycle_present_flag syntax element is not present in PHs referring to the SPS.
poc_msb_len_minus1 plus i specifies the length, in bits, of the poc_msb_vai syntax elements, when present in the PHs referring to the SPS. The value of poc_msb_len_minus1 shall be in the range of 0 to 32-log 2_max_pic_order_cat_is_minus4-5, inclusive.
sps_sub_layer_dpb_params_flag is used to control the presence of max_dec_pic_buffering_minus1[i], max_num_reorder_pics [i], and max_latency_increase_plus1[i] syntax elements in the dpb_parameters( ) syntax strucure in the SPS. When not present, the value of sps_sub_dpb_params_info_present_flag is inferred to be equal to 0.
long_term_ref_pics_flag equal to 0 specifies that no LTRP is used for inter prediction of any coded picture in the CLVS. long_tenn_ref_pics_flag_equal to 1 specifies that LTRPs may be used for inter prediction of one or more coded pictures in the CLVS.
inter_layer_ref_pics_present_flag equal to 0 specifies that no ILRP is used for inter prediction of any coded picture in the CLVS. inter_layer_ref_pics_flag equal to 1 specifies that ILRPs may be used for inter prediction of one or more coded pictures in the CLVS. When sps_video_paramcter_set_id is equal to 0, the value of inter_layer_ref_pics_present_flag is inferred 10 be equal to 0. When vps_independent_layer_flag[GeneralLayerfdx[nuh_layer_id]] is equal to 1, the value of inter_layer_ref_pics_present_flag shall be equal to 0.
sps_idr_rpl_present_flag equal to 1 specifies that reference picture list syntax elements are present in slice headers of IDR pictures. sps_idr_rpl_present_flag equal to 0 specifies that reference picture list syntax elements are not present in slice headers of IDR pictures.
rpl1_same_as_rpl0_flag equal to 1 specifies that the syntax element num_ref_pic_lists_in_sps[1] and the syntax structure ref_pic_list_struct(1, rplsIdx) are not present and the following applies:
   The value of num_ref_pic_lists_in_sps[1] is inferred to be equal to the value of num_ref_pic_lists_in_sps[0]. The value of each of syntax elements in ref_pic_list_struct(1, rplsIdx) is inferred to be equal to the value of corresponding syntax element in ref_pic_list_struct(0, rplsIdx) for rplsldx ranging from 0 to num_ref_pic_lists_in_sps[0]-1.
num_ref_pic_lists_in_sps[i] specifies the number of the ref_pic_list_struct(listIdx, rplsIdx) syntax structures with listIdx equal to i included in the SPS. The value of num_ref_pic_lists_in_sps[i] shall be in the range of 0 to 64. inclusive.
   NOTE—For each value of listIdx (equal to 0 or 1), a decoder should allocate memory for a total number of num_ref_pic_lists_in_sps[i]+1 ref_pic_list_struct(listidx, rplsldx) syntax structures since there may be one ref_pic_list_struct(listidx, rplsIdx) syntax structure directly signalled in the slice headers of a current picture.
qtbtt_dual_tree_intra_flag equal to 1 specifies that for I slices. each CTU is split into coding units with 64×64 luma samples using an implicit quadtree split and that these coding units are the root of two separate coding_tree syntax structure for luma and chroma. qtott_dual_tree_intra flag equal to 0 specifies separate coding tree syntax structure is not used for I slices. When qtbtt_dual_tree_intra_flag is not present, it is inferred to be equal to 0.
log 2_min_luma_coding_block_size_minus2 plus 2 specifics the minimum luma coding block size. The value range of log 2_min_luma_coding_block_size_minus2 shall be in the range of 0 to log 2_ctu_size_minus5+3, inclusive.

The variables MinCbLog 2SizeY, MinCbSizeY, IbcBufWidthY, IbcBufWidthC and Vsize are derived as follows:

$$Min Cb Log 2 SizeY = log 2 \_min \_luma \_coding \_block \_size \_minus 2 + 2$$

$$MinCbSizeY = 1 << Min Cb Log 2 SizeY$$

$$IbcBufWidthY = 256 * 128 / CtbSizeY$$

$$IbcBufWidthC = IbcBufWidthY / SubWidthC$$

$$VSize = Min ( 64 , CtbSizeY )$$

The value of MinCbSizeY shall less than or equal to VSize.

The variables CtbWidthC and CtbHeightC, which specify the width and height, respectively, of the array for each chroma CTB, are derived as follows:
If chroma_format_idc is equal to 0 (monochrome) or separate_colour_plane_flag is equal to 1, CtbWidthC and CtbHeightC are both equal to 0.
Otherwise, CtbWidthC and CtbHeightC are derived as follows:

$$CtbWidthC = CtbSizeY / SubWidthC$$

$$CtbHeightC = CtbSizeY / SubHeightC$$

For log 2Block Width ranging from 0 to 4 and for log 2BlockHeight ranging from 0 to 4, inclusive. the up-right diagonal and raster scan order array initialization process as specified is invoked with 1<<log 2BlockWidth and 1<<log 2BlockHeight as inputs, and the output is assigned DiagScanOrder [log 2Block Width] [log 2BlockHeight] and Rastcr2DiagScanPos [log 2BlockWidth] [log 2BlockHeight].
For log 2Block Width ranging from 0 to 6 and for log 2BlockHeight ranging from 0 to 6, inclusive, the horizontal and vertical traverse scan order array initialization process as specified is invoked with 1<<log 2Block Width and 1<<log 2Block Height as inputs, and the output assigned to HorTravScanOrder[log 2Block Width] [log 2BlockHeight] and VerTravScanOrder[log 2BlockWidth] [log 2BlockHeight].
partition_constraints_override_enabled_flag equal to 1 specifies the presence of partition constraints override flag in PHs referring to the SPS. partition constraints override enabled flag equal to 0 specifies the absence of partition_constraints_override_flag in PHs referring to the SPS.
sps_log 2_diff_min_qt_min_cb_intra_slice_luma specifies the default difference between the base 2 logarithm of the minimum size in luma samples of a luma leaf block resulting from quadtree splitting of a CTU and the base 2 logarithm of the minimum coding block size in luma samples for luma CUs in slices with slice_type equal to 2 (I) referring to the SPS. When partition_constraints_override_enabled_flag is equal to 1, the default difference can be overridden by pic_log 2_diff_min_qt_min_cb_luma present in PIIs referring to the SPS. The value of sps_log 2_diff_min_qt_min_cb_intra_slice_luma shall be in the range of 0 to CrbLog 2SizeY−MinChLog 2SizeY, inclusive. The base 2 logarithm of the minimum size in luma samples of a lama leaf block resulting from quadtree splitting of a CTU is derived as follows:

$$MinQtLog 2 SizeIntraY = sps\_log2 \_diff \_min \_qt \_min \_cb \_intra \_slice \_luma + MinCbLog 2 SizeY$$

sps_log 2_diff_min_qt_min_cb_inter_slice specifies the default difference between the base 2 logarithm of the minimum size in luma samples of a luma leaf block resulting from quadtree splitting of a CTU and the base 2 logarithm of the minimum luma coding block size in luma samples for luma CUs in slices with slice_type equal to 0 (B) or 1(P) referring to the SPS. When partition_constraints_override_enabled_flag is equal to 1, the default difference can be overridden by pic log 2_diff_min_qt_min_ch_luma present in PHs referring to the SPS. The value of sps_log 2_diff_min_ot_min_cb_inter_slice shall be in the range of 0 to CtbLog 2SizeY−MinCbLog 2SizeY, inclusive. The base 2 logarithm of the minimum size in luna samples of a luma leaf block resulting from quadtrec splitting of a CTU is derived as follows:

$$MinQtLog 2 SizeInterY = sps\_log2 \_diff \_min \_qt \_min \_cb \_inter \_slice + MinCbLog 2 SizeY$$

sps_max_mtt_hierarchy_depth_inter_slice specifies the default maximum hierarchy_depth for coding units resulting from multi-type tree splitting of a quadtree leaf in slices with slice_type equal to 0 (B) or 1 (P) referring to the SPS. When partition_constraints_override_enabled_flag is equal to 1, the default maximum hierarchy_depth can be overridden by pic_max_mtt_hierarchy_depth_inter_slice present in PHs referring to the SPS. The value of sps_max_mtt_hierarchy_depth_inter_slice shall be in the range of 0 to CtbLog 2SizeY−MinChLog 2SizeY, inclusive.
sps_max_mtt_hierarchy_depth_intra_slice_luma specifies the default maximum hierarchy_depth for coding units resulting from multi-type tree splitting of a quadtree leaf in slices with slice_type equal to 2 (1) referring to the SPS. When partition_constraints_override_enabled_flag is equal to 1, the default maximum hierarchy_depth can be overridden by pic_max_mit_hierarchy_depth_intra_slice_luma present in PHs referring to the SPS. The value of sps_max_mtt_hierarchy_depth_intra_slice_luma shall be in the range of 0 to CtbLog 2SizeY−MinChLog 2SizeY, inclusive.
sps_log 2_diff_max_bt_min_qt_intra_slice_luma specifies the default difference between the base 2 logarithm of the maximum size (width or height) in luma samples of a luma coding block that can be split using a binary split and the minimum size (width or height) in luma samples of a luma leaf block resulting from quadtree splitting of a CTU in slices with slice_type equal to 2 (I) referring to the SPS. When partition_constraints_override_enabled_flag is equal to 1. the default difference can be overridden by pic_log 2_diff_max_bt_min_qt_luma present in PHs referring to the SPS. The value of sps_log 2_diff_max_bt_min_gt_intra_slice_luma shall be in the range of 0 10 CtbLog 2SizeY−MinQLog 2SizeIntraY, inclusive. When sps_log 2_diff_max_bt_min_qi_intra_slice_luma is not present, the value of sps_log 2_diff_max_bt_min_qt_intra_slice_luma is inferred to be equal to 0.
sps_log 2_diff_max_tt_min_qt_intra_slice_luma specifies the default difference between the base 2 logarithm of the maximum size (width or height) in luma samples of a luna coding block that can be split using a ternary split and the minimum size (width or height) in luma samples of a luma leaf block resulting from quadtree splitting of a CTU in slices with slice_type equal to 2 (I) referring to the SPS. When partition_constraints_override_enabled_flag is equal to 1. the default difference can be overridden by pic_log 2_diff_max_At_min_of_luma present in PHIs referring to the SPS. The value of sps_log 2_diff_max_tt_min_qt_intra_slice_luma shall be in the range of 0 to CtbLog 2SizeY−MinQLog 2SizeIntraY, inclusive. When sps_log 2_diff max_it_min_qt_intra_slice_luma is not present. the value of sps_log 2_diff_max_tt_min_qt_intra_slice_luma is inferred to be equal to 0.
sps_log 2_diff_max_bt_min_qt_inter_slice specifies the default difference between the base 2 logarithm of the maximum size (width or height) in luma samples of a luma coding block that can be split using a binary split and the minimum size (width or height) in luma samples of a luna leaf block resulting from quadtree splitting of a CTU in slices with slice_type equal to 0 (B) or I (P) referring to the SPS. When partition_constraints_override_enabled_flag is equal to 1, the default difference can be overridden by pic_log 2_diff_max_bt_mitt_qt_luma present in PHs referring to the SPS. The value of sps_log 2_diff_max_bt_min_g1_inter_slice shall be in the range of 0 to CtbLog 2SizeY−MinQiLog 2SizeInterY, inclusive. When sps_log 2_diff max bt min_qt inter slice is not present, the value of sps_log 2_diff_max_bt_min_qt_inter_slice is inferred to be equal to 0.
sps_log 2_diff_max_tt_min_qt_inter_slice specifies the default difference between the base 2 logarithm of the maximum size (width or height) in luma samples of a luma coding block that can be split using a ternary split and the minimum size (width or height) in luma samples of a fama leaf block resulting from quadtree splitting of a CTU in slices with slice_type equal to 0 (B) or I (P) referring to the SPS. When partition_constraints_override_cnabled_flag is equal to 1, the default difference can be overridden by pic_log 2_diff_max_tt_min_qt_luma present in PHs referring to the SPS. The value of sps_log 2_diff max tt min_qt inter slice shall be in the range of 0 to CtbLog 2SizeY−MinQtLog 2SizeInterY. inclusive. When sps_log 2_diff_max_It_min_qt_inter_slice is not present, the value of sps_log 2_diff_max_tt_min_qt_inter_slice is inferred to be equal to 0.
sps_log 2_diff_min_qt_min_cb_intra_slice_chroma specifies the default difference between the base 2 logaritlun of the minimum size in luma samples of a chroma leaf block resulting from quadtree splitting of a chroma CTU with treeType equal to DUAL_TREE_CHROMA and the base 2 logarithm of the minimum coding block size in huma samples for chroma CUs with treeType equal to DUAL_TREE_CHROMA in slices with slice_type equal to 2 (1) referring to the SPS. When partition_constraints_override_enabled_flag is equal to 1. the default difference can be overridden by pic_log 2_diff_min_qt_min_cb_chroma present in PHs referring to the SPS. The value of sps_log 2_diff_min_ql_min_cb_intra_slice_chroma shall be in the range of 0 to CtbLog 2SizeY−MinCbLog 2SizeY, inclusive. When not present. the value of sps_log 2_diff_min_qt_min_cb_intra_slice_chroma is inferred to be equal to 0). The base 2 logarithm of the minimum size in luma samples of a chroma leaf block resulting from quadtree splitting of a CTU with treeType equal to DUAL TREE_CHROMA is derived as follows:

$$MinQtLog 2 SizeIntraC = sps\_log2 \_diff \_min \_qt \_min \_cb \_intra \_slice \_chroma + MinCbLog 2 SizeY$$

sps_max_mtt_hierarchy_depth_intra_slice_chroma specifies the default maximum hierarchy_depth for chroma coding units resulting from multi-type tree splitting of a chroma quadtree leaf with treeType equal to DUAL_TREE_CHROMA in slices with slice_type equal to 2 (1) referring to the SPS. When partition_constraints_override_enabled_flag is equal to}, the default maximum hierarchy_depth can be overridden by pic_max_mtt_hierarchy_depth_chroma present in PHs referring to the SPS. The value of sps_max_mtt_hierarchy_depth_intra_slice_chroma shall be in the range of 0 to CtbLog 2SizeY−MinChLog?SizeY. inclusive. When not present, the value of sps_max_mtt_hierarchy_depth_intra_slice_chroma is inferred to be equal to 0.
sps_log 2_diff_max_bt_min_qt_intra_slice_chroma specifies the default difference between the base 2 logarithm of the maximum size (width or height) in luma samples of a chroma coding block that can be split using a binary split and the minimum size (width or height) in luma samples of a chroma leaf block resulting from quadtree splitting of a chroma CTU with treeType equal to DUAL_TREE_CHROMA in slices with slice_type equal to 2 (I) referring to the SPS. When partition_constraints_override_enabled_flag is equal to 1, the default difference can be overridden by pic_log 2_diff_max_bt_min_qt_chroma present in PIIs referring 10 the SPS. The value of sps_log 2_diff_max_bt_min_qt_intra_slice_chroma shall bc in the range of 0 to CtbLog 2SizeY−MinQtLog 2SizeintraC, inclusive. When sps_log 2_diff_max_bt_min_qt_intra_slice_chroma is not present, the value of sps_log 2_diff_max_bt_min_qt_intra_slice_chroma is inferred to be equal to 0.
sps_log 2_diff max_tt_min_qt_intra_slice chroma specifies the default difference between the base 2 logarithm of the maximum size (width or height) in luma samples of a chroma coding block that can be split using a ternary split and the minimum size (width or height) in luma samples of a chroma leaf block resulting from quaduree splitting of a chroma CTU with treeType equal to DUAL_TREE_CHROMA in slices with slice_type equal to 2 (1) referring to the SPS. When partition_constraints override enabled flag is equal to 1, the default difference can be overridden by pic_log 2_diff_max_tt_min_qt_chroma present or PHs referring to the SPS. The value of sps_log 2_diff_max_tt_min_qt_intra_slice_chroma shail be in the range of 0 10 CtbLog 2SizeY−MinQILog 2SizeIntraC, inclusive. When sps_log 2_diff max tt_min_qt intra slice chroma is not present. the value of sps_log 2_diff max_tt min_qt intra slice chroma is inferred to be equal to 0.
sps_max_luma_transform_size_64_flag equal to 1 specifies that the maximum transform size in luma samples is equal to 64. sps_max luma transform_size_64_flag equal to 0 specifies that the maximum transform size in luma samples is equal to 32.

When CtbSizeY is less than 64, the value of sps_max_luma_transform_size_64_flag shall be equal to 0.

The variables MinTbLog 2Size Y, MaxTbLog 2Size Y, MinTbSize Y, and MaxTbSizeY are derived as follows:

$$MinTbLog 2 SizeY = 2$$

$$MaxTbLog 2 SizeY = sps\_max \_luma \_transform \_size \_ 64 \_flag ? 6 : 5$$

$$MinTbSizeY = 1 ≪ MinTbLog 2 SizeY$$

$$MaxTbSizeY = 1 ≪ MaxTbLog 2 SizeY$$

sps_joint_cher_enabled_flag equal to 0 specifies that the joint coding of chroma residuals is disabled. sps_joint_cher_enabled_flag equal to i specifies that the joint coding of chroma residuals is enabled.
same qp_table_for_chroma equal to 1 specifics that only one chroma OP mapping table is signalled and this table applies to Cb and Cr residuals as well as joint Cb-Cr residuals. same_qp_table_for_chroma equal to 0 specifies that three chroma QP mapping tables are signalled in the SPS. When same_qp_table_for_chroma is not present in the bistream, the value of same_qp_table_for_chroma is inferred to be equal to 1.
qp_table_start_minus26 [i] plus 26 specifies the starting luma and chroma QP used to describe the i-th chroma QP mapping table. The value of qp_table_start_minus26 [i] shall be in the range of −26-QpBdOffsetC to 36 inclusive. When qp_table_start_minus26 [i] is not present in the bitstream, the value of qp_table_start_minus26 [i] is inferred to be equal to 0.
num_points_in_qp_table_minust [i] plus 1 specifies the number of points used to describe the i-th chroma QP mapping table. The value of num points in qp table_minus1[i] shall be in the range of 0 to 63+QpBdOffset, inclusive. When num points_in_qp_table minus1[0] is not present in the bitstream, the value of num_points_in_qp_table_minus 1[0] is inferred to be equal to 0.
delta_on_in_val_minus1[i] [i] specifies a delta value used to derive the input coordinate of the j-th pivot point of the i-th chroma QP mapping table. When delta_qp_in_val_minus1[0] [i] is not present in the bitstream, the value of delta_qp_in_val_minus1[0] [i] is inferred to be equal to 0.
delta qp_diff_vall i ∥ j] specifies a delta value used to derive the output coordinate of the j-th pivot point of the i-th chroma QP mapping table. When delta qp_out_val [0] [i] is not present in the bitstream, the value of delta_qp_out_val [0][i] is inferred to be equal to 0.

The i-th chroma QP mapping table ChromaQpTable [i] for i=0 . . . same_qp_table_for_chroma? 0:2 is derived as follows:

```
qpInVal[ i ][ 0 ] = −qp_table_start_minus26[ i ] + 26
qpOutVal[ i ][ 0] = qpInval[ i ][ 0 ]
for( j = 0, j <= num points in qp table minus1[ i ], j++ ) {
  qpInVal[ i ][ j + 1 ] = qpInVal[ i ][ j ] + delta_qp_in_val_minus1[ i ][ j ] + 1
  qpOutVal[ i ][ j + 1 ] = qpOutVal[ i ][ j ] +
( delta_qp_in_val_minus1[ i ][ j ] \hat{ } delta_qp_diff_val[ i ][ j ] )
}
ChromaQpTable[ i ][ qpInVal[ i ][ 0 ] ] = qpOutVal[ i ][ 0 ]
for( k = qpInVal[ i ][ 0 ] − 1: k >= −QpBdOffset: k − − )
  ChromaQpTable[ i ][ k ] = Clip3( −QpBdOffset, 63, ChromaQpTable[ i ][ k + 1 ] − 1 )
for( j = 0, j <+ num_points_in_qp_table_minus1[ i ], j++ ) {
  sh − ( delta qp_in_val_minus1[ i ][j ] + 1 ) >> 1
  for( k = qpInVal[ i ][ j ] + 1, m = 1; k <= qpInval[ i ][ j + 1 ]; k++, m++ )
    ChromaQpTable[ i ][ k ] = ChromaQpTable[ i ][ qpInVal[ i ][ j ] ] +
    ( ( qpOutVal[ i ][j + 1] − qpOutVal[ i ][j ] ) * m + sh ) /
( delta_qp_in_val_minus1[ i ][j] + 1 )
}
for( k = qpInVal[ i ][ num_points_in_qp_table_minus1[ i ] + 1 ] + 1; k <= 63; k++ )
  ChromaQpTable[ i ][ k ] = Clip3( −QpBdOfset, 63, ChromaQpTable[ i ][ k − 1 ] + 1 )
```

When same_qp_table_for_chroma is equal to 1, ChromaQpTable [1] [k] and ChromaQpTable [2][k] are set equal to ChromaQpTable [0] [k] for k=-QpBdOffset.63.
It is a requirement of bitstream conformance that the values of qpIn Val[i][j] and qpOutVal[1][j] shall be in the range of −QpBdOffset to 63. inclusive for i=0. same qp table for chroma?0:2 and j=0. num points in qp table minus] [i]+1.
sps_sao_enabled_flag equal to 1 specifics that the sample adaptive offset process is applied to the reconstructed picture after the deblocking filter process. sps_sao enabled flag equal to 0 specifies that the sample adaptive offset process is not applied to the reconstructed picture after the deblocking filter process.
sps_alf_enabled_flag equal to 0 specifies that the adaptive loop filter is disabled sps_alf_enabled_flag equal to l specifies that the adaptive loop filter is enabled.
sps_transform_skip_enabled_flag equal to 1 specifies that transform_skip_flag may be present in the transform unit syntax. sps_transform_skip_enabled_Dag equal to 0 specifies that transform_skip_flag is not present in the transform unit syntax
sps_bdpem_enabled_flag equal to 1 specifies that intra bdpem_luma flag may be present in the coding unit syntax for intra coding units. sps_bdpom enabled flag equal to 0 specifies that intra bdpcm luma flag is not present in the coding unit syntax for intra coding units. When not present. the value of sps_bdpem_enabled_flag is inferred to be equal to 0.
sps_bdpcm_chroma_enabled_flag equal to 1 specifics that intra_bdpem_chroma_flag may be present in the coding unit syntax for intra coding units. sps_bdpcm_chroma_enabled_flag equal to 0 specifies that intra_bdpem_chroma_flag is not present in the coding unit syntax for intra coding units. When not present, the value of sps_bdpcm_chroma_enabled_flag is inferred to be equal to 0.
sps_ref_wraparound_caabled_flag equal to 1 specifies that horizontal wrap-around motion compensation is applied in inter prediction. sps_ref wraparound enabled_flag equal to 0 specifies that horizontal wrap-around motion compensation is not applied. When the value of (CtbSizeY/MinCbSizeY+1) is less than or equal to (pic_width_in_luma_samples/MinChSizeY−1), where pic_width_in_luma_samples is the value of pic_width in_luma_samples in any PPS that refers to the SPS, the value of sps_ref_wraparound enabled flag shall be equal to 0.
sps_ref_wraparound_offset_minus1 plus 1 specifies the offset used for computing the horizontal wrap-around position in units of MinCbSizeY luma samples. The value of ref_wraparound_offset_minusI shall be in the range of (CtbSizeY/MinCbSizeY)+1 10 (pic_width_in_luma_samples/MinCbSizeY)−1. inclusive. where pic_width_in_luma_samples is the value of pic_width_in_luma_samples in any PPS that refers to the SPS.
sps_temporal_mvp_enabled_flag equal to 1 specifies that temporal motion vector predictors may be used in the CLVS. sps_temporal_mvp_enabled_flag equal to 0 specifies that temporal motion vector predictors are not used in the CLVS.
sps_shtmvp_enabled_flag equal to 1 specifies that subblock-based temporal motion vector predictors may be used in decoding of pictures with all slices having slice_type not equal to 1 in the CLVS. sps_sbtmvp_enabled_flag equal to 0 specifies that subblock-based temporal motion vector predictors are not used in the CLVS. When sps_sbtmvp_enabled_flag is not present, it is inferred to be equal to 0.
sps_amvr enabled_flag equal to 1 specifies that adaptive motion vector difference resolution is used in motion vector coding. amvr_enabled_flag equal to 0 specifies that adaptive motion vector difference resolution is not used in motion vector coding.
sps_bdof_enabled_flag equal to 0 specifies that the bi-directional optical flow inter prediction is disabled. sps_bdof_enabled_flag equal to 1 specifies that the bi-directional optical flow inter prediction is enabled.
sps_bdof_plc_present_flag equal to 1 specifics that pic disable bdof flag is present in PHs referring to the SPS. sps_bdof pic_present_flag equal to 0 specifies that pic disable_bdof flag is not present in PHs referring to the SPS. When sps_bdof pic present_flag is not present, the value of sps_bdof pic_present_flag is inferred to be equal to 0.
sps_smavd_enabled_nag equal to 1 specifies that symmetric motion vector difference may be used in motion vector decoding. sps_sivd_enabled_flag equal to 0 specifies that symmetric motion vector difference is not used in motion vector coding.
sps_dmvr_enabled_flag equal to 1 specifies that decoder motion vector refinement based inter bi-prediction is enabled. sps_dmyr_enabled_flag equal to 0 specifies that decoder motion vector refinement based inter bi-prediction is disabled.
sps_dmvr_pic_present_flag equal to 1 specifics that pic_disable_dmvr_flag is present in PHs referring to the SPS. sps_duivr_pic_present_flag equal to 0 specifies that pic_disable_divr_flag is not present in PHs referring to the SPS. When sps_dmvr_pic_present_flag is not present, the value of sps_dmvr_pic_present_flag is inferred to be equal to 0.
sps_mmvd_enabled_flag equal to 1 specifies that merge mode with motion vector difference is enabled. sps_mmvd_enabled_flag equal to 0 specifies that merge mode with motion vector difference is disabled.
sps_isp_enabled_flag equal to 1 specifics that intra prediction with subpartitions is enabled. sps_isp_enabled_flag equal to 0) specifies that intra prediction with subpartitions is disabled.
sps_mri_enabled_flag equal to 1 specifies that intra prediction with multiple reference lines is enabled. sps_mrl_enabled_flag equal to( ) specifies that intra prediction with multiple reference lines is disabled.
sps_mip_enabled_flag equal to 1 specifies that matrix-based intra prediction is enabled. sps_mip_enabled_flag equal to O specifies that matrix-based intra prediction is disabled.
sps_cclm_enabled_flag equal to 0 specifics that the cross-component linear model intra prediction from luma component to chroma component is disabled. sps_cclm enabled flag equal to 1 specifies that the cross-component linear model intra prediction from luma component to chroma componenent is enabled. When sps_celm_enabled_flag is not present, it is inferred to be equal to 0).
sps_celm_colocated_chroma_flag equal to 1 specifies that the top-left downsampled luma sample in cross-component linear model intra prediction is collocated with the top-left luma sample. sps_celm_colocated_chroma_flag equal to 0 specifies that the top-left downsampled luma sample in cross-component linear model intra prediction is horizontally co-sited with the top-left luma sample but vertically shifted by 0.5 units of luma samples relatively to the top-left luma sample.
sps_mts_enabled_flag equal to 1 specifics that sps_explicit_mts_intra_enabled_flag is present in the sequence parameter set RBSP syntax and that sps_explicit_mts_inter_enabled_flag is present in the sequence parameter set RBSP syntax. sps_mts_enabled_flag equal to 0) specifies that sps_explicit mts intra enabled flag is not present in the sequence parameter set RBSP syntax and that sps_explicit mts inter enabled flag is not present in the sequence parameter set RBSP syntax.
sps_explicit_mts_intra_enabled_flag equal to 1 specifies that mts_idx may be present in intra coding unit syntax. sps_explicit_mts_intra_enabled_flag equal to 0 specifies that mts_idx is not present in intra coding unit syntax. When not present, the value of sps_explicit_mis_intra_enabled_flag is inferred to be equal to 0.
sps_explicit_mts_inter_enabled_flag equal to 1 specifies that its_idx may be present in inter coding unit syntax. sps_explicit_mts_inter_enabled_flag equal to 0 specifies that mts_idx is not present in inter coding unit syntax. When not present, the value of sps_explicit_mts_inter_enabled_flag is inferred to be equal to 0.
sps_sbt_enabled_flag equal to 0 specifies that subblock transform for inter-predicted CUs is disabled. sps_sbt_enabled_flag equal to 1 specifies that subblock transform for inter-predicteds CU is enabled.
sps_affine_enabled_flag specifies whether affine model based motion compensation can be used for inter prediction. If sps_affine_enabled_flag is equal to 0, the syntax shall be constrained such that no affine model based motion compensation is used in the CLVS, and inter_affine_flag and cu_affine_type_flag are not present in coding unit syntax of the CLVS. Otherwise (sps_affine_enabled_flag is equal to 1), affine model based motion compensation can be used in the CLVS.
sps_affine_type_flag specifies whether 6-parameter affine model based motion compensation can be used for inter prediction. If sps_affine_type_flag is equal to 0, the syntax shall be constrained such that no 6-parameter affine model based motion compensation is used in the CLVS, and cu_affine_type_flag is not present in coding unit syntax in the CLVS. Otherwise (sps_affine_type_flag is equal to 1), 6-parameter affine model based motion compensation can be used in the CLVS. When not present, the value of sps_affine_type_flag is inferred to be equal to 0.
sps_affine_amvr_enabled_flag equal to 1 specifics that adaptive motion vector difference resolution is used in motion vector coding of affine inter mode. sps_affine_amvr_enabled_flag equal to 0 specifics that adaptive motion vector difference resolution is not used in motion vector coding of affine inter mode.
sps_affine_prof_enabled_flag specifics whether the prediction refinement with optical flow can be used for affine motion compensation. If sps_affine prof enabled flag is equal to 0, the affine motion compensation shall not be refined with optical flow. Otherwise (sps_affine_prof_enabled_flag is equal to 1), the affine motion compensation can be refined with optical flow. When not present, the value of sps_affine_prof_enabled_llag is inferred to be equal to 0).
sps_prof_pic_present_flag equal to 1 specifies that pic_disable_prof_flag is present in PHs referring to the SPS. sps_prof_pic_present_flag equal to 0 specifies that pic_disable_prof_flag is not present in PHs referring to the SPS. When sps_prof_pic_present_flag is not present, the value of sps_prof_pic_present_flag is inferred to be equal to 0.
sps_palette_enabled_flag equal to 1 specifics that pred_mode_plt_flag may be present in the coding unit syntax. sps_palette_enabled_flag equal to 0 specifics that pred_mode_plt_flag is not present in the coding unit syntax. When sps_palette_enabled_flag is not present, it is inferred to be equal to 0.
sps_act_enabled_fing specifies that whether adaptive colour transform is enabled. If sps_act enabled flag is equal to 1, adaptive colour transforin may be used and the flag cu act enabled_flag may be present in the coding unit syntax. If sps_act_enabled_flag is equal to 0), adaptive colour transform is not used and cu_act_enabled_flag is not present in the coding unit syntax When sps_act enabled_flag is not present, it is inferred to be be equal to 0.
sps_bew_enabled_flag specifies whether bi-prediction with CU weights can be used for inter prediction. If sps_bow_enabled_flag is equal to 0, the syntax shall be constrained such that no bi-prediction with CU weights is used in the CLVS, and bew idx is not present in coding unit syntax of the CLVS. Otherwise (sps_bew enabled flag is exqual to 1), bi-prediction with CU weights can be used in the CLVS.
sps_ibc_enabled_flag equal to 1 specifies that the IBC prediction mode may be used in decoding of pictures in the CLVS. sps_ibc_enabled_flag equal to 0 specifies that the IDC prediction mode is not used in the CLVS. When sps_ibe enabled flag is not present, il is inferred to be equal to 0).
xps_ciip_enabled_flag specifies that ciip_flag may be present in the coding unit syntax for inter coding nnits. sps_ciip_enabled_flag equal to 0 specifies that ciip_flag is not present in the coding unit syntax for inter coding units.
sps_fpel_mmvd_enabled_flag equal to 1 specifies that merge mode with motion vector difference is using integer sample precision. sps_fpel_mmvd_enabled_flag equal to 0) specifies that merge mode with motion vector difference can use fractional sample precision.
sps_triangle_enabled_flag specifies whether triangular shape based motion compensation can be used for inter prediction. sps_triangle enabled flag equal to 0 specifies that the syntax shall be constrained such that no triangular shape based motion compensation is used in the CLVS, and merge_triangle_split_dir, merge_triangle_idx0, and merge triangle idxl are not present in coding unit syntax of the CLVS. sps_triangle enabled flag equal to 1 specifies that triangular shape based motion compensation can be used in the CLVS.
sps_Imes_enabled_flag equal 10 1 specifics that luma mapping with chroma scaling is used in the CLVS. sps_Imcs_enabled_flag equal to 0 specifies that luma mapping with chroma scaling is not used in the CLVS.
sps_Ifnst_enabled_flag equal to 1 specifies that Ifnst_idx may be present in inrra coding unit syntax. sps_Ifnst_enabled_flag equal to 0 specifies that Ifnst_idx is not present in intra coding unit syntax.
sps_ladf_enabled_flag equal to 1, specifies that sps_num_ladf_intervals_minus2. sps_ladf_lowest_interval_qp_offset. sps_ladf_qp_offset [i], and sps_ladf_delta_threshold_minus1] i] are present in the SPS.
sps_num_ladf_intervals_minus2 plus] specifies the number of sps_ladf delta threshold minust [i] and sps_ladf_qp_offset [i] syntax elements that are present in the SPS. The value of sps_num_ladf_intervals_minus2 shall be in the range of 0 to 3, inclusive.
sps_ladf_lowest_interval_qp_offset specifies the offset used to derive the variable qP as specified. The value of sps_ladf_lowest_interval_qp_offset shall be in the range of 0 to 63, inclusive.
sps_ladf qp_offset [i] specifies the offset array used to derive the variable qP as specified. The value of sps_ladf qp_offset [i] shall be in the range of 0 to 63, inclusive.
sps_ladf_delta_threshold_minus1[i] is used to compute the values of SpsLadfIntervalLowerBound [i], which specifies the lower bound of the i-th luma intensity level interval. The value of sps_ladf delta threshold_minus1[:] shall be in the range of 0 to 2Bilxph-3, inclusive.

The value of SpsLadfIntervalLowerBound [0] is set equal to 0.

For each value of i in the range of 0 to sps_num ladf intervals minus2, inclusive, the variable SpsLadfIntervalLowerBound [i+1] is derived as follows:

$$SpsLadfIntervalLowerBound [ i + 1 ] = SpsLadfIntervalLowerBound [ i ] + sps \text{?} ladf \text{?} delta \text{?} threshold \text{?} minus 1 [ i ] \text{?} 1$$

$$\text{?} \text{indicates text missing or illegible when filed}$$

sps_scaling list_enabled_flag equal to 1 specifics that a scaling list is used for the scaling process for transform coefficients. sps_scaling_list_enabled_flag equal to 0 specifics that sealing list is not used for the scaling process for transform coefficients.
sps_loop_filter_across_virtual_boundaries_disabled_present_flag equal to 1 specifics that the in-loop filtering operations are disabled across the virtual boundaries in pictures referring to the SPS. sps_Joop filter_across virtual boundaries disabled present flag equal to 0 specifies that no such disabling of in-loop filtering operations is applied in pictures referring to the SPS. In-loop filtering operations include the deblocking filter. sample adaptive offset filter, and adaptive loop filter operations
sps_num_ver_virtual_boundaries specifies the number of sps_virtual boundaries_pos_x[i] syntax elements that are present in the SPS. When sps_num_ver_virtual_boundaries is not presem, it is inferred to be equal to 0
sps_virtual_boundaries_pos_x[i] is used to compute the value of VirtualBoundariesPosX[i], which specifies the location of the i-th vertical virtual boundary in units of lama samples. sps_virtual_boundaries_pos_x[i] shall be in the range of 1 to Ceil (pic_width_in_luma_samples=8)−1, inclusive.
sps_num_hor_virtual_boundaries specifies the number of sps_virtual_boundaries pos y [i] syntax elements that are present in the SPS. When sps_num_hor_virtual_boundaries is not present, it is inferred to be equal to 0.
sps_virtual_boundaries_pos_y[i] is used to compute the value of VirtualBoundariesPosY[i], which specifies the location of the i-th horizontal virtual boundary in units of luma samples. sps_virtual_boundaries_pos_v[i] shall be in the range of 1 to Ceil (pic_height_in_luma_samples+8)-J, inclusive.
sps_general_hrd_params_present_flag equal to 1 specifies that the syntax structure general_brd_parameters( ) is present in the SPS RBSP syntax structure. sps_general_hrd_params_present_flag equal to 0 specifics that the syntax structure general_hrd_parameters( ) is not present in the SPS RBSP syntax structure.
sps_sub_layer_cpb_params_present_flag equal to 1 specifies that the syntax structure old_hrd parameters( ) in the SPS RBSP includes HRD parameters for sub-layer representations with Temporalld in the range of 0) to sps_max_sub_layers_minus1, inclusive. sps_sub_layer_cpb_params present_flag equal to 0 specifies that the syntax structure ols_hrd_parameters( ) in the SPS RBSP includes HRD parameters for the sub-layer representation with Temporalld equal to sps_max_sub_layers_minus1 only. When sps_max_sub_layers_minusI is equal to 0, the value of sps_sub_layer_cpb_paramus_present_flag is inferred to be equal to 0.
When sps_sub_layer_cpb_params_present_flag is equal to 0, the HRD parameters for the sub-layer representations with Temporalld in the range of 0 to sps_max_sub_layers_minus]−1. incluisive, are inferred to be the same as that for the sub-layer representation with Temporalld equal to sps_max_sub_layers_minus1. These include the HRD parameters starting from the fixed_pic_rate_general_flag[i] syntax element till the sub_layer_hrd parameters (i) syntax structure immediately under the condition “if (general_vel_hrd params_present_flag)” in the ols_hrd_parameters symax structure.
vui_parameters_present_flag equal to 1 specifies that the syntax structure vui parameters( ) is present in the SPS RBSP syntax structure. vui parameters present flag equal to 0 specifies that the syntax structure vui_parameters( ) is not present in the SPS RBSP syntax structure.
sps_extension_flag equal to( ) specifies that no sps_extension_data_flag syntax elements are present in the SPS RBSP syntax structure. sps_extension_flag equal to 1 specifies that there are sps_extension_data_flag syntax elements present in the SPS RBSP syntax structure.
sps_extension_data_flag may have any value. Its presence and value do not affect decoder conformance to profiles specified in this version of this Specification. Decoders conforming to this version of this Specification shall ignore all sps_extension_data_flag syntax elements.

As provided in Table 2, a NAL unit may include a picture parameter set syntax structure. Table 4 illustrates the syntax of the picture parameter set syntax structure provided in JVET-P2001.

TABLE 4

| | Descriptor |
|---|---|
| pic_parameter_set_rbsp( ) { | |
| pps_pic_parameter_set_id | ue(v) |
| pps_seq_parameter_set_id | u(4) |
| pps_seq_parameter_set_id | ue(v) |
| pic_width_in_luma_samples | ue(v) |
| pic_height_in_luma_samples | ue(v) |
| conformance_window_flag | u(1) |
| if( conformance_window_flag ) { | |
| conf_win_left_offset | ue(v) |
| conf_win_right_offset | ue(v) |
| conf_win_top_offset | ue(v) |
| conf_win_bottom_offset | ue(v) |
| } | |
| scaling_window_flag | u(1) |
| if( scaling_window_flag ) { | |
| scaling_win_left_offset | ue(v) |
| scaling_win_right_offset | ue(v) |
| scaling_win_top_offset | ue(v) |
| scaling_win_bottom_offset | ue(v) |
| } | |
| output_flag_present_flag | u(1) |
| mixed_nalu_types_in_pic_flag | u(1) |
| pps_subpic_id_signalling_present_flag | u(1) |
| if( pps_subpics_id_signalling_present_flag ) { | |
| pps_num_subpics_minus1 | ue(v) |
| pps_subpic_id_len_minus1 | ue(v) |
| for( i = 0; i <= pps_num_subpic_minus1; i++ ) | |
| pps_subpic_id[ i ] | u(v) |
| } | |
| no_pic_partition_flag | u(1) |
| if( !no_pic_partition_flag ) { | |
| pps_log2_ctu_size_minus5 | u(2) |
| num_exp_tile_columns_minus1 | ue(v) |
| num_exp_file_rows_minus1 | ue(v) |
| for( i = 0; i <= num_exp_tile_columns_minus1; i++ ) | |
| tile_column_width_minus1[ i ] | ue(v) |
| for( i = 0; i <= num_exp_file_rows_minus1; i++ ) | |
| tile_row_height_minus1[ i ] | ue(v) |
| rect_slice_flag | u(1) |
| if( rect_slice_flag ) | |
| single_slice_per_subpic_flag | u(1) |
| if( rect_slice_flag && !single_slice_per_subpic_flag ) { | |
| num_slices_in_pic_minus1 | ue(v) |
| tile_idx_delta_present_flag | u(1) |
| for( i = 0; i < num_slices_in_pic_minus1; i++ ) { | |
| slice_width_in_tiles_minus1[ i ] | ue(v) |
| slice_height_in_tiles_minus1[ i ] | ue(v) |
| if( slice_width_in_tiles_minus1[ i ] = = 0 && | |
| slice_height_in_tiles_minus1[ i ] = = 0 ) { | |
| num_slices_in_tile_minus1[ i ] | ue(v) |
| numSlicesInTileMinus1 = num_slices_in_tile_minus1[ i ] | |
| for( j = 0; j < numSlicesInTileMinus1; j++ ) | |
| slice_height_in_ctu_minus1[ i++ ] | ue(v) |
| } | |
| if( tile_idx_delta_present_flag && i < num_slices_in_pic_minus1 ) | |
| tile_idx_delta[ i ] | se(v) |
| } | |
| } | |
| loop_filter_across_tiles_enabled_flag | u(1) |
| loop_filter_across_slices_enabled_flag | u(1) |
| } | |
| entropy_coding_sync_enabled_flag | u(1) |
| if( !no_pic_partition_flag \| \| entropy_coding_sync_enabled_flag ) | |
| entry_point_offsets_present_flag | u(1) |
| cabac_init_present_flag | u(1) |
| for( i = 0; i < 2; i++ ) | |
| num_ref_idx_default_active_minus1[ i ] | ue(v) |
| rpl1_idx_present_flag | u(1) |
| init_qp_minus26 | se(v) |
| if( sps_transform_skip_enabled_flag ) | |
| log2_transform_skip_max_size_minus2 | ue(v) |
| cu_qp_delta_enabled_flag | u(1) |
| pps_cb_qp_offset | se(v) |
| pps_cr_qp_offset | se(v) |
| pps_joint_cbcr_qp_offset_present_flag | u(1) |
| if( pps_joint_cbcr_qp_offset_present_flag ) | |
| pps_joint_cbcr_qp_offset_value | se(v) |
| pps_slice_chroma_qp_offsets_present_flag | u(1) |
| cu_chroma_qp_offset_enabled_flag | u(1) |
| if( cu_chroma_qp_offset_enabled_flag ) { | |
| chroma_qp_offset_list_len_minus1 | ue(v) |
| for( i = 0; i <= chroma_qp_offset_list_len_minus1; i++ ) { | |
| cb_qp_offset_list[ i ] | se(v) |
| cr_qp_offset_list[ i ] | se(v) |
| if( pps_joint_cbcr_qp_offset_present_flag ) | |
| joint_cbcr_qp_offset_list[ i ] | se(v) |
| } | |
| } | |
| pps_weighted_pred_flag | u(1) |
| pps_weighted_bipred_flag | u(1) |
| deblocking_filter_control_present_flag | u(1) |
| if( deblocking_filter_control_present_flag ) { | |
| deblocking_filter_override_enabled_flag | u(1) |
| pps_deblocking_filter_disabled_flag | u(1) |
| if( !pps_deblocking_filter_disabled_flag ) { | |
| pps_beta_offset_div2 | se(v) |
| pps_tc_offset_div2 | se(v) |
| } | |
| } | |
| constant_slice_header_params_enabled_flag | u(1) |
| if( constant_slice_header_params_enabled_flag ) { | |
| pps_dcp_quant_enabled_idc | u(2) |
| for( i = 0; i < 2; i++ ) | |
| pps_ref_pic_list_sps_idc[ i ] | u(2) |
| pps_mvd_l1_zero_idc | u(2) |
| pps_collocated_from_l0_idc | u(2) |
| pps_six_minus_max_num_merge_cand_plus1 | ue(v) |
| pps_max_num_merge_cand_minus_max_num_triangle_cand_plus1 | ue(v) |
| } | |
| picture_header_extension_present_flag | u(1) |
| slice_header_extension_present_flag | u(1) |
| pps_extension_flag | u(1) |
| if( pps_extension_flag ) | |
| while( more_rbsp_data( ) ) | |
| pps_extension_data_flag | u(1) |
| rbsp_trailing_bits( ) | |
| } | |

With respect to Table 4, JVET-P2001 provides the following semantics:

A PPS RBSP shall be available to the decoding process prior to it being referenced, included in at least one AU with TemporalId less than or equal to the Temporalld of the PPS NAL unit or provided through external means.

All PPS NAL units with a particular value of pps_pic_parameter_set_id within a PU shall have the same content.

pps_pic_parameter_set_id identifies the PPS for reference by other syntax elements. The value of pps_pic_parameter_set_id shall be in the range of 0 to 63, inclusive.

PPS NAL units, regardless of the nuh_layer_id values, share the same value space of pps_pic_parameter_set_id.

pps_seq_parameter_set_id specifies the value of sps_sen parameter set id for the SPS. The value of pps_seq parameter set_id shall be in the range of 0 to 15, inclusive. The value of pps_seq parameter set_id shall be the same in all PPSs that are referred to by coded pictures in a CLVS.

pic_width_in_luma_samples specifies the width of each decoded picture referring to the PPS in units of luma samples. pic_width_in_luma_samples shall not be equal to 0, shall be an integer multiple of Max (8. MinCbSizeY), and shall be less than or equal to pic_width_max_in_luma_samples.

When subpics present_flag is equal to 1 or ref_pic_resampling enabled_flag equal to 0, the value of pic_width_in_luma_samples shall be equal to pic_width_max_in_luma_samples.

pic_height_in_luma_samples specifies the height of each decoded picture referring to the PPS in units of luma samples. Pic_height_in_luma_samples shall not be equal to 0 and shall be an integer multiple of Max (8, MinCbSizeY), and shall be less than or equal to pic_height_max_in_luma_samples.

When subpics_present_flag is equal to 1 or ref_pic_resampling_enabled_flag equal to 0, the value of pic_height_in_luma_samples shall be equal to pic_height_max_in_luma_samples.

Let refPic WidthInLumaSamples and refPicHeightInLumaSamples be the pic width in luma samples and pic height in luma samples, respectively, of a reference picture of a current picture referring to this PPS. Is a requirement of bitstream conformance that all of the following conditions are satisfied:
pic_width_in huna_samples*2 shall be greater than or equal to refPicWidthinLuma Simples.
pic_height_in luma samples*2 shall be greater than or equal to refPicHeightInLumaSamples.
pic_width_in_luma_samples shall be less than or equal to refPicWidthinL umaSamples+8.
-pic_height_in_Iuma samples shall be less than or equal to refPicHeight InLumaSamples*8.

The variables PicWidthInCtbsY. PicHeightInCtbsY, PicSizelnCtbsY, Pic WidthInMinCbsY, PicHeightInMinCbsY, PicSizeInMinCbsY, PicSizeInSamplesY, PicWidthInSamplesC and PicHeightInSamplesC are derived as follows:

$$PicWidthInCtbsY = Ceil ( pic\_width \_in \_luma \_samples + CtbSizeY )$$

$$PicHeightInCtbsY \text{?} Ceil ( pic\_height \_in \_luma \_samples + CtbSizeY )$$

$$PicSizeInCtbsY \text{?} PicWidthInCtbsY * PicHeightInCtbsY$$

$$PicWidthInMinCbsY = pic\_width \_in \_luma \_samples / MinCbSizeY$$

$$PicHeightInMinCbsY = pic\_height \_in \_luma \_samples / MinCbSizeY$$

$$PicSizeInMinCbsY = PicWidthInMinCbsY * PicHeightInMinCbsY$$

$$PicSizeInSamplesY = pic\_width \_in \_luma \_samples * pic\_height \_in \_luma \_samples$$

$$PicWidthInSamplesC = pic\_width \_in \_luma \_samples / SubWidthC$$

$$PicHeightInSamplesC = pic\_height \_in \_luma \_samples / SubHeightC$$

$$\text{?} \text{indicates text missing or illegible when filed}$$

conformance_window_flag equal to 1 indicates that the conformance cropping window offset parameters follow next in the SPS. conformance_window_flag equal to 0 indicates that the conformance cropping window offset parameters are not present.
conf_win_left_offset, conf_win_right_offset, conf_win_top_offset, and conf_win_bottom_offset specify the samples of the pictures in the CLVS that are output from the decoding process, in terms of a rectangular region specified in picture coordinates for output. When conformance_window flag is equal to 0, the values of conf_win_left_offset, conf_win_right_offset. conf_win_top_offset, and conf_win_bottom_offset are inferred to be equal to 0
The conformance cropping window contains the luma samples with horizontal picture coordinates from SubWidthC+conf_win_left_offset to pic_width_in_luma_samples-(SubWidthC+conf_win_right_offset+1) and vertical picture coordinates from SubHeightC*conf_win_top_offset pic_height_in_luma_samples-(SubHeightC*conf_win_bottom_offset+1), inclusive. The value of SubWidthC+ (conf_win_left_offset+conf_win_right_offset) shall be than less pic_width_in_luma_samples, and the value of SubHeightC #(conf_win_lop_offset+conf_win_bottom_offset) shall be less than pic_height_in_luma_samples.
When ChromaArrayType is not equal to 0, the corresponding specified samples of the two chroma arrays are the samples having picture coordinates (x/SubWidthC, y/SubHeightC), where (x, y) are the picture coordinates of the specified luma samples.
   NOTE—The conformance cropping window offset parameters are only applied at the output. All internal decoding processes are applied to the uncropped picmre size.

Let ppsA and ppsB be any two PPSs referring to the same SPS. It is a requirement of bitstream conformance that, when ppsA and ppsB have the same the values of pic_width_in_luma_samples and pic_height_in_luma_samples, respectively, ppsA and ppsB shall have the same values of conf_win_left_offset. conf win_right_offset, conf_win_top_offset, and conf_win_bottom_offset, respectively.
scaling_window_flag equal to 1 specifies that the scaling window offset parameters are present in the PPS. scaling_window_flag equal to 0 specifies that the scaling window offset parameters are not present in the PPS. When ref_pic resampling enabled flag is equal to 0, the value of scaling window flag shall be equal to 0.
scaling win left_offset, scaling win right offset, scaling win top offset, and scaling win bottom offset specify the offsets, in units of luma samples, that are applied to the picture size for scaling ratio calculation. When sclaing_window flag is equal to 0, the values of scaling win left_offset, scaling win_right_offset, scaling_win_top_offset, and scaling_win_bottom_offset are inferred to be equal to 0.
The value of SubWidthC*(scaling win left_offset+scaling win right offset) shall be less than pic width in luma samples, and the value of SubHeightC*(scaling win top offset+scaling win bottom offset) shall be less than pic_height_in_luma_samples.

The variables PicOutputWidthL and PicOutputHeightL are derived as follows:

$$PicOutputWidthL = pic\_width \_in \_luma \_samples \text{?} SubWidthC * ( scaling\_win \_right \_offset + scaling\_win \_left \_offset )$$

$$PicOutputHeightL = pic\_height \_in \_pic \_size \_units \text{?} SubHeightC * ( scaling\_win \_bottom \_offset + scaling\_win \_top \_offset )$$

$$\text{?} \text{indicates text missing or illegible when filed}$$

output_flag present_flag equal to 1 indicates that the pic_output_flag syntax element is present in slice headers referring to the PPS output_flag_present_flag equal to 0 indicates that the pic_output_flag syntax element is not present in slice headers referring to the PPS.
mixed_nalu_types_in_pic_flag equal to 1 specifies that each picture referring to the PPS has more than one VCL NAL unit and that the VAL NAL units do not have the same value of nal_unit_type and that the picture is not an IRAP picture. mixed_nalu_types_in_pic_flag equal to 0 specifies that each picutre referring to the PPS has one or more VCL NAL units and the VCL. NAL units of each picture refering to the PPS have the same value of nal_unit_type.

When no_mixed_nalu_types_in_pic_constraint_flag is equal to 1, the value of mixed_nalu_types_in_pic_flag shall be equal to 0.

For each slice with a nal_unit_type value nalUnitTypeA in the range of IDR_W_RADL to CRA_NUT, inclusive, in a picture picA that also contains one or more slices with another value of nal_unit_type (i.e., the value of mixed_nalu_types_in_pic_flag for the picture picA is equal to 1), the following applies:
The slice shall belong to a subpicture subpicA for which the value of the corresponding sub_pic_treated_as_pic_flag[i] is equal to 1.
The slice shall not belong to a subpicture of picA containing VCL NAL units with nal_unit_type not equal to nalUnitTypeA.
For all the following PUs in the CLVS in decoding order, neither RefPicList [0] nor RefPicList [1] of a slice in subpicA shall include any picture preceding picA in decoding order in an active entry.
pps_subpic_id_signalling_present_flag equal to 1 specifies that subpicture ID mapping is signalled in the PPS. pps_subpic_id_signalling_present_flag equal to 0 specifies that subpicture ID mapping is not signalled in the PPS. When sps_subpic_id_present_flag is 0 or sps_subpic_id signalling_present_flag is equal to 1. pps_subpic_id_signalling_present_flag shall be equal to 0.
pps_num_subpics_minust plus 1 specifies the number of subpictures in the coded pictures referring to the PPS.

It is a requirement of bitstream conformance that the value of pps_num_subpic_minus1 shall be equal to sps_num_subpics_minus1.
pps_subpic_id_len_minus1 plus 1 specifies the number of bits used to represent the syntax element pps_subpic_id [i]. The value of pps_subpic_id len minus1 shall be in the range of 0 to 15, inclusive.

It is a requirement of bitstream conformance that the value of pps_subpic_id_len_minus1 shall be the same for all PPSs that are referred to by coded pictures in a CLVS.
pps_subpic_id [i] specifies that subpicture ID of the i-th subpicture. The length of the pps subpic_id [i] syntax element is pps_subpic_id_Jen_minus1+1 bits.
no_pic_partition_flag equal to 1 specifies that no picture partitioning applied to each picture referring to the PPS. no_pic partition flag equal to 0 specifies each picture referring to the PPS may be partitioned into more than one tile or slice.

It is a requirement of bitstream conformance that the value of no_pic_partition_flag shall be the same for all PPSs that are referred to by coded pictures within a CLVS.

It is a requirement of bitstream conformance that the value of no_pic_partition_flag shall not be equal to 1 when the value of sps_nunit_subpics_minus1+1 is greater than 1.
pps log 2 ctu size minus5 plus 5 specifies the luma coding tree block size of each CTU. pps log 2 ctu size minus5 shall be equal to sps_log 2 ctu_size_minus5.
num_exp_file_columns_minus1 plus 1 specifies the number of explicitly provided tile column widths. The value of num_exp_tile_columns_minus1 shall be in the range of 0 to PicWidthIaCtbsY−1, inclusive. When no_pic_partition_flag is equal to 1, the value of num_exp_tile_columns_minus1 is inferred to be equal to 0.
num_exp_tile rows minus1 plus 1 specifies the number of explicitly provided tile row heights. The value of num_exp_tile_rows_minusI shall be in the range of O to PicHeightInClosY−1, inclusive. When no pic partition flag is equal to 1. the value of num tile rows minus1 is inferred to be equal to 0.
tile_column_width_minus1[i] plus 1 specifics the width of the i-th tile column in units of CTBs for i in the range of 0 to num_exp_tile_columns_minus1-1, inclusive. tile_column_width_minus1[num_exp_tile_columns_minus]] is used to derive the width of the tile columns with index greater than or equal to num_exp_tile_columns_minus1 as specified. When not present, the value of tile_column_width mimist [0] is inferred to be equal to PicWidthInCtbsY−1.
tile_row_height_minus1[i] plus 1 specifies the height of the i-th tile row in units of CTBs for i in the range of 0 to aum_exp tile rows_minus1-1, inclusive. tile row_height_minus1] num_exp tile rows minus1] is used to derive the height of the tile rows with index greater than or equal to num_exp tile rows minus1 as specified. When not present, the value of tile_row height minust [0] is inferred to be equal to PicHeightinCIbsY−1.
rect_slice_flag equal to 0 specifies that tiles within each slice are in raster scan order and the slice information is not signalled in PPS reet_slice_flag equal to 1 specifies that tiles within each slice cover a rectangular region of the picture and the slice information is signalled in the PPS. When not present, rect_slice_flag is inferred to be equal to 1.
single_slice_per_subpic_flag equal to 1 specifies that each subpicture consists of one and only one rectangular slice. single_slice_per_subpic_flag equal to 0 specifics that each subpicture may consist one or more rectangular shecs. When subpics present_flag is equal to 0, sangle_silice per_subpic_flag shall be equal to 0. When single_slice per_subpic_flag is equal to 1, num_slices_in_pic_minust is inferred to be equal to sps_num_subpics_minus1.
num_slices_in_pic_minus plus 1 specifies the member of rectangular slices in each picture referring to the PPS. The value of num_slices_in_pic_minust shall be in the range of 0 to MaxSlicesPerPicture−1, inclusive, where MaxSlicesPerPicture is specified in Annex A. When no_pic_partition_flag is equal to 1, the value of num_slices_in_pic_minus1 is inferred to be equal to 0.
tile_idx_delta_present_flag equal to 0) specifies that tile_idx_della values are not present in the PPS and that all rectangular slices in pictures referring to the PPS are specified in raster order according to a process defined. tile_idx delta present flag equal to 1 specifies that tile idx delta values may be present in the PPS and that all rectangular slices in pictures referring to the PPS are specified in the order indicated by the values of tile_idx_delta slice_width_in_tiles_minus1[i] plus 1 specifies the width of the i-th rectangular slice in units of tile columns. The value of slice_width in tiles minusif i] shall be in the range of 0) to NumTileColumns−1, inclusive. When not present, the value of slice_width_in_files_minus1[i] is inferred as specified.
slice_height_in_tiles_minus1[i] plus 1 specifies the height of the i-thì rectangular slice in wruts of tile rows. The value of slice_height_in_tiles_minus1[i] shall be in the range of 0 to NumTiteRows−1. inclusive. When not present, the value of slice_height in tiles minusif i] is inferred as specified.
num_slices in tile_minus1[i] plus 1 specifics the number of slices in the current tile for the case where the i-th slice contains a subset of CTU rows from a single tile. The value of num_slices_in_tile_minus] [i] shall be in the range of 0 to RowHeight [tileY]. 1. inclusive, where tileY is the tile row index containing the i-th slice. When not present, the value of num_slices_in_tile_minus1[i] is inferred to be equal to 0.
slice_height_in_ctu_minus1[i] plus i specifies the height of the i-th rectangular slice in units of CTU rows for the case where the i-th slice contains a subset of CTU rows from a single tile. The value of slice_height_in_cta_minus! [i] shall be in the range of 0 to RowHeight [tileY]−1, inclusive, where tileY is the tile row index containing the i-th slice.
tile_idx_delta [i] specifies the difference in tile index between the i-th rectangular slice and the (i+1)-th rectangular slice. The value of tile_idx_delta [i] shall be in the range of −NumTilesInPic+1 to Num TilesInPic−1. inclusive. When not present, the value of tile_idx_deltal i] is inferred to be equal to 0. In all other cases, the value of tile_idx_delta [i] shall not be equal to 0.
loop_filter_across_files_enabled_flag equal to 1 specifies that in-loop filtering operations may be performed across tilc boundaries in pictures referring to the PPS. loop filter across tiles_enabled_flag equal to 0 specifics that in-loop filtering operations are not performed across tile boundaries in pictures referring to the PPS. The in-loop filtering operations include the deblocking filter, sample adaptive offset filter, and adaptive loop filter operations. When not present, the value of loop_filter_across_files_enabled_flag is inferred to be equal to 1.
loop_filter_across_slices_enabled_flag equal to 1 specifies that in-loop filtering operations may be performed across slice boundaries in pictures referring to the PPS. loop_filter_across_slice_enabled_flag equal to 0 specifies that in-loop filtering operations are not performed across slice boundaries in pictures referring to the PPS. The in-loop filtering operations include the deblocking filter, sample adaptive offset filter, and adaptive loop filter operations. When not present, the value of loop_filter_across_slices_enabled_flag is inferred to be equal to 0.
entropy_coding_sync_enabled_flag equal to 1 specifies that a specific synchronization process for context variables is invoked before decoding the CTU that includes the first CTB of a row of CTBs in each file in each picture referring to the PPS, and a specific storage process for context variables is invoked after decoding the CTU that includes the first CTB of a row of C′TBs in each file in each picture referring to the PPS. entropy coding sync enabled_flag equal to 0 specifies that no specific synchronization process for context variables is required to be invoked before decoding the CTU that includes the first CTB of a row of CTBs in each tile in each picture referring to the PPS, and no specific storage process for context variables is required to be invoked after decoding the CTU that includes the first CTB of a row of CTBs in each tile in each picture referring to the PPS.

It is a requirement of bitstream conformance that the value of entropy_coding_sync_enabled_flag shall be the same for all PPSs that are referred to by coded pictures within a CLVS.
cabac_init_present_flag equal to 1 specifies that cabac_init_flag is present in slice headers referring to the PPS. cabac_init_present_flag equal to 0 specifies that cabac_init_flag is not present in slice headers referring to the PPS.
num_ref_idx_default_active_minus1[i] plus 1, when i is equal to 0, specifies the inferred value of the variable NumRendxActivet[0] for Por B slices with num_ref_idx active override flag equal to 0, and, when i is equal to], specifies the inferred value of NumRefIdxActive [1] for B slices with num_ref_idx_active_override_flag equal to 0. The value of num_ref_idx_default_active_minus1[i] shall be in the range of 0) to 14, inclusive.
rplt_idx_present_flag equal to 0 specifies that ref_pic_list_sps_flag [I] and ref_pic_list_idx [1] are not present in slice headers. rpll_idx_present_flag equal to 1 specifies that ref_pic_list_sps_flag [1] and ref_pic_list_idx [1] may be present in slice headers.
init_qp_minus26 plus 26 specifies the initial value of SliceQpy for each slice referring to the PPS. The initial value of SliceQpy is modified at the slice layer when a non-zero value of slice qp delta is decoded. The value of init qp minus26 shall be in the range of −(26+QpBdOffset) to +37, inclusive.
log 2_transform_skip_max_size_minus2 specifies the maximum block size used for transform skip, and shall be in the range of 0 to 3.

When not present, the value of log 2_transform_skip_max_size_minus2 is inferred to be equal to 0.

The variable MaxTsSize is set equal to 1<< (log 2_transform_skip_max_size_minus2 +2).
cu_qp_delta_enabled_flag equal to 1 specifies that the pic_cu_qp_delta_subdiv_intra_slice and pic_cu_qp delta_subdiv_inter_slice syntax elements are present in PHs referring to the PPS and that on_qp_delta abs may be present in the transform unit syntax. cu qp delta enabled_flag equal to 0 specifics that the pic cu_qp delta subdiv_intra_slice and pic cu qp delta subdiv inter slice syntax elements are not present in PHs referring to the PPS and that cu qp delta abs is not present in the transform unit syntax.
pps_cb_qp_offset and pps_er_qp_offset specify the offsets to the luma quantization parameter Qp′ y used for deriving Qp′ c and Qp′ on respectively. The values of pps_cb_qp_offset and pps_cr_qp_offset shall be in the range cf-. 12 to +12, inclusive. When ChromaArrayType is equal to 0, pps_cb_qp_offset and pps_cr_qp_offset are not used in the decoding process and decoders shall ignore their value.
pps_joint_cher_qp_offset_present_flag equal to 1. specifies that pps joint eber qp_offset value and joint_cher_qp_offset_list [i] are present in the PPS RBSP syntax structure. pps_joint_cher_qp_offset_present_flag equal to 0) specifies that pps_joint_cher_qp_offset_value and joint_cher_qp_offset_list [i] are not present in the PPS RBSP syntax structure. When ChromaArrayType is equal to 0 or sps_joint_chet_enabled_flag is equal to 0, the value of pps_joint_cbcr_qp_offset_present_flag shall be equal to 0.
pas_joint_cher_qp_offset_value specifies the offset to the luma quantization parameter Qp′ y used for deriving Qp′ cve. The value of pps_joint_ober_qp_offset_value shall be in the range of −12 to +12, inclusive. When ChromaArray Type is equal to 0 or sps_joint_cber_enabled_flag is equal to 0. pps_joint_cher_qp_offset_value is not used in the decoding process and decoders shall ignore its value. When pps_joint_eber_qp_offset_present_flag is equal to 0. pps_joint_cbor_qp_offset_value is not present and is inferred to be equal to 0.
pps_slice_chroma_qp_offsets present flag equal to 1 indicates that the slice_cb_qp_offset and slice_cr_qp_offset syntax elements are present in the associated slice headers. pps slice chroma qp offsets present flag equal to 0 indicates that these syntax elements are not present in the associated slice headers. When ChromaArrayType is equal to 0, pps slice chroma qp offsets present flag shall be equal to 0).
cu_chroma_qp_offset_enabled_flag equal to 1 specifies that the pic_cu_chroma_qp_offset_flag_intra_slice and pic_cu_chroma_qp_offset_flag_inter_slice may present in the be transform unit syntax. cu_chroma_qp_offset_enabled_flag equal to 0 specifies that the pic_cu_chroma_qp_offset_flag_intra_slice and pic_cu_chroma qp_offset_flag inter slice are not present in the transform unit syntax. When ChromaArray Type is equal to 0, it is a requirement of bitstream conformance that the value of cu_chroma_qp_offset_enabled_flag shall be equal to 0.
chroma_qp_offset_list_len_minust plus 1 specifies the number of cb_op_offset_list [i], cr_qp_offset_list [i], and joint_cbcr_qp_offset_list [i], syntax elements that are present in the PPS. The value of chroma_qp_offset_list_len_minus1 shall be in the range of 0 to 5, inclusive.
ch_qp_offset_list [i], cr_qp_offset_list [i], and joint_cher_qp_offset_list] i], specify offsets used in the derivation of Qp′ a, Qp′ on, and Qp′ ac, respectively. The values of cb_qp_offset_list[1], cr_qp_offset_list[i] and joint_cher_qp_offset_list i] shall be in the range of −12 to +12, inclusive. When pps_joint_cber_qp_offset_present_flag is equal to 0, joint_cher_qp_offset_list [i] is not present and it is inferred to be equal to 0.
pps_weighted_pred_flag equal to 0 specilies that weighted prediction is not applied to P slices referring to the PPS. pps_weighted_pred_flag equal to 1 specifies that weighted prediction is apphed to P slices referring to the PPS. When sps_weighted pred flag is equal to 0, the value of pps weighted pred flag shall be equal to 0.
pps_weighted_bipred_flag equal to( ) specifies that explicit weighted prediction is not applied to B slices referring to the PPS. pps_weighted_bipred_flag equal to 1 specifies that explicit weighted prediction is applied to B slices referring to the PPS. When sps_weighted_bipred_flag is equal to 0. the value of pps_weighted_bipred_flag shall be equal to 0.
deblocking_filter_control_present_flug equal to 1 specifies the presence of deblocking filter control syntax elements in the PPS. deblocking_filter_control_present_flag equal to 0 specifies the absence of deblocking filter control syntax elements in the PPS.
deblocking_filter_override_enabled_flag equal to 1 specifies the presence of pic_deblocking_filter_override_flag in the PHs referring to the PPS or slice_deblocking_filter_override_flag in the slice headers referring to the PPS. deblocking_filter_override_enabled_flag equal to 0 specifies the absence of pic_deblocking_filter_override_flag in PHs referring to the PPS or slice deblocking filter_override_flag in slice headers referring to the PPS. When not present, the value of deblocking filter override enabled flag is inferred to be equal to 0.
pps_deblocking_filter_disabled_flag equal to 1 specifies that the operation of deblocking filter is not applied for slices referring the PPS in which slice_deblocking_filter_disabled_flag is not present pps_deblocking_filter_disabled_flag equal to C specifics that the operation of the deblocking filter is applied for slices referring to the PPS in which slice_deblocking_filter_disabled_flag is not present. When not present, the value of pps_deblocking_filter disabled flag is inferred to be equal to 0.
pps_beta_offset_div2 and pps_the_offset_div2 specify the default deblocking parameter offsets for B and tC (divided by 2) that are applied for slices referring to the PPS, unless the default deblocking parameter offsets are overridden by the deblocking parameter offsets present in the slice headers of the slices referring to the PPS. The values of pps_beta_offset_div2 and pps_to_offset_div2 shall both be in the range of −6 to 6, inclusive. When not present, the value of pps beta_offset div2 and pps_to_offset div2 are inferred to be equal to 0.
constant_slice_header_params_enabled_flag equal to 0 specifies that pps_dep_quant_enabled_ide. pps_ref_pic_list_sps_idc [i], pps_mvd_11_zero_idc. pps_collocated_from_10_idc. pps_six_minus_max_num_merge_cand plus1, and pps_max num merge cand minus_max num triangle cand plusl arc inferred to bc equal to 0. constant_shice_header_params_enabled_flag equal to 1 specifies that these syntax elements are present in the PPS.
pps_dep_quant_enabled_idc equal to 0 specifies that the syntax element pic_dep_quant_enabled_flag is present in PIIs referring to the PPS. pps_dep quant enabled ide equal to i or 2 specifies that the syntax element pic dep quant enabled flag is not present in PHs referring to the PPS. pps dep quant enabled ide equal to 3 is reserved for future use by ITU-T] ISO/IEC.
pps_ref_pic_list_sps_idc [i] equal to 0 specifies that the syntax element pic_rpl_sps_flag[i] is present in PHs referring to the PPS or slice_rpl_sps_flag[i] is present in slice header referring to the PPS. pps_ref_pic_list_sps_ide [i] equal to 1 or 2 specifies that the syntax element pic_rpl_sps_flag[i] is not present in PHIs referring to the PPS and slice_rpl_sps_flag[i] is not present in slice header referring to the PPS. pps_ref_pic_list_sps_ide [i] equal to 3 is reserved for future use by ITU-T] ISO/IEC.
pps_mvd_11_zero_ide equal to 0 specifies that the syntax element mvd_11_zero_flag is present in PHs referring to the PPS. pps_mvd_11_zero ide equal to 1 or 2 specifies that mvd_11_zero_flag is not present in PHs referring to the PPS. pps_mvd_11_zero idc equal to 3 is reserved for future use by ITU-T] ISO/IEC.
pps_collocated_from_10_ide equal to 0 specifies that the syntax element collocated_from_10_flag is present in slice header of slices referring to the PPS. pps collocated from 10 ide equal to 1 or 2 specifies that the syntax element collocated_from_10_flag is not present in slice header of slices referring to the PPS. pps_collocated_from_10_ide equal to 3 is reserved for future use by ITU-T] ISO/IEC.
pps_six_minus_max_num_merge_cand_plust equal to O specifies that pic_six_minus_max_num_merge_cand is present in PHs referring to the PPS. pps_six_minus_max_num_merge_cand plus1 greater than 0 specifies that pic_six_minus_max_num_merge_cand is not present in PHs referring to the PPS. The value of pps_six_minus_max_num_merge_cand_plusI shall be in the range of 0 to 6, inclusive.
pps_max_num_merge_cand_minus_max_num_triangle_cand_plus1 equal to 0 specifies that pic_max_num_merge_cand minus_max_num triangle_cand is present in PHs of slices referring to the PPS. pps_max_num_merge_cand_minus_max_num_triangle_cand_plus1 greater than 0 specifies that pic_max_num_merge_cand_minus_max_num_triangle_cand is not present in PHs referring to the PPS. The value of pps_max_num_merge_cand_minus_max_num_triangle_cand plus1 shall be in the range of 0 to Max NumMergeCand −1.
picture_header_extension_present_flag equal to 0 specifies that ne PH extension syntax elements are present in PHs referring to the PPS. picture_header_extension_present_flag equal to 1 specifies that PH extension syntax elements are present in PHs referring to the PPS. picture_header_extension_present_flag shall be equal to 0 in bitstreams conforming to this version of this Specification.
slice_header_extension_present_fag equal to 0 specifies that no slice header extension syntax elements are present in the slice headers for coded pictures referring to the PPS. slice_header_extension_present_flag equal to 1 specifies that slice header extension syntax elements are present in the slice headers for coded pictures referring to the PPS. slice_header_extension present_flag shall be equal the 0 in bitstreams conforming to this version of this Specification.
pps_extension_flag equal to O specifies that no pps_extension data flag syntax elements are present in the PPS RBSP syntax structure. pps_extension flag equal to 1 specifies that there are pps extension data flag syntax elements present in the PPS RBSP syntax structure.
pps_extension_data_flag may have any value. Its presence and value do not affect decodet conformance 10 profiles specified in this version of this Specification. Decoders conforming to this version of this Specification shall ignore all pps_extension_data_flag syntax elements.

As provided in Table 2, a NAL unit may include a picture header syntax structure. Table 5 illustrates the syntax of the picture header syntax structure provided in JVET-P2001.

TABLE 5

| | Descriptor |
|---|---|
| picture_header_rbsp( ) { | |
| non_reference_picture_flag | u(1) |
| gdr_pic_flag | u(1) |
| no_output_of_prior_pics_flag | u(1) |
| if( gdr_pic_flag ) | |
| recovery_poc_cnt | ue(v) |
| ph_pic_parameter_set_id | ue(v) |
| if( sps_poc_msb_flag ) { | |
| ph_poc_msb_present_flag | u(1) |
| if( ph_poc_msb_present_flag ) | |
| poc_msb_val | u(v) |
| } | |
| if( sps_subpic_id_present_flag && !sps_subpic_id_signalling_flag ) { | |
| ph_subpic_id_signalling_present_flag | u(1) |
| if( ph_subpics_id_signalling_present_flag ) { | |
| ph_subpic_id_len_minus1 | ue(v) |
| for( i = 0; i <= sps_num_subpics_minus1; i++ ) | |
| ph_subpic_id[ i ] | u(v) |
| } | |
| } | |
| if( !sps_loop_filter_across_virtual_boundaries_disabled_present_flag ) { | |
| ph_loop_filter_across_virtual_boundaries_disabled_present_flag | u(1) |
| if( ph_loop_filter_across_virtual_boundaries_disabled_present_flag ) { | |
| ph_num_ver_virtual_boundaries | u(2) |
| for( i = 0; i < ph_num_ver_virtual_boundaries; i++ ) | |
| ph_virtual_boundaries_pos_x[ i ] | u(13) |
| ph_num_hor_virtual_boundaries | u(2) |
| for( i = 0; i < ph_num_hor_virtual_boundaries; i++ ) | |
| ph_virtual_boundaries_pos_y[ i ] | u(13) |
| } | |
| } | |
| if( separate_colour_plane_flag = = 1 ) | |
| colour_plane_id | u(2) |
| if( output_flag_present_flag ) | |
| pic_output_flag | u(1) |
| pic_rpl_present_flag | u(1) |
| if( pic_rpl_present_flag ) { | |
| for( i = 0; i < 2; i++ ) { | |
| if( num_ref_pic_lists_in_sps[ i ] > 0 && !pps_ref_pic_list_sps_idc[ i ] && | |
| ( i = = 0 \| \| ( i = = 1 && rpl1_idx_present_flag ) ) ) | |
| pic_rpl_sps_flag[ i ] | u(1) |
| if( pic_rpl_sps_flag[ i ] ) { | |
| if( num_ref_pic_lists_in_sps[ i ] > 1 && | |
| ( i = = 0 \| \| ( i = = 1 && rpl1_idx_present_flag ) ) ) | |
| pic_rpl_idx[ i ] | u(v) |
| } else | |
| ref_pic_list_struct( i, num_ref_pic_lists_in_sps[ i ] ) | |
| for( j = 0; j < NumLtrpEntries[ i ][ RplsIdx[ i ] ]; j++ ) { | |
| if( ltrp_in_slice_header_flag[ i ][ RplsIdx[ i ] ] ) | |
| pic_poc_lsb_lt[ i ][ j ] | u(v) |
| pic_delta_poc_msb_present_flag[ i ][ j ] | u(1) |
| if( pic_delta_poc_msb_present_flag[ i ][ j ] ) | |
| pic_delta_poc_msb_cycle_lt[ i ][ j ] | ue(v) |
| } | |
| } | |
| } | |
| if( partition_constraints_override_enabled_flag ) { | |
| partition_constraints_override_flag | ue(v) |
| if( partition_constraints_override_flag ) { | |
| pic_log2_diff_min_qt_min_cb_intra_slice_luma | ue(v) |
| pic_log2_diff_min_qt_min_cb_inter_slice | ue(v) |
| pic_max_mtt_hierarchy_depth_inter_slice | ue(v) |
| pic_max_mtt_hierarchy_depth_intra_slice_luma | ue(v) |
| if( pic_max_mtt_hierarchy_depth_intra_slice_luma != 0 ) { | |
| pic_log2_diff_max_bt_min_qt_intra_slice_luma | ue(v) |
| pic_log2_diff_max_tt_min_qt_intra_slice_luma | ue(v) |
| } | |
| if( pic_max_mtt_hierarchy_depth_inter_slice != 0 ) { | |
| pic_log2_diff_max_bt_min_qt_inter_slice | ue(v) |
| pic_log2_diff_max_tt_min_qt_inter_slice | ue(v) |
| } | |
| if( qtbtt_dual_tree_intra_flag ) { | |
| pic_log2_diff_min_qt_min_cb_intra_slice_chroma | ue(v) |
| pic_max_mtt_hierarchy_depth_intra_slice_chroma | ue(v) |
| if( pic_max_mtt_hierarchy_depth_intra_slice_chroma != 0 ) { | |
| pic_log2_diff_max_bt_min_qt_intra_slice_chroma | ue(v) |
| pic_log2_diff_max_tt_min_qt_intra_slice_chroma | ue(v) |
| } | |
| } | |
| } | |
| } | |
| if( cu_qp_delta_enabled_flag ) { | |
| pic_cu_qp_delta_subdiv_intra_slice | ue(v) |
| pic_cu_qp_delta_subdiv_inter_slice | ue(v) |
| } | |
| if( cu_chroma_qp_offset_enabled_flag ) { | |
| pic_cu_chroma_qp_offset_subdiv_intra_slice | ue(v) |
| pic_cu_chroma_qp_offset_subdiv_inter_slice | ue(v) |
| } | |
| if( sps_temporal_mvp_enabled_flag ) | |
| pic_temporal_mvp_enabled_flag | u(1) |
| if(!pps_mvd_l1_zero_idc ) | |
| mvd_l1_zero_flag | u(1) |
| if( !pps_six_minus_max_num_merge_cand_plus1 ) | |
| pic_six_minus_max_num_merge_cand | ue(v) |
| if( sps_affine_enabled_flag ) | |
| pic_five_minus_max_num_subblock_merge_cand | ue(v) |
| if( sps_fpel_mmvd_enabled_flag ) | |
| pic_fpel_mmvd_enabled_flag | u(1) |
| if( sps_bdof_pic_present_flag ) | |
| pic_disable_bdof_flag | u(1) |
| if( sps_dmvr_pic_present_flag ) | |
| pic_disable_dmvr_flag | u(1) |
| if( sps_prof_pic_present_flag ) | |
| pic_disable_prof_flag | u(1) |
| if( sps_triangle_enabled_flag && MaxNumMergeCand >= 2 && | |
| !pps_max_num_merge_cand_minus_max_num_triangle_cand_ minus1 ) | |
| pic_max_num_merge_cand_minus_max_num_triangle_cand | ue(v) |
| if ( sps_ibc_enabled_flag ) | |
| pic_six_minus_max_num_ibc_merge_cand | ue(v) |
| if( sps_joint_cbcr_enabled_flag ) | |
| pic_joint_cbcr_sign_flag | |
| if( sps_sao_enabled_flag ) { | |
| pic_sao_enabled_present_flag | u(1) |
| if( pic_sao_enabled_present_flag ) { | |
| pic_sao_luma_enabled_flag | u(1) |
| if(ChromaArrayType != 0 ) | |
| pic_sao_chroma_enabled_flag | u(1) |
| } | |
| } | |
| if( sps_alf_enabled_flag ) { | |
| pic_alf_enabled_present_flag | u(1) |
| if( pic_alf_enabled_present_flag ) { | |
| pic_alf_enabled_flag | u(1) |
| if( pic_alf_enabled_flag ) { | |
| pic_num_alf_aps_ids_luma | u(3) |
| for( i = 0; i < pic_num_alf_aps_ids_luma; i++ ) | |
| pic_alf_aps_id_luma[ i ] | u(3) |
| if( ChromaArrayType != 0 ) | |
| pic_alf_chroma_idc | u(2) |
| if( pic_alf_chroma_idc ) | |
| pic_alf_aps_id_chroma | u(3) |
| } | |
| } | |
| } | |
| if ( !pps_dep_quant_enabled_flag ) | |
| pic_dep_quant_enabled_flag | u(1) |
| if( !pic_dep_quant_enabled_flag ) | |
| sign_data_hiding_enabled_flag | u(1) |
| if( deblocking_filter_override_enabled_flag ) { | |
| pic_deblocking_filter_override_present_flag | u(1) |
| if( pic_deblocking_filter_override_present_flag ) { | |
| pic_deblocking_filter_override_flag | u(1) |
| if( pic_deblocking_filter_override_flag ) { | |
| pic_deblocking_filter_disabled_flag | u(1) |
| if( !pic_deblocking_filter_disabled_flag ) { | |
| pic_beta_offset_div2 | se(v) |
| pic_tc_offset_div2 | se(v) |
| } | |
| } | |
| } | |
| } | |
| if( sps_lmcs_enabled_flag ) { | |
| pic_lmcs_enabled_flag | u(1) |
| if( pic_lmcs_enabled_flag ) { | |
| pic_lmcs_aps_id | u(2) |
| if( ChromaArrayType != 0 ) | |
| pic_chroma_residual_scale_flag | u(1) |
| } | |
| } | |
| if( sps_scaling_list_enabled_flag ) { | |
| pic_scaling_list_present_flag | u(1) |
| if( pic_scaling_list_present_flag ) | |
| pic_scaling_list_aps_id | u(3) |
| } | |
| if( picture_header_extension_present_flag ) { | |
| ph_extension_length | ue(v) |
| for( i = 0; i < ph_extension_length; i++) | |
| ph_extension_data_byte[ i ] | u(8) |
| } | |
| rbsp_trailing_bits( ) | |
| } | |

With respect to Table 5, JVET-P2001 provides the following semantics: The PH contains information that is common for all slices of the coded picture associated with the PH.
non_reference_picture_flag equal to 1 specifies the picture associated with the PH is never used as a reference picture. non_reference_picture_flag equal to O specifies the picture associated with the PH may or may not be used as a reference picture.
gdr_pic_flag equal to 1 specifies the picture associated with the PH is a GDR picture. gdr pic flag equal to 0 specifies that the picture associated with the PH is not a GDR picture.
no_output_of_prior_pics_flag affects the output of previously-decoded pictures in the decoded picture buffer after the decoding of a CLVSS picture that is not the first picture in the bitstream as specified.
recovery_poc_ent specifies the recovery point of decoded pictures in output order. If the current picture is a GDR picture that is associated with the PH and there is a picture picA that follows the current GDR picture in decoding order in the CL VS and that has PicOrderCntVal equal to the PicOrderCht Val of the current GDR picture plus the value of recovery_poc_cnt, the picture picA is referred to as the recovery point picture. Otherwise, the first picture in output order that has PicOrderCutVal greater than the PicOrderOntVal of the current picture plus the value of recovery poc cnt is referred to as the recovery point picture The recovery point picture shall not precede the current GDR picture in decoding order. The value of recovery_poc_cnt shall be in the range of 0 to MaxPicOrderOntLsb−1, inclusive.
NOTE—When gdr enabled flag is equal to 1 and PicOrderOnt Val of the current picture is greater than or equal to RpPicOrderCntVal of the associated GDR picture, the current and subsequent decoded pictures in output order are exact match to the corresponding pictures produced by starting the decoding process from the previous IRAP picture, when present, preceding the associated GDR picture in decoding order.
ph_pic_parameter_set_id specifies the value of pps pic parameter set id for the PPS in use. The value of ph pic parameter set_id shall be in the range of 0 to 63, inclusive.

It is a requirement of bitstream conformance that the value of Temporalld of the PH shall be greater than or equal to the value of Temporalld of the PPS that has pps_pic_parameter_set_id equal to ph_pic_parameter_set_id.
ph_poc_msb_present_flag equal to 1 specifies that the syntax element poc_msb_val is present in the PH. ph_poc_msb_present_flag equal to 0) specifies that the syntax element poc_muss_val is not present in the PH. When vps_independent_layer_flag [GeneralLayerlds [nih_layer_id]] is equal to 0 and there is a picture in the current AU in a reference layer of the current layer, the value of ph_poc_msb_present_flag shall be equal to 0.
poc_msb_val specifies the POC MSB value of the current picture. The length of the syntax element poc_msb_val is poc_msb_len_minus1+1 bits.
ph_subpic_id_signalling_present_flag equal to 1 specifies that subpicture ID mapping is signalled in the PH. ph_subpic_id_signalling_present_flag equal to 0) specifies that subpicture ID mapping is not signalled in the PH.
ph_subpic_id_len_minus1 plus 1 specifies the number of bits used to represent the syntax element ph_subpic_id [i]. The value of pic_subpic_id_len_minus1 shall be in the range of 0 to 15, inclusive.

It is a requirement of bitstream conformance that the value of ph_subpic_id_len_minus1 shall be the same for all PHs that are referred to by coded pictures in a CLVS.
ph_subpic_id [i] specifies that subpicture ID of the i-thi subpicture. The length of the ph_subpic_id[i] syntax element is ph_subpic_id len_minus1] 1 bits.
The list SubpicldList i J is derived as follows:

$$for ( i = 0 ; i <= sps\_num \_subpics \_minus1 ; i ++ )$$

$$SubpicIdList [ i ] = sps\_subpic \_id \_present \_flag ?$$

$$( sps\_subpic \_id \_signalling \_present \_flag ? sps\_subpic \_id [ i ] : ( ph\_subpic \_ id\_signalling \_present \_flag ? ph\_subpic \_id [ i ] : pps\_subpic \_id [ i ] ) ) : i$$

ph_loop_filter_across_virtual_boundaries_disabled_present_flag equal to 1 specifies that the in-loop filtering operations are disabled across the virtual boundaries in pictures associated to the PH.
ph_loop_filter_across_virtual_boundaries_disabled present_flag equal to 0 specifies that no such disabling of in-loop filtering operations is applied in pictures associated to the PH. The in-loop filtering operations inchide the deblocking filter, sample adaptive offset filter, and adaptive loop filter operations. When not present, the value of ph_loop_filter_across_virtual_boundaries_disabled_present_flag is inferred to be equal to 0.

The parameter VirtualBoundariesDisabledFlag is derived as follows:

$$VirtualBoundariesDisabledFlag = sps\_loop \_filter \_across \_virtual \_boundaries \_disabled \_present \_flag \vert \vert$$

$$ph\_loop \_filter \_across \_virtual \_boundaries \_disabled \_present \_flag$$

ph_num_ver_virtual_boundaries specifies the number of ph_virtual_boundaries_pos_x[i] syntax elements that are present in the PH. When ph num_ver virtual boundaries is not present. it is inferred to be equal to 0).

The parameter VirtualBoundariesNum Ver is derived as follows:

$$VirtualBoundariesNumVer = sps\_loop \_filter \_across \_virtual \_boundaries \_disabled \_present \_flag ?$$

$$sps\_num \_ver \_virtual \_boundaries : ph\_num \_ver \_virtual \_boundaries$$

ph_virtual_boundaries_pos_x[i] is used to compute the value of VirtualBoundariesPosX[i], which specifies the location of the i-th vertical virtual boundary in units of luma samples. ph_virtual_boundaries_pos_x[i] shall be in the range of 1 to Ceil (pic_width_in_luma_samples+8)−1, inclusivc.

The location of the vertical virtual boundary Virtual BoundariesPosX[i] is derived as follows:

$$VirtualBoundariesPosX [ i ] = ( sps\_loop \_filter \_across \_virtual \_boundaries \_disabled \_present \_flag ?$$

$$sps\_virtual \_boundaries \_pos \_x [ i ] : ph\_virtual \_boundaries \_pos \_x [ i ] ) * 8$$

The distance between any two vertical virtual boundaries shall be greater than or equal to CtbSizeY luma samples.

ph_num_hor_virtual_boundaries specifies the number of ph_virtual boundaries pos yl i {syatax elements that are present in the PH. When ph_num_hor_virtual_boundaries is not present. it is inferred to be equal to 0.

The parameter VirtualBoundariesNumHor is derived as follows:

$$VirtualBoundariesNumHor = sps\_loop \_filter \_across \_virtual \_boundaries \_disabled \_present \_flag ?$$

$$sps\_num \_hor \_virtual \_boundaries : ph\_num \_hor \_virtual \_boundaries$$

ph_virtual_boundaries_pos_v[i] is used to compute the value of VirtualBoundariesPosY [i], which specifies the location of the i-th horizontal virtual boundary in units of luma samples. ph_virtual boundaries pos_y [i] shall be in the range of 1 to Ceil (pic_height_in_luma_samples+8)−1. inclusive.

The location of the horizontal virtual boundary VirtualBoundariesPosY [i] is derived as follows:

$$VirtualBoundariesPosY [ i ] = ( sps\_loop \_filter \_across \_virtual \_boundaries \_disabled \_present \_flag ?$$

$$sps\_virtual \_boundaries \_pos \_y [ i ] : ph\_virtual \_boundaries \_pos \_y [ i ] ) * 8$$

The distance between any two horizontal virtual boundaries shall be greater than or equal to CtbSizeY luma samples.

colour_plane_id specifies the colour plane associated with the slices associated with the PH when scparatc colour plane_flag is equal to 1. The value of colour_plane_id shall be in the range of 0 to 2, inclusive. colour plane_id values 0, 1 and 2 correspond to the Y, Ch and Cr planes, respectively.

NOTE—There is no dependency between the decoding processes of pictures having different values of colour_plane_id.

pic_output_flag affects the decoded picture output and removal processes as specified. When pic_output_flag is not present, it is inferred to be equal to l.

pic_rpl_present_flag equals I specifies that reference picture list signalling is present in the PH. pic_tpl_present_flag equals 0 specifics that reference picture list signalling is not present in the PH and may be present in slice headers of slices of the picture.

It is a requirement of bitstream conformance that the value of pic_rpl_present_flag shall be equal to 0 when sps_id_rpl_present_flag is equal to 0 and the picture associated with the PH is an IDR picture.

pic_rpl_sps_flag[i] equal to 1 specifics that reference picture list i for the picture associated with the PH is derived based on one of the ref_pic_list_struct(listIdx, rplsIdx) syntax structures with listIdy equal to i in the SPS. ref_pic_list_sps_flag[i] equal to 0 specifics that reference picture list i of the picture is derived based on the ref_pic_list_struct(listIdx, rplsIdx) syntax structure with lisfdx equal to i that is directly included in the PH. When pic_rpl_sps_Dag [i] is not present. the following applies:
If num_ref_pic_lists_in_sps[i] is equal to 0, the value of pic_rpl_sps_flag[i] is inferred to be equal to 0.
Otherwise if num_ref_pic_lists_in_spst i] is greater than 0) and roll_idx present flag is equal to 0, the-value of pic_rpl_sps_flag [I] is inferred to be equal to pic_rpl_sps_flag [0],
Otherwise, the value of pic_rpl_sps_flag[i] is inferred to be equal to pps_ref_pic_list_sps_ide [i]-−1.

pic_rpl_idx[i] specifies the index, into the list of the ref_pic_list struct(histIdx, vplsIdx) syntax structures with listIdx equal to i included in the SPS, of the ref_pic_list_struct(listIdx, rplsIdx) syntax structure with listidx equal to i that is used for derivation of reference picture list i of the current picture. The syntax element pic rpl_idx[i] is represented by Ceil (Log 2 (num_ref_pic_lists_in_sps[i]) bits. When not present, the value of pic_rpl_idx [i] is inferred to be equal to 0. The value of pic_rpl_idx[i] shall be in the range of 0 to num_ref_pic_lists_in_sps[i]−1, inclusive. When pic rpl_sps_flag[i] is equal to 1 and nuin ref_pic_lists_in_sps[i] is equal to 1. the value of pic_rpl_idx[i] is inferred to be equal to 0. When pic_rpl sps_flag[i] is equal to 1 and roll_idx_present_flag is equal to 0, the value of pic_rpl_idx [1] is inferred to be equal to pic_tpl_idx [0].

The variable PicRplsIdx[i] is derived as follows:

$$PicRplsIdx [ i ] = pic\_rpl \_sps \_flag [ i ] ? pic\_rpl \_idx [ i ] : num\_ref \_pic \_hsts \_in \_sps [ i ]$$

pic_poc_lsb_It [i] [i] specifies the value of the picture order count modulo MaxPicOrderCntLsb of the j-th LTRP entry in the i-th reference picture list for the picture associated with the PH. The length of the pic poc_lsb_It [i] [i] syntax element is log 2_max pic order ent Isb minus4+4 bits.

The variable PicPocLsbLi [i] [i] is derived as follows:

$$PicPocLsbLt [ i ] [ j ] = ltrp\_in \_slice \_header \_flag [ i ] [ PicRplsIdx [ i ] ] ? pic\_poc \_ lsb\_lt [ i ] [ j ] : rpls\_poc \_lsb \_lt [ listIdx ] [ PicRplsIdx [ i ] ] [ j ]$$

pic_delta_poc_msb_present_flag[i l][j] equal to 1 specifics that pic delta poc_msb cycle It[i[[j] is present. pic_delta poc msb_present_flag[i] [i] equal to 0 specifies that pic delta poc msb cycle lt[i] [i] is not present. Let prevTidOPic be the previous picture in decoding order that has nuh_layer_id the same as the PH, has TemporalId equal to 0, and is not a RASL or RADL picture. Let setOfPrevPoc Vals be a set consisting of the following:
the PicOrderCntVal of prevTidOPic, the PicOrderOnt Val of each picture that is referred to by entries in RefPicList [@] or RefPiclist [I] of −prevTidOPic and has nuh_layer_id the same as the current picture, the PicOrderOnt Val of each picture that follows prevTidOPic in decoding order, has nuh_layer_id the same as the current picture, and precedes the current picture in decoding order.

When there is more than one value in setOfPrevPoc Vals for which the value modulo MaxPicOrderOntLsb is equal to PicPocLsbLt [i] [i], the value of pic_delta_poc_msb_present_flagl i ll j] shall be equal to 1.

pic_delta_poc_msb_cycle li [i] {j] specifies the value of the variable PicFullPocLt [: I [i] as follows:

$$if ( j == 0 ) deltaPocMsbCycleLt [ i ] [ j ] = pic\_delta \_poc \_msb \_cycle \_lt [ i ] [ j ]$$

$$else$$

$$eltaPocMsbCycleLt [ i ] [ j ] = pic\_delta \_poc \_msb \_cycle \_lt [ i ] [ j ] + deltaPocMsbCycleLt [ i ] [ j - 1 ]$$

$$PicFullPocLt [ i ] [ j ] = PicOrderCntVal - deltaPocMsbCycleLt [ i ] [ j ] * MaxPicOrderCntLsb - ( PicOrderCntCal \& ( MaxPicOrderCntLsb - 1 ) ) + PicPocLsb \text{?} [ i ] [ j ]$$

$$\text{?} \text{indicates text missing or illegible when filed}$$

The value of pic_delta_poc_msb_cycle_till j] shall be in the range of 0) to 2022-ig2_post_pic_order_at_why must-1) inclusive. When not present, the value of pic delta poc msb_cycle It [i] [i] is inferred to be equal to 0.

partition_constraints_override_flag equal to 1 specifies that partition constraint parameters are present in the PH. partition_constraints_override_flag equal to 0) specifies that partition constraint parameters are not present in the PH. When not present, the value of partition_constraints_override flag is inferred to be equal to 0.

pic_log 2_diff_min_qt_min_cb_intra_slice_luma specifics the difference between the base 2 logarithm of the minimum size in luma samples of a luma leaf block resulting from quadtree splitting of a CTU and the base 2 logarithm of the minimum coding block size in luma samples for luma CUs in the slices with slice_type equal to 2 (1) associated with the PH. The value of pic log 2_diff_min_qt_min_cb_intra_slice_luma shall be in the range of 0 to CtbLog 2SizeY−MinCbLog 2SizeY, inclusive. When not present, the value of pic_log 2_diff_min_qt_min_cb_lumia is inferred to be equal to sps_log 2_diff_min_qt_min_cb_intra_slice_luma.

pic log 2_diff_min_qt_min_cb_inter_slice specifies the difference between the base 2 logarithm of the minimum size in luma samples of a luma leaf block resulting from quadirce splitting of a CTU and the base 2 logarithmn of the minimum luma coding block size in luma samples for luma CUs in the slices with slice_type equal to 0 (B) or 1 (P) associated with the PH. The value of pic log 2_diff_min_qt_min_ch inter_slice shall be in the range of 0 to CtbLog 2SizeY−MinCbLog 2SizeY, inclusive. When not present, the value of pic_log 2_diff_min_qt_min_cb_luma is inferred to be equal to sps_log 2_diff_min_qt_min_cb_inter_slice.

pic_max_mtt_hierarchy_depth_inter_slice specifics the maximum hierarchy_depth for coding units resulting from multi-type tree splitting of a quadtree leal in slices with slice_type equal to( ) (B) or I (P) associated with the PH. The value of pic_max_mtt_hierarchy_depth_inter_slice shall be in the range of 0) to CtbLog 2SizeY−MinCbLog?SizeY, inclusive. When not present, the value of pic_max_mit_hierarchy_depth inter slice is inferred to be equal to sps_max_mtt_hierarchy_depth_inter_slice.

pic_max_mtt_hierarchy_depth_intra_slice_luma specifies the maximum hierarchy_depth for coding units resulting from multi-type tree splitting of a quadtree leaf in shoes with slice type equal to 2 (1) associated with the PH. The value of pic_max_mtt_hierarchy_depth_intra slicc_luma shall bc range of 0 to in the CtbLog 2SizeY−MinCbLog 2SizeY, inclusive. When not present, the value of pic_max_mtt_hierarchy_depth_intra_slice_luma is inferred to be equal to sps_max_mit_hierarchy_depth_intra_slice_luma.

pic_log 2_diff_max_bt_min_qt_intra_slice_luma specifies the difference between the base 2 logarithm of the maximum size (width or height) in luma samples of a luma coding block that can be split using a binary split and the minimun size (width or height) in luma samples of a luma leaf block resulting from quadtree splitting of a CTU in slices with slice_type equal to 2 (1) associated with the PH. The value of pic_log 2_diff_max_bt_min_qt_intra_slice_luma shall be in the range of 0 to CtbLog 2SizeY−. MinQtLog 2SizeIntraY, inclusive. When net present, the value of pic_log 2_diff_max_bt_min_qt_intra_slice_luma is inferred to be equal to sps_log 2_diff_max_bt_min_qt_intra_slice_luma.

pic_log 2_diff_max_it_min_qt_intra_slice_luma specifics the difference between the base 2 logarithm of the maximum size (width or height) in luma samples of a luma coding block that can be split using a ternary split and the minimum size (width or height) in luma samples of a luma leaf block resulting from quadtree splitting of a CTU in slices with slice typo equal to 2 (I) associated with the PH. The value of pic_log 2_diff_max_tt_min_qt_intra_slice_luma shall be in the range of 0 to CtbLog 2SizeY−MinQtLog 2SizeIntraY. inclusive. When not present, the value of pic log 2_diff max tt min_qt intra slice luma is inferred to be equal to sps_log 2_diff_max_ut_min_qt intra slice_luma.

pic_log 2_diff_max_bt_min_qt_inter_slice specifies the difference between the base 2 logarithm of the maximum size (width or height) in luma samples of a luma coding block that can be split using a binary split and the minimum size (width or height) in luma samples of a luma leaf block resulting from quadtree splitting of a CTU in the slices with slice_type equal to 0 (B) or 1 (P) associated with the PH. The value of pic_log 2_diff_max_bt_min_qt_inter_slice shall be in the range of 0 to CtbLog 2SizeY−MinQtLeg2SizeInterY, inclusive. When not present, the value of pic_log 2_diff_max_br_min_qt_inter_slice is inferred to be equal to sps_log 2_diff_max_bt_min_qt_inter_slice.

pic_log 2_diff_max_tt_min_qt_inter_slice specifies the difference between the base 2 logarithm of the maximum size (width or height) in luma samples of a luma coding block that can be split using a ternary split and the minimum size (width or height) in luma samples of a luma leaf block resulting from quadtrec splitting of a CTU in slices with slice_type equal to 0) (B) or 1 (P) associated with the PH. The value of pic_log 2_diff max_tt_min_ql_iter slice shall be in the range of 0 to CtbLog 2SizeY−MinQtLog 2SizeInterY, inclusive. When not present, the value of pic_log 2_diff max_tt min_qt inter slice is inferred to be equal to sps_log 2_diff max_tt min_qt inter slice.

pic_log 2_diff_min_qt_min_cb_intra_slice_chroma specifies the difference between the base 2 logarithm of the minimum size in luma samples of a chroma leaf block resulting from quadtree splitting of a chroma CTU with treeType equal to DUAL_TREE_CHROMA and the base 2 logarithm of the minimum coding block size in luma samples for chroma C′Us with trecType equal to DUAL_TREE_CHROMA in slices with slice_type equal to 2 (1) associated with the PH. The value of pic log 2_diff_min_qt_min_cb_intra_slice chroma shall be in the range of 0 to CtbLog 2SizeY−MinCbLog 2SizeY, inclusive. When not the value of present, pic_log 2_diff_min_qt_min_cb_intra_slice chroma is inferred to be equal 10 sps_log 2_diff_min_qt_min_cb_intra_slice_chroma.

pic_max_mtt_hierarchy_depth_intra_slice chroma specifies the maximum hierarchy_depth for chroma coding units resulting from multi-type tree splitting of a chroma quadtree leaf with treeType equal to DUAL_TREE_CHROMA in slices with slice_type equal to 2 (l) associated with the PH. The value of pic_max_mtt_hierarchy_depth_intra_slice chroma shall be in the range of 0 to CtbLog 2SizeY−MinChLog 2SizeY. inclusive. When not present, the value of pic_max_mit_hierarchy_depth_intra_slice_chroma is inferred to be equal to sps_max_mtt_hierarchy_depth_intra_slice_chroma pic_log 2_diff_max_bt_min_qt_intra_slice_chroma specifies the difference between the base 2 logarithm of the maximum size (width or height) in luma samples of a chroma coding block that can be split using a binary split and the minimum size (width or height) in luma samples of a chroma leaf block resulting from quadtree splitting of a chroma CTU with treeType equal to DUAL_TREE_CHROMA in slices with slice_type equal to 2 (1) associated with the PH. The value of pic_log 2_diff max_bt_min_qt_intra_slice_chroma shall be in the range of 0 to CtbLog 2SizeY−MinQtLog 2SizeIntraC, inclusive. When not present. the value of pic_log 2_diff max_bt_min_qt_intra_slice chroma is inferred 10 be equal to sps_log 2_diff_max_bt_min_qt_intra_slice_chroma pic log 2_diff max_tl min ql_intra_slice_chroma specifies the difference between the base 2 logarithm of the maximum size (width or height) in luma samples of a chroma coding block that can be split using a ternary split and the minimum size (width or height) in luma samples of a chroma leat block resulting from quadtree splitting of a chroma CTU with tree Type equal to DUAL_TREE_CHROMA in slices with slice_type equal to 2 (I) associated with the PH. The value of pic log 2_diff max_It min gt_intra_slice chroma shall be in the range of 0) to CtbLog 2SizeY−MinQtLog 2SizeIntraC. inclusive. When not present. the value of pic_log 2_diff max_tt_min_qt intra slice chroma is inferred to be equal to sps_log 2_diff_max_tt_min_qt_intra_slice_chroma pic_cu_qp_delta_subdiv_intra_slice specifies the maximum cbSubdiv value of coding units in intra slice that convey cu_qp_delta abs and cu_qp della sign flag. The value of pic cu qp delta subdiv_intra_slice shall be in the range of 0 to 2*(CtbLog 2SizeY−MinQtLog 2SizeIntraY+pic_max_mtt_hierarchy_depth_intra_slice_luma), inclusive. When not present, the value of pic cu qp delta subdiv intra slice is inferred to be equal to 0.

pic_cu_qp_delta_subdiv_inter_slice specifies the maximum cbSubdiv value of coding units that in inter slice convey cu_qp_delta_abs and cn_qp_delta_sign_flag. The value of pic_en_qp_delta_subdiv_inter_slice shall be in the range of 0 to 2*(ClbLog 2SizeY−MinQ: Log 2SizeInterY+pic_max_mtt_hierarchy_depth_inter_slice). inclusive.

When not present, the value of pic_cu_qp_delta_subdiv_inter_slice is inferred to be equal to 0.

pic_cu_chroma_gp_offset_subdiv_intra_slice specifies the maximum cbSubdiv value of coding units in intra slice that convey cu chroma qp offset flag. The value of pic cu chroma qp offset subdiv intra slice shall be in the range of 0 to 2*(CtbLog 2SizeY−MinQtLog 2SizeIntraY+pic_max_mft_hierarchy_depth_intra_slice_luma), inclusive

When not present, the value of pic_cu_chroma qp_offset_subdiv_intra_slice is inferred to be equal to 0.

pic_cu_chroma qp_offset subdiv inter_slice specifies the maximum cbSubdiv value of coding units in inter slice that convey cu_chroma qp offset_flag. The value of pic cu chroma qp offset subdiv inter slice shall be in the range of 0 to 2*(CtbLog 2SizeY−MinQ (Log 2SizeInterY+pic_max_mtt_hierarchy_depth_inter_slice), inclusive.

When not present, the value of pic_cu_chroma qp_offset_subdiv_inter_slice is inferred to be equal to 0.

pic_temporal_mvp_enabled_flag specifies whether temporal motion vector predictors can be used for inter prediction for slices associated with the PH. If pic_temporal_mvp_enabled_flag is equal to 0, the syntax elements of the slices associated with the PH shall be constrained such that no temporal motion vector predictor is used in decoding of the slices. Otherwise (pic_temporal_mvp_enabled_flag is equal to 1). temporal motion vector predictors may be used in decoding of the slices associated with the PH. When not present, the value of pic_temporal_mvp_enabled_flag is inferred to be equal to 0.

mvd_11_zero_flag equal to 1 indicates that the mvd_coding (x0, y0, 1) syntax structure is not parsed and MvdLI [x0] [yo] [complds] and MvdLI [ x0] [y0cpldx] [compldx] are set equal to 0 for compldx=0. 1 and cpldx=0.2. mvd_11_zero_flag equal to O indicates that the mvd_coding (x0. y0. 1) syntax structure is parsed. When not present, the value of myd_11_zero_flag is inferred to be equal to pps_mvd_11_zero_ide−1.

pic_six_minus_max_num_merge_cand specifics the maximum number of merging motion vector prediction (MVP) candidates supported in the slices associated with the PH subtracted from 6. The maximum number of merging MVP candidates, MaxNumMergeCand is derived as follows:

$$MaxNum \text{?} MergeCand = 6 - picsix\_minus \_max \_num \_merge \_cand$$

$$\text{?} \text{indicates text missing or illegible when filed}$$

The value of MaxNumMergeCand shall be in the range of 1 to 6, inclusive. When not present, the value of pic six_minus_max_man_merge_cand is inferred to be equal to pps_six_minus_max_num merge cand plus1-1.

pic_five_minus_max_num_subblock_merge_cand specifies the maximum number of subblock-based merging motion vector prediction (MVP) candidates supported in the slice subtracted from 5. When not present, the value of pic_five_minus_max_num_subblock_merge_cand is inferred be equal 10 5-(sps_sbimvp_enabled_flag && pic_temporal_mvp_enabled_flag).

The maximum number of subblock-based merging MVP candidates, MaxNumSub-blockMergeCand is derived as follows:

$$MaxNumSubblockMergeCand = 5 - pic\_five \_minus \_max \_num \_subblock \_merge \_cand$$

The value of Max NumSubblockMergeCand shall be in the range of 0 to 5, inclusive. pic fpel_mmvd_enabled_flag equal to 1 specifies that merge mode with motion vector difference uses integer sample precision in the slices associated with the PH. pic_fpel_mmvd_enabled_flag equal to 0 specifies that merge mode with motion vector difference can use fractional sample precision in the slices associated with the PH. When not present, the value of pic_fpel_mmvd_enabled_flag is inferred to be 0.

pic_disable_hdof_flag equal to 1 specifies that bi-directional optical flow inter prediction based inter bi-prediction is disabled in the slices associated with the PH. pic_disable_bdof_flag equal to 0 specifies that bi-directional optical flow inter prediction based inter bi-prediction may or may not be enabled in the slices associated with the PH.

When pic_disable_bdof_flag is not present, the following applies:

If sps_bdof_enabled_flag is equal to 1. the value of pic_disable_bdof_flag is inferred to be equal to 0. equal to 1. Otherwise (sps_bdof enabled flag is equal to 0), the value of pic disable_bdof flag is inferred to be pic_disable_dmvr_flag equal to 1 specifics that decoder motion vector refinement based inter bi-prediction is disabled in the slices associated with the PH. pic_disable_dmvr_flag equal to 0 specifies that decoder motion vector refinement based inter bi-prediction may or may not be enabled in the slices associated with the PH. When not present, the value of pic disable dmvr flag is inferred to be!.

When pic_disable_dmvr_flag is not present, the following applies:
--. If sps_dmvr enabled_flag is equal to 1, the value of pic disable duivr flag is inferred to be equal to 0. Otherwise (sps_dmvr_enabled_flag is equal to 0), the value of pic_disable_dmvr_flag is inferred to be--, equal to 1 pic_disable_prof_flag equal to 1 specifies that prediction refinement with optical flow is disabled in the slices associated with the PH. pic_disable_prof_flag equal to 0) specifies that prediction refinement with optical flow may or may not be enabled in the slices associated with the PH. When not present, the value of pic_disable_prof_flag is inferred to be 1.

When pic_disable_prof_flag is not present, the following applies:
If sps_affine_prof_enabled_flag is equal to 1, the value of pic_disable_prof_flag is inferred to be equal to 0.
Otherwise (sps_affine_prof_enabled_flag is equal to 0), the value of pic_disable prof flag is inferred to be equal to 1.
pic_max_num_merge_cand_minus_max_num_triangle_cand specifies the maximum number of triangular merge mode candidates supported in the slices associated with the pictur header subtracted from MaxNumMergeCand.
When pic_max_num_merge_cand_minus_max_num_triangle_cand is not present, and sps_triangle_enabled_flag is equal 10 1 and MaxNumMergeCand greater than or equal to 2 pic_max_num_inerge_cand_minus_max_num_triangle_cand is inferred to be equal to pps_max_num_merge_cand_minus_max_num_triangle_cand_plus]−1.

The maximum number of triangular merge mode candidates, MaxNum Triangle-MergcCand is derived as follows:

$$MaxNumTriangleMergeCand = MaxNumMergeCand - pic\_max \_num \_merge \_cand \_minus \_max \_num \_triangle \_cand$$

When pic_max_num_merge_cand_minus_max_num_triangle_cand is present, the value of MaxNumTriangleMergeCand shall be in the range of 2 to MaxNumMergeCand, inclusive.

When pic_max_num_merge_cand_minus_max_num triangle_cand is not present, and (sps_triangle_enabled_flag is equal to 0 or MaxNumMergeCand is less than 2), MaxNum TriangleMergeCand is set equal to 0.

When MaxNumTriangleMergeCand is equal to 0, triangle merge mode is not allowed for the slices associated with the PH.

pic_six_minus_max_num_the_merge_cand specifics the maximum number of IBC merging block vector prediction (BVP) candidates supported in the slices associated with the PH subtracted from 6. The maximum number of IBC merging BVP candidates, MaxNumibcMergeCand is derived as follows:

$$MaxNumIbcMergeCand = 6 - pic\_six \_minus \_max \_num \_ibc \_merge \_cand$$

The value of MaxNumlbcMergeCand shall be in the range of 1 to 6, inclusive. pic joint_cher sign_flag specifies whether, in transform units with tu_joint_cher_residual_flag [x0][y0)] equal to 1. the co-located residual samples of both chroma components have inverted signs. When tu_joint_cbor_residual_flag [x0] [y0] equal to 1 for a transform unit. pic_joint_cher sign flag equal to 0 specifies that the sign of each residual sample of the Cr (or Cb) component is identical to the sign of the co-located Cb(or Cr) residual sample and pic joint cher sign_flag equal to 1 specifies that the sign of each residual sample of the Cr (or Cb) component is given by the inverted sign of the co-located Cb(or Cr) residual sample pic_sao_enabled_present_flag equal to 1 specifies that pic_sao_luma flag and pic_sao_chroma_flag are present in the PH. pic_sao_enabled_present_flag equal to O specifies that pic_sao_luma_flag and pic_sao_chroma_flag are not present in the PH. When pic_sao_enabled_present_fag is not present, it is inferred to be equal to( ) pic_sao_luma_flag equal to 1 specifies that SAO is enabled for the luma component in all slices associated with the PH; pic_sao_luma_flag equal to 0 specifies that SAO for the luma component may be disabled for one, or more, ot all slices associated with the PH. When pic_sao luma_flag is not present. it is inferred to be equal to 0.

pic_sao_chroma_flag equal to 1 specifies that SAO is enabled for the chroma component in all slices associated with the PH; pre_sao_chroma_flag equal to 0 specifics that SAO for chroma component may be disabled for one, or more. or all slices associated with the PH. When pic_sao_chroma_flag is not present, it is inferred to be equal to 0.

pic_alf_enabled_present_flag equal to 1 specifies that pic_alf_enabled_flag, pic_num_alf_aps_ids_luma, pic_alf_aps_id_luma [i], pic_alf_chroma_ide, and pic_all_aps_id_chroma are present in the PH. pic_all_enabled_present_flag equal to 0 specifies that pic_all_enabled_flag, pic_num_all_aps_ids_luma, pic_alf_aps_id_luma [i], pic_alf_chroma_ide, and pic_alf_aps_id_chroma are not present in the PH. When pic_alf_enabled_present_flag is not present. it is inferred to be equal to 0.

pic_alf_enabled_flag equal to 1 specifies that adaptive loop filter is enabled for all slices associated with the PH and may be applied to Y, Cb, or Cr colour component in the slices. pic_alf enabled flag equal to 0 specifies that adaptive loop filter may be disabled for one, or more, or all slices associated with the PH. When not present, pic alf enabled flag is inferred to be equal to( ) pic_num_alf_aps_ids luma specifies the number of ALF APSs that the slices associated with the PH refers to.

pic_alf_aps_id_luma [i] specifics the adaptation_parameter_set_id of the i-th ALF APS that the luma component of the slices associated with the PH refers to.

The value of alf luma filter signal flag of the APS NAL unit having aps params type equal to ALF APS and adaptation parameter_set id equal to pic_alf aps_id_luma [i] shall be equal to 1.

pic_all_chroma_ide equal to 0 specifies that the adaptive loop filter is not applied to Cb and Cr colour components. pic alf chroma ide equal to 1 indicates that the adaptive loop filter is applied to the Cb colour component. pic alf chroma idc equal to 2 indicates that the adaptive loop filter is applied to the Cr colour component. pic alf chroma idc equal to 3 indicates that the adaptive loop filter is applied to Ch and Cr colour components. When pic_alf_chroma_idc is not present, it is inferred to be equal to 0.

pic_alf_aps_id_chroma specifies the adaptation parameter set_id of the ALF APS that the chroma component of the slices associated with the PH refers to.

The value of alf_chroma_filter_signal_flag of the APS NAL unit having aps_params_type equal to ALF_APS and adaptation_parameter_set_id equal to pic_alf_aps_id_chroma shall be equal to 1.

pic_dep_quant_enabled_flag equal to 0 specifies that dependent quantization is disabled for slices associated with the PH. pic_dep_quant_enabled_flag equal to 1 specifies that dependent quantization is enabled for slices associated with the PH. When not present, the value of pic_dep_quant_enabled_flag is inicred to be equal to pps_dep_quant_enable_idc−1.

sign_data_hiding_enabled_flag equal to 0 specifies that sign bit hiding is disabled. sign_data_hiding_enabled_flag equal to 1 specifies that sign bit hiding is enabled. When sign_data_hiding_enabled_flag is not present. it is inferred to be equal to 0.

pic_deblocking_filter_override_present_flag equal to 1 specifies that pic_deblocking filter override_flag is present in the PH. pic deblocking filter override present flag equal to 0 specifies that pic_deblocking filter override flag is not present in the PH. When pic_deblocking_filter_override_present_flag is not present, it is inferred to be equal to 0.

pic_deblocking_filter_override_flag equal to 1 specifies that deblocking parameters are present in the PH. pic_deblocking_filter_override_flag equal to 0 specifies that deblocking parameters are not present in the PH. When not present, the value of pic_pic_deblocking_filter_override_flag is inferred to be equal to 0.

pic_deblocking_filter_disabled_flag equal to 1 specifies that the operation of the deblocking filter is not apphed for the slices associated with the PH. pic_deblocking_filter_disabled_flag equal to 0) specifies that the operation of the deblocking filter is applied for the slices associated with the PH. When pic_deblocking_filter_disabled_flag is not present, it is inferred to be equal to pps deblocking filter disabled flag pic_beta_offset_div2 and pic_the_offset_div2 specify the deblocking parameter offsets for B and IC (divided by 2) for the slices associated with the PH. The values of pic_beta_offset_div2 and pic_the_offset_div2 shall both be in the range of −6 to 6, inclusive. When not present, the values of pic_beta_offset_div2 and pic_to_offset_div2 are inferred to be equal to pps_beta_offset_div2 and pps_to_offset_div2, respectively.

pic_Imes_enabled_flag equal to 1 specifies that luma mapping with chroma scaling is enabled for all slices associated with the PH. pic Imes enabled flag equal to 0 specifics that luma mapping with chroma scaling may be disabled for one, or more, or all slices associated with the PH. When not present, the value of pic_Imes enabled flag is inferred to be equal to 0.

pic_Imes_aps_id specifies the adaptation parameter_set_id of the LMCS APS that the slices associated with the PH refers to. The Temporalld of the APS NAL unit having aps params_type equal to LMCS_APS and adaptation parameter set id equal to pic Imes aps_id shall be less than or equal to the Temporalld of the picture associated with PH.

pic_chroma_residual_scale_flag equal to} specifies that chroma residual scaling is enabled for the all slices associated with the PH. pic chroma_residual scale flag equal to 0 specifies that chroma residual scaling may be disabled for one, or more, or all slices associated with the PH. When pic chroma residual scale flag is not present. it is inferred to be equal to 0.

pic_scaling_list_present_flag equal to 1 specifies that the scaling list data used for the slices associated wih the PH is derived based on the scaling list data contained in the referenced scaling list APS. pic scaling list present flag equal to 0 specifies that the scaling list data used for the slices associated with the PH is the default scaling list data derived specified. When not present. the value of pic_scaling_list present_flag is inferred to be equal to 0).

pic_scaling_list_aps_id specifies the adaptation_parameter set_id of the scaling list APS. The TemporalId of the APS NAL unit having aps params_type equal to SCALING APS and adaptation parameter set id equal to pic_scaling_list_aps_id shall be less than or equal to the Temporalld of the picture associated with PH.

ph_extension_length specifies the length of the PH extension data in bytes, not including the bits used for signalling ph_extension_length itself. The value of ph_extension_length shall be in the range of 0 to 256, inclusive. When not present, the value of ph_extension_length is inferred to be equal to 0.

ph_extension_data_byte may have any value. Decoders conforming to this version of this Specification shall ignore the value of ph_extension_data_byte. Its value does not affect decoder conformance to profiles specified in this version of specification.

As provided in Table 2, a NAL unit may include coded slices of pictures. A slice syntax structure includes slice_header( ) syntax structure and a slice_data( ) syntax structure. Table 6 illustrates the syntax of the slice header provided in JVET-P2001.

TABLE 6

| | Descriptor |
|---|---|
| slice_header( ) { | |
| slice_pic_order_cnt_lsb | u(v) |
| if( subpics_present_flag ) | |
| slice_subpic_id | u(v) |
| if( rect_slice_flag \| \| NumTilesInPic > 1 ) | |
| slice_address | u(v) |
| if( !rect_slice_flag && NumTilesInPic > 1 ) | |
| num_tiles_in_slice_minus1 | ue(v) |
| slice_type | ue(v) |
| if( !pic_rpl_present_flag &&( ( nal_unit_type != IDR_W_RADL && nal_unit_type != | |
| IDR_N_LP ) \| \| sps_idr_rpl_present_flag ) ) { | |
| for( i = 0; i < 2; i++ ) { | |
| if( num_ref_pic_lists_in_sps[ i ] > 0 && !pps_ref_pic_list_sps_idc[ i ] && | |
| ( i = = 0 \| \| ( i = = 1 && rpl1_idx_present_flag ) ) ) | |
| slice_rpl_sps_flag[ i ] | u(1) |
| if( slice_rpl_sps_flag[ i ] ) { | |
| if( num_ref_pic_lists_in_sps[ i ] > 1 && | |
| ( i = = 0 \| \| ( i = = 1 && rpl1_idx_present_flag ) ) ) | |
| slice_rpl_idx[ i ] | u(v) |
| } else | |
| ref_pic_list_struct( i, num_ref_pic_lists_in_sps[ i ] ) | |
| for( j = 0; j < NumLtrpEntries[ i ][ RplsIdx[ i ] ]; j++ ) { | |
| if( ltrp_in_slice_header_flag[ i ][ RplsIdx[ i ] ] ) | |
| slice_poc_lsb_lt[ i ][ j ] | u(v) |
| slice_delta_poc_msb_present_flag[ i ][ j ] | u(1) |
| if( slice_delta_poc_msb_present_flag[ i ][ j ] ) | |
| slice_delta_poc_msb_cycle_lt[ i ][ j ] | ue(v) |
| } | |
| } | |
| } | |
| if( pic_rpl_present_flag \| \| ( ( nal_unit_type != IDR_W_RADL && nal_unit_type != | |
| IDR_N_LP ) \| \| sps_idr_rpl_present_flag ) ) { | |
| if( ( slice_type != I && num_ref_entries[ 0 ][ RplsIdx[ 0 ] ] > 1 ) \| \| | |
| ( slice_type = = B && num_ref_entries[ 1 ][ RplsIdx[ 1 ] ] > 1 ) ) { | |
| num_ref_idx_active_override_flag | u(1) |
| if( num_ref_idx_active_override_flag ) | |
| for( i = 0; i < ( slice_type = = B ? 2: 1 ); i++ ) | |
| if( num_ref_entries[ i ][ RplsIdx[ i ] ] > 1 ) | |
| num_ref_idx_active_minus1[ i ] | ue(v) |
| } | |
| } | |
| if( slice_type != I ) { | |
| if( cabac_init_present_flag ) | |
| cabac_init_flag | u(1) |
| if( pic_temporal_mvp_enabled_flag ) { | |
| if( slice_type = = B && !pps_collocated_from_l0_idc ) | |
| collocated_from_l0_flag | u(1) |
| if( ( collocated_from_l0_flag && NumRefIdxActive[ 0 ] > 1 ) \| \| | |
| ( !collocated_from_l0_flag && NumRefIdxActive[ 1 ] > 1 ) ) | |
| collocated_ref_idx | ue(v) |
| } | |
| if( ( pps_weighted_pred_flag && slice_type = = P ) \| \| | |
| ( pps_weighted_bipred_flag && slice_type = = B ) ) | |
| pred_weight_table( ) | |
| } | |
| slice_qp_delta | se(v) |
| if( pps_slice_chroma_qp_offsets_present_flag ) { | |
| slice_cb_qp_offset | se(v) |
| slice_cr_qp_offset | se(v) |
| if( sps_joint_cbcr_enabled_flag ) | |
| slice_joint_cbcr_qp_offset | se(v) |
| } | |
| if( sps_sao_enabled_flag && !pic_sao_enabled_present_flag ) { | |
| slice_sao_luma_flag | u(1) |
| if( ChromaArrayType != 0 ) | |
| slice_sao_chroma_flag | |
| } | |
| if( sps_alf_enabled_flag && !pic_alf_enabled_present_flag ) { | |
| slice_alf_enabled_flag | u(1) |
| if( slice_alf_enabled_flag ) { | |
| slice_num_alf_aps_ids_luma | u(3) |
| for( i = 0; i < slice_num_alf_aps_ids_luma; i++ ) | |
| slice_alf_aps_id_luma[ i ] | u(3) |
| if( ChromaArrayType != 0 ) | |
| slice_alf_chroma_idc | u(2) |
| if( slice_alf_chroma_idc ) | |
| slice_alf_aps_id_chroma | u(3) |
| } | |
| } | |
| if( deblocking_filter_override_enabled_flag && | |
| !pic_deblocking_filter_override_present_flag ) | |
| slice_deblocking_filter_override_flag | u(1) |
| if( slice_deblocking_filter_override_flag ) { | |
| slice_deblocking_filter_disabled_flag | u(1) |
| if( !slice deblocking filter disabled flag ) { | |
| slice_beta_offset_div2 | se(v) |
| slice_tc_offset_div2 | se(v) |
| } | |
| } | |
| if( entry_point_offsets_present_flag && NumEntryPoints > 0 ) { | |
| offset_len_minus1 | ue(v) |
| for( i = 0; i < NumEntryPoints; i++ ) | |
| entry_point_offset_minus1[ i ] | u(v) |
| } | |
| if( slice_header_extension_present_flag ) { | |
| slice_header_extension_length | ue(v) |
| for( i = 0; i < slice_header_extension_length; i++) | |
| slice_header_extension_data_byte[ i ] | u(8) |
| } | |
| byte_alignment( ) | |
| } | |

With respect to Table 6, JVET-P2001 provides the following semantics:

When present, the value of the slice header syntax element slice pic_order_cnt_Isb shall be the same in all slice headers of a coded picture.

The variable CuQpDelta Val, specifying the difference between a luma quantization parameter for the coding unit containing cu_qp_delta_abs and its prediction, is set equal to 0. The variables CuQpOffsetc., CuQpOffsetc, and CuQpOffsetccr, specifying values to be used when determining the respective values of the Qp′ce, Qp′cn, and Qp′ cac: quantization parameters for the coding unit containing cu_chroma_qp_offset_flag, are all set equal to 0.

slice_pic_order_cnt_Ish specifies the picture order count modulo MaxPicOrderCntLsb for the current picture. The length of the slice pic order_cnt Isb syntax element is log 2_max pic order ent Isb_minus4+4 bits. The value of the slice_pic_order_cnt_lsb shall be in the range of 0 to MaxPicOrderCuL.sh−1, inclusive.

When the current picture is a GDR picture, the variable RpPicOrderCntVal is derived as follows:

$$RpPicOrdcrCntVal - PicOrderCntVal - recovery\_poc \_cnt$$

slice_subpic_id specifies the subpicture identifier of the subpicture that contains the slice If slice_subpic_id is present. the value of the variable SubPiclax is derived to be such that Subpicldl . . . ist [SubPicldx] is equal to slice_subpic_id. Otherwise (slice subpic_id is not present), the variable SubPicIdx is derived to be equal to 0. The length of slice_subpic_id, in bits, is derived as follows:
If sps_subpic_id signalling present_flag is equal to 1, the length of slice subpic id is equal to sps_subpic_id_len_minns1+1.
Otherwise, if ph_subpic_id_signalling_present_flag is equal to 1, the length of slice_subpic_id is equal to ph_subpic_id len minus1+1.
Otherwise, if ph subpic_id signalling present flag is equal to 1, the length of slice subpic id is equal to pps_subpic_id_len_minus] +].

Otherwise, the length of slice subpic_id is equal to Ceil (Log 2 (sps_num_subpics_minus1+1)). slice_address specifies the slice address of the slice. When not present. the value of slice address is inferred to be equal to 0.

If rect_slice_flag is equal to 0, the following applies:
The slice address is the raster scan tile index.

The length of slice_address is Ceil (Log 2 (Num TilesInPic)) bits.
The value of slice_address shall be in the range of 0 to NumTileslaPic−1, inclusive.

Otherwise (rect_slice_flag is equal to 1), the following applies:
The slice address is the slice index of the slice within the SubPicIdx-th subpicture.

The length of slice_address is Ceil (Log 2 (NumSlicesInSubpic [ SubPicIdx])) bits.
The value of slice_address shall be in the range of 0 to NumSlicesInSubpic [SubPieldx]−1, inclusive.

It is a requirement of bitstream conformance that the following constraints apply:
If rect slice flag is equal to 0 or subpics present_flag is equal to 0. the value of slice address shall not be equal to the value of slice_address of any other coded slice NAL unit of the same coded picture.
Otherwise, the pair of slice subpic_id and slice address values shall not be equal to the pair of slice_subpic_id and slice_address values of any other coded slice NAL unit of the same coded picture.
When rect_slice_flag is equal to 0, the slices of a picture shall be in increasing order of their slice_address values.
The shapes of the slices of a picture shall be such that each CTU, when decoded, shall have its entire left boundary and entire top boundary consisting of a picture boundary or consisting of boundaries of previously decoded CTU(s).

For any two subpictures subpicA and subpicB, when the index of subpicA is less than the index of subpicB. any coded NAL unit of subPicA shall succeed any coded NAL unit of subPicB in decoding order.
The shapes of the subpictures of a picture shall be such that each subpicture, when decoded. shall have its entire left boundary and entire top boundary consisting of picture boundaries or consisting of boundaries of previously decoded subpictures.

num_tiles_in_slice_minus plus 1, when present, specifies the number of tiles in the slice. The value of num_tiles_in_slice_minus1 shall be in the range of 0 to NumTilesInPic−1, inclusive.

The variable NumCtuinCurrSlicewhich specifies the number of CTUs in the current slice, and the list CtbAddrInCurrSlice [i]. for i ranging from 0 to NumCtuInCurrSlice−1. inclusive, specifying the picture raster scan address of the i-th CFB within the slice, are derived as follows:

```
if( rcct_slice_flag ) {
  picLevelSliceIdx = SliceSubpicToPicIdx[ SubPicIdx ][ slice_address ]
  NumCtuInCurrSlice = NumCtuInSlice[ picLevelSliceIdx ]
  for( i = 0; i < NumCtuInCurrSlice; i++ )
    CtbAddrInCurrSlice[ i ] = CtbAddrInSlice[ picLevelSliceIdx ][ i ]
} else {
  NunCtuInCurrSlice = 0
  for( tileIdx = slice_address; tileIdx <= slice_address + num_tiles_in_slice_minus1[ i ]; tileIdx++ ) {
    tileX = tileIdx % NumTileColumns
    tileY = tileIdx / NumTileColumns
    for( ctbY = tileRowBd[ tileY ]; ctbY < tileRowBd[ tileY + 1 ]; ctbY++ ) {
      for( ctbX = tileColBd[ tileX ]; ctbX < tileColBd[ tileX + 1 ]; ctbX++ ) {
        CtbAddrInCurSlice[ NumCtuInCurrSlice ] = ctbY * PicWidthInCtb + ctbX
        NumCtuInCurrSlice++
      }
    }
  }
}
```

The variables SubPicLeftBoundaryPos, SubPic TopBoundaryPos, SubPicRight-BoundaryPos. and SubPicBotBoundaryPos are derived as follows:

```
if( subpic_treated_as_pic_flag[ SubPicIdx ] ) {
  SubPicLeftBoundaryPos = subpic_ctu_top_left_x[ SubPicIdx ] * CtbSizeY
  SubPicRightBoundaryPos = Min( pic_width_max_in_luma_samples − 1,
  ( subpic_ctu_top_left_x[ SubPicIdx ] + subpic_width_minus1[ SubPicIdx ] + 1 ) * CibSizeY − 1)
  SubPicTopBoundaryPos = subpic_ctu_top_left_y[ SubPicIdx ] *CtbSizeY
  SubPicBotBoundaryPos = Min( pic_height_max_in_luma_samples − 1,
  ( subpic_ctu_top_left_y[ SubPicIdx ] + subpic_height_minus1[ SubPicIdx ] + 1 ) * CibSizeY − 1)
}
```

slice_type specifies the coding type of the slice according to Table 7.

TABLE 7

| slice_type | Name of slice_type |
|---|---|
| 0 | B (B slice) |
| 1 | P (P slice) |
| 2 | I (I slice) |

When nal_unit_type is a value of nal_unit_type in the range of IDR_W_RADL to CRA_NUT, inclusive, and the current picture is the first picture in an access unit, slice_type shall be equal to 2.

The variables MinQtLog 2SizeY, MinQtLog 2SizeC, MinQtSizeY, MinQtSizeC, MaxBtSizeY, MaxBtSizeC, MinBtSize Y, MaxTtSize Y, MaxTtSizeC, MinTtSizeY, MaxMttDepth Y and MaxMttDepthC are derived as follows:

$$MinQtSizeY = 1 << MinQtLog 2 SizeY$$

$$MinQtSizeC = 1 << MinQtLog 2 SizeC$$

$$MinBtSizeY = 1 << MinCbLog 2 SizeY$$

$$MinTtSizeY = 1 << MinCbLog 2 SizeY$$

If slice_type equal to 2 (I),

$$MinQtLog 2 SizeY = MinCbLog 2 SizeY + pic\_log 2 \_ diff\_min \_ qt \_min \_ cb\_ intra\_ slice \_luma$$

$$MinQtLog 2 SizeC = MinCbLog 2 SizeC + pic\_log 2 \_ diff\_min \_ qt \_min \_ cb\_ intra\_ slice \_chroma$$

$$MaxBtSizeY = 1 << ( MinQtLog 2 SizeY + pic\_log 2 \_diff \_max \_bt \_min \_qt \_intra \_slice \_luma )$$

$$MaxBtSizeC = 1 << ( MinQtLog 2 SizeC + pic\_ log 2 \_ diff\_max \_bt \_ min\_qt \_ intra\_slice \_chroma )$$

$$MaxTtSizeY - 1 << ( MinQtLog 2 SizeY + pic\_ log 2 \_ diff\_max \_tt \_ min\_qt \_ intra\_slice \_luma )$$

$$MaxTtSizeY = 1 << ( MinQtLog 2 SizeC + pic\_ log 2 \_ diff\_max \_tt \_ min\_qt \_ intra\_slice \_chroma )$$

$$MaxMttDepthY = pic\_max \_mtt \_hierarchy \_depth \_intra \_slice \_luma$$

$$MaxMttDepthC = pic \_max \_mtt \_hierarchy \_ depth\_intra \_slice \_chroma$$

$$CuQpDeltaSubdiv = pic \_cu \_qp \_delta \_subdiv \_ intra\_slice$$

$$CuChromaQpOffsetSubdiv = pic\_cu \_chroma \_qp \_offset \_subdiv \_intra \_slice$$

Otherwise (slice_type equal to 0 (B) or 1 (P)),

$$MinQtLog 2 SizeY = MinCbLog 2 SizeY + pic\_log 2 \_ diff\_min \_ qt \_min \_ cb\_ inter\_ slice$$

$$MinQtLog 2 SizeC = MinCbLog 2 SizeC + pic\_log 2 \_ diff\_min \_ qt \_min \_ cb\_ inter\_ slice$$

$$MaxBtSizeY = 1 << ( MinQtLog 2 SizeY + pic\_log 2 \_diff \_max \_bt \_min \_qt \_inter \_slice )$$

$$MaxBtSizeC = 1 << ( MinQtLog 2 SizeC + pic\_ log 2 \_ diff\_max \_bt \_ min\_qt \_ inter\_slice )$$

$$MaxTtSizeY = 1 << ( MinQtLog 2 SizeY + pic\_ log 2 \_ diff\_max \_tt \_ min\_qt \_ inter\_slice )$$

$$MaxTtSizeC = 1 << ( MinQtLog 2 SizeC + pic\_ log 2 \_ diff\_max \_tt \_ min\_qt \_ intra\_slice )$$

$$MaxMttDepthY = pic\_max \_mtt \_hierarchy \_depth \_inter \_slice$$

$$MaxMttDepthC = pic \_max \_mtt \_hierarchy \_ depth\_inter \_slice$$

$$CuQpDeltaSubdiv = pic \_cu \_qp \_delta \_subdiv \_ inter\_slice$$

$$CuChromaQpOffsetSubdiv = pic\_cu \_chroma \_qp \_offset \_subdiv \_inter \_slice$$

slice_rpl_sps_flag[i] equal to 1 specifies that reference picture list i of the current slice is derived based on one of the ref_pic_list_struct(listIdx, rplsIdx) syntax structures with listIdx equal to i in the SPS. slice_rpl sps_flag[i] equal to 0 specifies that reference picture list i of the current slice is derived based on the ref_pic_list_struct(listIdx, rplslax) syntax structure with listldx equal to i that is directly included in the slice headers of the current picture. When slice_rpl_sps_flag[i] is not present, the following applics:

If pic_rpl_present_flag is equal to 1, the value of slice_rpl_sps_flag[i] is inferred to be equal to pic_rpl_sps_flag[i].

Otherwise, if num_ref_pic_lists_in_sps[i] is equal to 0, the value of ref_pic_list_sps_flag[i] is inferred to be equal to 0.

Otherwise, if num_ref_pic lists_in_sps[i] is greater than 0 and if rpll_idx_present flag is equal to 0. the value of slice rpl sps_flag [1] is inferred to be equal to slice rpl sps_flag [0].

slice_rpl_idx[i] specifies the index, into the list of the ref_pic list struct(listidx, rplslds) syntax structures with listIdx equal to i included in the SPS, of the ref_pic_list_struct(listIdx, rplsIdx) syntax structure with Jistldx equal to i that is used for derivation of reference picture list i of the current picture. The syntax element slice rpl idx[if is represented by Ceil (Log 2 (nutn_ref_pic_lists_in_sps[i])) bits. When not present, the value of slice rpl idx[i] is inferred to be equal to 0. The value of slice_rpl_idx[i] shall be in the range of 0 to nunit_ref_pic_lists_in_sps[i]−1, inclusive. When slice_rpl_sps_flag[i] is equal to 1 and num_ref_pic_lists_in_sps[i] is equal to 1, the value of slice_rpl_idx[i] is inferred to be equal to 0. When slice_rpl_sps_flag[i] is equal to 1 and roll_idx_present_flag is equal to 0, the value of slice_tpl_ids [1] is inferred to be equal to slice_tpl_idx [0].

The variable Rplsldx[i] is derived as follows:

```
if( pic_rpl_present_flag )
  RplsIdx[ i ] = PicRplsIdx[ i ]
else
  RplsIdx[ i ] = slice_rpl_sps_flag[ i ] ? slice_tpl_idx[ i ] :
  num_ref_pic_lists_in_sps[ i ]
```

slice_poc_Ish_It [i] [i] specifies the value of the picture order count modulo MaxPicOrderOntLsb of the j-th LTRP entry in the i-th reference picture list The length of the slice pos_lsb_It [i] [i] syntax element is log 2_max_pic_order_cnt_Isb_minus4+4 bits.

The variable PocLsbLI [i]][j] is derived as follows:

```
if( pic_rpl_present_flag )
  PocLsbLt[ i ][ j ] = PocLsbLt[ i ][ j ]
else
  PocLsbLt[ i ][ j ] = ltrp_in_slice_header_flag[ i ][ RplsIdx[ i ] ] ?
    slice_poc_lsb_lt[ i ][ j ] : rpls_poc_lsb_lt[ listIdx ][
    RplsIdx[ i ][ j ]
```

slice_delta_poc_msb_present_flag[i] [i] equal to 1 specifies that slice_della_poc_msb_cycle_ltf i Ilj] is present. slice_delta_poc_msb_present_flag[i] [i] equal to 0 specifies that slice_delta_poc_msb_cycle_It [i] [i] is not present. Let prevTidOPic be the previous picture in decoding order that has nuh_layer_id the same as the current picture, has

TemporalId equal to 0, and is not a RASL or RADL picture. Let setOfPreyPoc Vals be a set consisting of the following:

the PicOrderCntVal of prev TidOPic, the PicOrderOntVai of each picture that is referred to by entries in RefPicList [0] or RefPiclist [I] of prevTidOPic and has nuh_layer_id the same as the current picture.

the PicOrderOntVal of each picture that follows prevTidOPic in decoding order, has mih_layer_id the same-as the current picture, and precedes the current picture in decoding order.

When pic_rpl_present_flag is equal to 0 and there is more than one value in setOfPrevPoc Vals for which the value modulo MaxPicOrderCniLsb is equal to Pocusbl.If i] [i], the value of slice delta poc_isb present_fagl i ∥ j į shall be equal to 1.

slice_delta_poc_msb_cycle_Itf i] [i] specifies the value of the variable FullPocLt {i} {j] as follows:

```
if( pic_rpl_present_flag )
  FullPocLt[ i ][ j ] = PicFullPocLt[ i ][ j ]
else {
  if( j = = 0 )
    DeltaPocMsbCycleLt[ i ][ j ] = delta_poc_msb_cycle_lt[ i ][ j ]
  else
    DeltaPocMsbCycleLt[ i ][ j ] = delta_poc_msb_cycle_lt[ i ][ j ] +
DeltaPocMsbCycleLt[ i ][ j − 1 ]
  FullPocLt[ i ][ j ] = PicOrderCntVal − DeltaPocMsbCycleLt[ i ][ j ] *
  MaxPicOrderCntLsb
− ( PicOrderCntVal & ( MaxPicOrderCntLsb − 1 ) ) + PocLsbLt[ i ][ j ]
}
```

The value of slice_delta_poc_msb_cycle It [i] [i] shall be in the range of 0 to 202-kg ma gio eder al kb obno4-4) inclusive. When not present, the value of slice_delta_poc_msb_cycle_It [i] [i] is inferred to be equal to 0.

num_ref_idx_active_override_flag equal to 1 specifies that the syntax element num_ref_idx active minus1[ 0] is present for P and B slices and that the syntax element num_ref idx active minus1[1] is present for B slices num_ref_idx_active_override_flag equal to 0 specifies that the syntax elements num_ref_idx_active_minus1[0] and num_ref_idx_active_minus1[1] are not present. When not present, the value of num_ref_idx_active_override_flag is inferred to be equal to 1.

num_ref_idx_active_minus1[i] is used for the derivation of the variable NumRefIdxActive [i] as specified by Equation 7-122. The value of num_ref_idx_active_minus1[i] shall be in the range of 0 to 14, inclusive. For i equal to 0 or 1, when the current. slice is a B slice, num_ref_idx_active_override_flag is equal to 1, and num_ref_idx_active_minus] [i] is not present, num_ref_idx_active_minus] [i] is inferred to be equal to 0, When the current slice is a P slice, num_ref_idx_active_override flag is equal to 1, and num_ref_idx_active minus] [0] is not present, num_ref_idx_active_minus 1[0] is inferred to be equal to 0. The variable NumRefIdxActive [i] is derived as follows:

```
for( i = 0; i < 2, i++ ) {
  if( slice_type = = B || ( slice_type = = P && i = = 0 ) ) {
    if( num_ref_idx_active_override_flag )
      NumRefIdxActive[ i ] = num ref idx active minus1[ i ] + 1
    else {
      if( num_ref_entries[ i ][ RplsIdx[ i ] ] >= num_ref idx_default_active_minus1[ i ] + 1 )
        NumRefIdxActive[ i ] = num_ref_idx_default_active_minus1[ i ] + 1
      else
        NumRefIdxActive[ i ] = num_ref_entries[ i ][ RplsIdx[ i ] ]
    }
  } else // slice_type = = I || ( slice_type = = P && i = = 1 )
    NumRefIdxActive[ i ] = 0
}
```

The value of NumReflexActive [i] . . . . I specifies the maximum reference index for reference picture list i that may be used to decode the slice. When the value of NumRefIdxActive [i] is equal to 0, no reference index for reference picture list i may be used to decode the slice.

When the current slice is a D′ slice, the value of NumRefidxActivet 0] shall be greater than 0.

When the current slice is a B slice, both NumRelldxActive[0] and NumRefldxActive [1] shall be greater than 0. cabac_init_flag specifies the method for determining die imtialization table used in the imtialization process for context variables. When cabac_init_flag is not present. it is inferred to be equal to 0.

collocated_from_10_flag equal to 1 specifies that the collocated picture used for temporal motion vector prediction is derived from reference picture list 0. collocated_from_10_flag equal to 0) specifies that the collocated picture used for temporal motion vector prediction is derived from reference picture list 1.

When collocated_from_10_flag is not present, the following applies:
If slice type is not equal to B, the value of collocated_from_10_flag is inferred to be equal to I.

Otherwise (slice_type is equal to B), the value of collocated_from_10_flag is inferred to be equal to-pps_collocated_from_10_idc−1.

collocated_ref_idx specifies the reference index of the collocated picture used for temporal motion vector prediction. When slice_type is equal to P or when slice_type is equal to B and collocated_from_10_flag is equal to 1, collocated_ref_idx refers to a picture in list 0, and the value of collocated_ref_idx shall be in the range of 0 to NumRefIdxActive [0]-1, inclusive.

When slice_type is equal to B and collocated_from_10_flag is equal to 0, collocated_ref_idx refers to a picture in list 1, and the value of collocated_ref_idx shall be in the range of 0 to NumRefldx Active [1]--1, inclusive.

When collocated_ref_idx is not present, the value of collocated_ref_idx is inferred to be equal to 0.

It is a requirement of bitstream conformance that the picture referred to by collocated_ref_idx shall be the same for all slices of a coded picture.

It is a requirement of bitstream conformance that the resolutions of the reference picture referred to by collocated_ref_idx and the current picture shall be the same and RefPicIsScaled [collocated_from_10_flag? 0:1] [collocated_ref_idx] shall be equal to 0.

slice_qp_delta specifies the initial value of Qpy to be used for the coding blocks in the slice until modified by the value of CuQpDeltaVal in the coding unit layer. The initial value of the Qpy quantization parameter for the slice, Slice (py, is derived as follows:

$$SliceQp \text{?} = 26 + init\_qp \_minus 26 + slice\_qp \_delta$$

$$\text{?} \text{indicates text missing or illegible when filed}$$

The value of SliceQpy shall be in the range of −QpBdOffset to +63, inclusive. slice_ch qp_offset specifies a difference to be added to the value of pps cb qp_offset when determining the value of the Qp′ ce quantization parameter. The value of slice cb qp offset shall be in the range of −12 to +12, inclusive. When slice cb qp offset is not present, it is inferred to be equal to 0. The value of pps_cb_qp_offset+slice_ch_qp_offset shall be in the range of −12 10+12, inclusive.

slice_cr_qp_offset specifies a difference to be added to the value of pps er qp offset when determining the value of the Qp′ a quantization parameter. The value of slice_er_qp_offset shall be in the range of −12 to +12, inclusive. When slice_cr_qp_offset is not present. it is inferred to be equal to 0. The value of pps_cr_qp_offset+slice_cr_qp_offset shall be in the range of −12 to +12, inclusive.

slice_joint_cher_qp_offset specifies a difference to be added to the value of pps joint cher_qp offset value when determining the value of the Qp′ Ccr. The value of slice joint cher op_offset shall be in the range of −12 to +12, inclusive. When slice joint cher qp offset is not present. it is inferred to be equal 10 0. The value of pps joint_cher_qp_offset_value+slice joint cher qp_offset shall be in the range of −12 to +12, inclusive slice_sao_luma_flag equal to 1 specifics that SAO is enabled for the luma component in the current slicc: slice sao luma flag equal to 0 specifies that SAO is disabled for the luma component in the current slice. When slice sao luma flag is not present, it is inferred to be equal to pic sao luma enabled flag, slice_sao_chroma_flag equal to 1 specifies that SAO is enabled for the chroma component in the current slice; slice sao chroma flag equal to 0 specifies that SAO is disabled for the chroma component in the current slice. When slice sao chroma flag is not present, it is inferred to be equal to pic sao chroma enabled flag.

slice_alf_enabled_flag equal to 1 specifies that adaptive loop filter is enabled and may be applied to Y, Cb, or Cr colour component in a slice. slice alf enabled flag equal to 0 specifies that adaptive loop filter is disabled for all colour components in a slice. When not present, the value of slice_alf_enabled_flag is inferred to be equal to pic_alf enabled flag.

slice_num_alf_aps_idx_luma specifies the munber of ALF APSs that the slice refers to. When slice_alf_enabled_flag is equal to 1 and slicc_num_alf_aps_ids_luma is not present, the value of slice_num_alf_aps_ids_luma is inferred to be equal to the value of pic_num_alf_aps_ids_luma.

slice_alf_aps_id_luma [i] specifies the adaptation_parameter_set_id of the ith ALF APS that the luma component of the slice refers to. The Temporalld of the APS NAL unit having aps_params type equal to ALF_APS and adaptation parameter set_id equal to slice alf aps_id lumaf i] shall be less than or equal to the TemporalId of the coded slice NAL. unit. When slice_alf enabled flag is equal to 1 and slice alf aps id luma [i] is not present, the value of slice_alf aps_id luma [i] is inferred to be equal to the value of pic alf aps_id_luma [i].

The value of alf_luma_filter_signal_flag of the APS NAL, unit having aps_params_type equal io ALF_APS and adaptation_parameter_set_id equal to slice_alf_aps_id_luma [i] shall be equal to 1.

slice_alf_chroma_ide equal to 0 specifies that the adaptive loop filter is not applied to Cb and Cr colour components. slice alf chroma ide equal to 1 indicates that the adaptive loop filter is applied to the Cb colour component. slice alf chroma_ide equal to 2 indicates that the adaptive loop filter is applied to the Cr colour component. slice_alf chroma ide equal to 3 indicates that the adaptive loop filter is applied to Cb and Cr colour components. When slice alf chroma ide is not present, it is inferred to be equal to pic alf chroma idc.

slice_alf_aps_id_chroma specifies the adaptation parameter set_id of the ALF APS that the chroma component of the slice refers to. The Temporalld of the APS NAL unit having aps_params_type equal to ALF_APS and adaptation parameter_set_id equal to slice_alf_aps_id_chroma shall be less than or equal to the Temporalld of the coded slice NAL unit. When slice_alf_enabled_flag is equal to 1 and slice_alf_aps_id_chroma is not present, the value of slice_alf_aps_id_chroma is inferred to be equal to the value of pic_alf_aps_id_chroma.

The value of alf_chroma_filter_signal_flag of the APS NAL unit having aps_params_type equal to ALF_APS and adaptation_parameter_set_id equal to slice_alf_aps_id_chroma shall be equal to 1.

slice deblocking_filter_override_nag equal to 1 specifies that deblocking parameters are present in the slice header. slice deblocking filter_override flag equal to 0 specifies that deblocking parameters are not present in the slice header. When not present, the value of slice deblocking filter override flag is inferred to be equal to pic_deblocking_filter_override_flag.

slice_deblocking_filter_disabled_flag equal to 1 specifics that the operation of the deblocking filter is not applied for the current slice. slice deblocking_filter disabled flag equal to 0) specifics that the operation of the deblocking filter is applied for the current slice. When slice deblocking filter disabled flag is not present, it is inferred to be equal to pic deblocking filter disabled Dag slice_beta_offset_div2 and slice_to_offset_div2 specify the deblocking parameter offsets for B and tC (divided by 2) for the current slice. The values of slice beta offset div2 and slice to offset div2 shall both be in the range of −6 to 6. inclusive. When not present, the values of slice_beta_offset_div2 and slice_the_offset_div2 are inferred to be equal to pic_beta_offset_div2 and pic_lc_offset_div2, respectively.

When entry point offsets present flag is equal to 1, the variable NumEntryPoints, which specifies the number of entry points in the current slice, is derived as follows:

```
NumEntryPoints = 0
for( i = 1; i < NumCtuInCurrSlice: i++ ) {
  CtbAddrInRs = CtbAddrInCurrSlice[ i ]
  CtbAddrX = ( CtbAddrInRs % PicWidthInCibsY )
  CtbAddrY = ( CtbAddrInRs / PicWidthInCtbsY )
  if( CtbAddrX = = CtbToTileColBd[ CtbAddrX ] &&
    ( CtbAddrY == CtbToTileRowBd[ CtbAddrY ] ||
    entropy_coding_sync_enabled_flag ) )
    NumEntryPoints++
}
```

offset_len_minus1 plus 1 specifies the length, in bits, of the entry point_offset_minus1[i] syntax elements. The value of offset len_minusI shall be in the range of 0 to 31, inclusive.

entry_point_offset_minus1[i] plus 1 specifies the i-th entry point offset in bytes, and is represented by offset len minus] plus 1 bits. The slice data that follow the slice header consists of NumEntryPoints+1 subsets, with subset index values ranging from 0 to NumEntryPoints, inclusive. The first byte of the slice data is considered byte 0. When presem, emulation prevention bytes that appear in the slice data portion of the coded slice NAL unit are counted as part of the slice data for purposes of subset identification. Subset 0 consists of bytes 0 to entry_point_offset_minus1[0], inclusive, of the coded slice data, subset k. with k in the range of 1 to NumEntryPoints−1, inclusive, consists of bytes firstByte [k] to lastByte [k], inclusive, of the coded slice data with firstByte [k] and fastByte [k] defined as:

$$firstByte [ k ] = {\sum }_{n =}^{k} \text{?} ( entry\_point \_offset \_minus 1 [ n - 1 ] + 1 )$$

$$lastByte [ k ] = firstByte [ k ] + entry\_point \_offset \_minus 1 [ k ]$$

$$\text{?} \text{indicates text missing or illegible when filed}$$

The last subset (with subset index equal to NumEntry Points) consists of the remaining bytes of the coded slice data.

When entropy_coding_sync_enabled_flag is equal to 0 and the slice contains one or more complete tiles, each subset shall consist of all coded bits of all CTUs in the slice that are within the same tile, and the number of subsets (i.e., the value of NumEntryPoints+1) shall be equal to the number of tiles in the slice.

When entropy_coding_sync_enabled_flag is equal to 0 and the slice contains a subset of CTU rows from a single tile, the NumEntryPoints shall be 0, and the number of subscts shall be 1. The subset shall consist of all coded bits of all CTUs in the slice. When entropy_coding_sync_enabled_flag is equal to 1, each subset k with k in the range of 0 to NumEntryPoints, inclusive, shall consist of all coded bits of all CTUs in a CTU row within a tile, and the number of subsets (i.e., the value of NumEntryPoints+
1) shall be equal to the total number of tile-specific CTU rows in the slice.

slice_header_extension_length specifies the length of the slice header extension data in bytes, not including the bits used for signalling slice_header_extension_length itself. The value of slice_header_extension_length shall be in the range of 0 to 256, inclusive. When not present, the value of slice_header_extension_length is inferred to be equal to 0.

slice_header_extension_data_byte [i] may have any value. Decoders conforming to this version of this Specification shall ignore the values of all the slice_header_extension_data_byte [i] syntax elements. Its value does not affect decoder conformance to profiles specified in this version of specification.

As provided in Table 2, a NAL unit may include an adaptation parameter set syntax structure. Table 8 illustrates the adaptation parameter set syntax structure provided in JVET-P2001.

TABLE 8

| | Descriptor |
|---|---|
| adaptation_parameter_set_rbsp( ) { | |
| adaptation_parameter_set_id | u(5) |
| aps_params_type | u(3) |
| if( aps_params_type = = ALF_APS ) | |
| alf_data( ) | |
| else if( aps_params_type = = LMCS_APS ) | |
| lmcs_data( ) | |
| else if( aps_params_type = = SCALING_APS ) | |
| scaling_list_data( ) | |
| aps_extension_flag | u(1) |
| if( aps_extension_flag ) | |
| while( more_rbsp_data( ) ) | |
| aps_extension_data_flag | u(1) |
| rbsp_trailing_bits( ) | |
| } | |

With respect to Table 8, JVET-P2001 provides the following semantics: Each APS RBSP shall be available to the decoding process prior to it being referenced, included in at least one AU with Temporalld less than or equal to the Temporalld of the coded slice NAL unit that refers it or provided through external means.

All APS NAL units with a particular value of adaptation_parameter_set_id and a particular value of aps_params_type within a PU, regardless of whether they are prefix or suffix APS NAL units, shall have the same content.

adaptation_parameter_set_id provides an identifier for the APS for reference by other syntax elements. When aps_params_type is equal to ALF_APS or SCALING_APS, the value of adaptation parameter_set_id shall be in the range of 0 to 7, inclusive.

When aps_params_type is equal to LMCS_APS, the value of adaptation_parameter_set_id shall be in the range of 0 to 3, inclusive. aps_params_type specifies the type of APS parameters carried in the APS as specified in Table 9. When aps_params type is equal to 1 (L.MCS_APS), the value of adaptation parameter set_id shall be in the range of 0 to 3, inclusive.

TABLE 9

| | Name of | |
|---|---|---|
| aps_params_type | aps_params_type | Type of APS parameters |
| 0 | ALF_APS | ALF parameters |
| 1 | LMCS_APS | LMCS parameters |
| 2 | SCALING_APS | Scaling list parameters |
| 3 . . . 7 | Reserved | Reserved |

NOTE -
Each type of APSs uses a separate value space for adaptation_parameter_set_id.
NOTE -
An APS NAL unit (with a particular value of adaptation_parameter_set_id and a particular value of aps_params_type) can be shared across pictures, and different slices within a picture can refer to different ALF APSs.
NOTE -
A suffix APS NAL unit associated with a particular VCL NAL unit (this VCL NAL unit precedes the suffix APS NAL unit in decoding order) is not for use by the particular VCL NAL unit, but for use by VCL NAL units following the suffix APS NAL unit in decoding order.

aps_extension_flag equal to 0) specifies that no aps extension data flag syntax elements are present in the APS RBSP syntax structure. aps_extension_flag equal to 1 specifies that there are aps_extension_data_flag syntax elements present in the APS RBSP syntax structure.

aps_extension_data_flag may have any value. Its presence and value do not affect decoder conformance to profiles specified in this version of this Specification. Decoders conforming to this version of this Specification shall ignore all aps_extension_data_flag syntax elements.

As provided above with respect to Table 5, the picture header syntax structure provided in JVET-P2001 includes syntax element pic_Imes_enabled_flag which specifics that luma mapping with chroma scaling (LMCS) is enabled for all slices associated with the PH and includes syntax element pic_Imes_aps_id which specifies the adaptation_parameter_set_id of the LMCS APS that the slices associated with the PH refers to. Thus, according to IVET-P2001, if pic_Imes_enabled_flag is equal to 1, Iuma mapping with chroma scaling is applied for all slices associated with the PH. That is, in JVET-P2001, LMCS cannot be turned on or off on a per slice basis, if LMCS is enabled for the picture. Similarly, the picture header syntax structure provided in JVET-P2001 includes syntax element pic_scaling_list_present_flag which specifies that the scaling list data used for the slices associated with the PH is derived based on the scaling list data contained in the referenced scaling list APS and pic_scaling_list_aps_id specifies the adaptation parameter set_id of the scaling list APS. Thus, according to 1 VET-P2001. if pic_scaling_list_present_flag is equal to 1, a scaling list is applied for all slices associated with the PH. That is, in JVET-P2001, a scaling list cannot be selected on a per slice basis. This may be less than ideal.

As described above, in some cases, a picture may have a single slice. According to the picture header syntax structure and slice header syntax structure provided in JVET-P2001, in cases where a picture has a single slice, syntax elements in the picture header which relate to specifying syntax which may be present at picture header or slice header level are redundant. It is not an ideal design to signal redundant syntax elements at picture header level due to its effect on compression efficiency.

As provided above with respect to Table 3 and Table 5, the SPS syntax structure in JVET-P2001 includes syntax element sps_subpic_id_len_minus1 which specifies the number of bits used to represent the syntax element sps_subpic_id [i] and when subpicture id is signaled in the picture header. the length of the subpicture id syntax element is also signaled in the picture header. That is, the picture header in JVET-P2001 includes syntax element ph_subpic_id_len_minus1 which specifies the number of bits used to represent the syntax element ph_subpic_id[i]. Since the length of the subpicture id syntax element is one of the items that has been identified as a property assumed to be aligned between different encodings of pictures within a sequence, it is inefficient to repeat this length in each picture header:

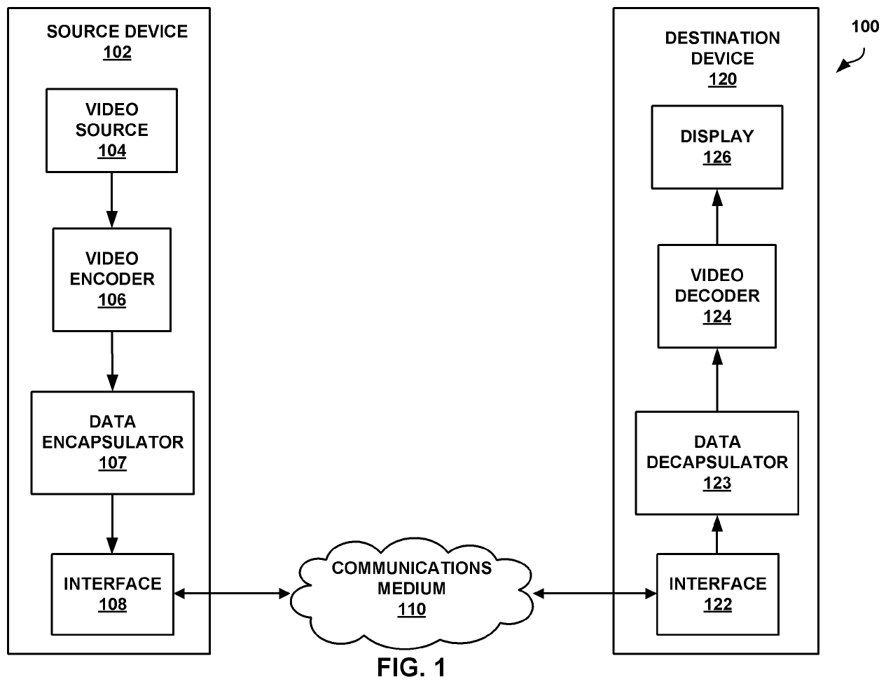

FIG. 1 is a block diagram illustrating an example of a system that may be configured to code (i.e., encode and/or decode) video data according to one or more techniques of this disclosure. System 100 represents an example of a system that may encapsulate video data according to one or more techniques of this disclosure. As illustrated in FIG. 1, system 100 includes source device 102, communications medium 110, and destination device 120. In the example illustrated in FIG. 1, source device 102 may include any device configured to encode video data and transmit encoded video data to communications medium 110. Destination device 120 may include any device configured to receive encoded video data via communications medium 110 and to decode encoded video data. Source device 102 and/or destination device 120 may include computing devices equipped for wired and/or wireless communications and may include, for example, set top boxes, digital video recorders, televisions, desktop, laptop or tablet computers. gaming consoles, medical imagining devices, and mobile devices, including, for example, smartphones, cellular telephones, personal gaming devices.

Communications medium 110 may include any combination of wireless and wired communication media, and/or storage devices. Communications medium 110 may include coaxial cables, fiber optic cables, twisted pair cables, wireless transmitters and receivers, routers, switches, repeaters, base stations, or any other equipment that may be useful to facilitate communications between various devices and sites. Communications medium 110 may include one or more networks. For example, communications medium 110 may include a network configured to enable access to the World Wide Web, for example, the Internet. A network may operate according to a combination of one or more telecommunication protocols. Telecommunications protocols may include proprietary aspects and/or may include standardized telecommunication protocols. Examples of standardized telecommunications protocols include Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, Global System Mobile Communications (GSM) standards, code division multiple access (CDMA) standards, 3rd Generation Partnership Project (3GPP) standards, European Telecommunications Standards Institute (ETSI) standards, Internet Protocol (IP) standards, Wireless Application Protocol (WAP) standards, and Institute of Electrical and Electronics Engineers (IEEE) standards.

Storage devices may include any type of device or storage medium capable of storing data. A storage medium may include a tangible or non-transitory computer-readable media. A computer readable medium may include optical discs, flash memory, magnetic memory, or any other suitable digital storage media. In some examples, a memory device or portions thereof may be described as non-volatile memory and in other examples portions of memory devices may be described as volatile memory.

Examples of volatile memories may include random access memories (RAM), dynamic random access memories (DRAM), and static random access memories (SRAM). Examples of non-volatile memories may include magnetic hard discs, optical discs, floppy discs, flash memories, or forms of electrically programmable memories (EPROM) or electrically erasable and programmable (EEPROM) memories. Storage devicc(s) may include memory cards (e.g., a Secure Digital (SD) memory card), internal/external hard disk drives, and/or internal/external solid state drives. Data may be stored on a storage device according to a defined file format.

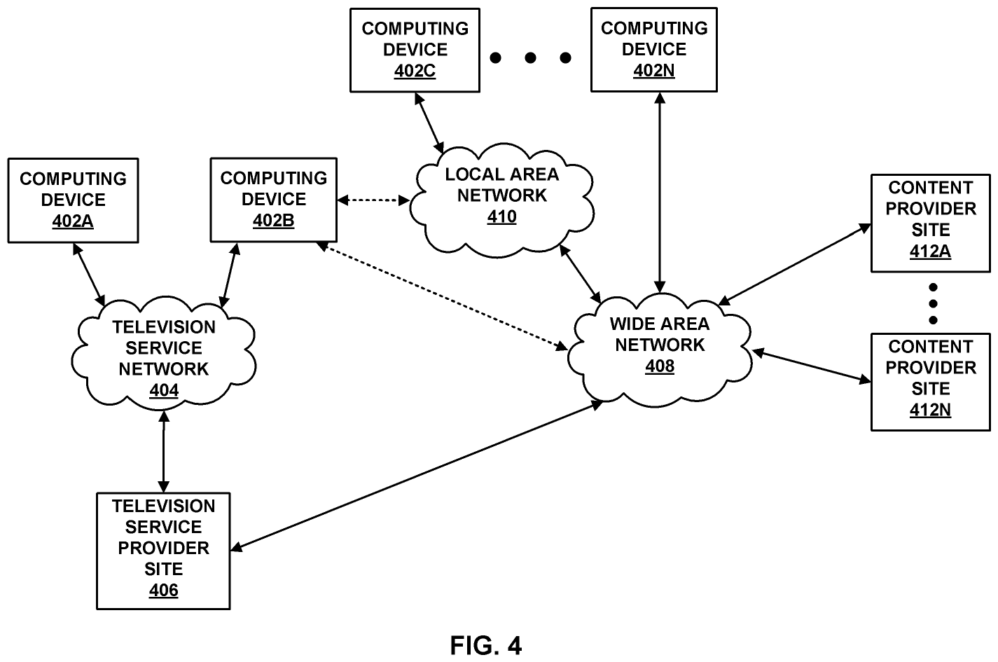

FIG. 4 is a conceptual drawing illustrating an example of components that may be included in an implementation of system 100. In the example implementation illustrated in FIG. 4, system 100 includes one or more computing devices 402A-402N, television service network 404, television service provider site 406, wide area network 408, local area network 410, and one or more content provider sites 412A-412N. The implementation illustrated in FIG. 4 represents an example of a system that may be configured to allow digital media content, such as, for example, a movie, a live sporting event, etc., and data and applications and media presentations associated therewith to be distributed to and accessed by a plurality of computing devices, such as computing devices 402A-402N. In the example illustrated in FIG. 4, computing devices 402A-402N may include any device configured to receive data from one or more of television service network 404, wide area network 408, and/or local area network 410. For example, computing devices 402A-402N may be equipped for wired and/or wireless communications and may be configured to receive services through one or more data channels and may include televisions, including so-called smart televisions, set top boxes, and digital video recorders. Further, computing devices 402A-402N may include desktop, laptop, or tablet computers, gaming consoles, mobile devices, including, for example, “smart” phones, cellular telephoncs, and personal gaming devices.

Television service network 404 is an example of a network configured to enable digital media content, which may include television services, to be distributed. For example, television service network 404 may include public over-the-air television networks, public or subscription-based satellite television service provider networks, and public or subscription-based cable television provider networks and/or over the top or Internet service providers. It should be noted that although in some examples television service network 404 may primarily be used to enable television services to be provided, television service network 404 may also enable other types of data and services to be provided according to any combination of the telecommunication protocols described herein. Further, it should be noted that in some examples, television service network 404 may enable two-way communications between television service provider site 406 and one or more of computing devices 402A-402N.

Television service network 404 may comprise any combination of wireless and/or wired communication media. Television service network. 404 may include coaxial cables, fiber optic cables, twisted pair cables, wireless transmitters and receivers, routers, switches, repeaters, base stations, or any other equipment that may be useful to facilitate communications between various devices and sites. Television service network 404 may operate according to a combination of one or more telecommunication protocols. Telecommunications protocols may include proprietary aspects and/or may include standardized telecommunication protocols. Examples of standardized telecommunications protocols include DVB standards, ATSC standards, ISDB standards, DTMB standards, DMB standards, Data Over Cable Service Interface Specification (DOCSIS) standards, HbbTV standards, W3C standards, and UPnP standards.

Referring again to FIG. 4, television service provider site 406 may be configured to distribute television service via television service network 404. For example, television service provider site 406 may include one or more broadcast stations, a cable television provider, or a satellite television provider, or an Internet-based television provider. For example, television service provider site 406 may be configured to receive a transmission including television programming through a satellite uplink/downlink.

Further, as illustrated in FIG. 4, television service provider site 406 may be in communication with wide area network 408 and may be configured to receive data from content provider sites 412A-412N. It should be noted that in some examples, television service provider site 406 may include a television studio and content may originate therefrom.

Wide area network 408 may include a packet based network and operate according to a combination of one or more telecommunication protocols. Telecommunications protocols may include proprietary aspects and/or may include standardized telecommunication protocols. Examples of standardized telecommunications protocols include Global System Mobile Communications (GSM) standards, code division multiple access (CDMA) standards, 3rd Generation Partnership Project (3GPP) standards, European Telecommunications Standards Institute (ETSI) standards, European standards (EN), IP standards, Wireless Application Protocol (WAP) standards, and Institute of Electrical and Electronics Engineers (IEEE) standards, such as, for example, one or more of the IEEE 802 standards (e.g., Wi-Fi). Wide area network 408 may comprise any combination of wireless and/or wired communication media. Wide area network 408 may include coaxial cables, fiber optic cables, twisted pair cables, Ethernet cables, wireless transmitters and receivers, routers, switches, repeaters, base stations, or any other equipment that may be useful to facilitate communications between various devices and sites. In one example, wide area network 408 may include the Internet. Local area network 410 may include a packet based network and operate according to a combination of one or more telecommunication protocols. Local area network 410 may be distinguished from wide area network 408 based on levels of access and/or physical infrastructure. For example, local area network 410 may include a secure home network.

Referring again to FIG. 4, content provider sites 412A-412N represent examples of sites that may provide multimedia content to television service provider site 406 and/or computing devices 402A-402N. For example, a content provider site may include a studio having one or more studio content servers configured to provide multimedia files and/or streams to television service provider site 406. In one example, content provider sites 412A-412N may be configured to provide multimedia content using the IP suite. For example, a content provider site may be configured to provide multimedia content to a receiver device according to Real Time Streaming Protocol (RTSP), HTTP, or the like. Further, content provider sites 412A-412N may be configured to provide data, including hypertext based content, and the like, to one or more of receiver devices computing devices 402A-402N and/or television service provider site 406 through wide area network 408. Content provider sites 412A-412N may include one or more web servers. Data provided by data provider site 412A-412N may be defined according to data formats.

Referring again to FIG. 1, source device 102 includes video source 104, video encoder 106, data encapsulator 107, and interface 108. Video source 104 may include any device configured to capture and/or store video data. For example, video source 104 may include a video camera and a storage device operably coupled thereto. Video encoder 106 may include any device configured to receive video data and generate a compliant bitstream representing the video data. A compliant bitstream may refer to a bitstream that a video decoder can receive and reproduce video data therefrom.

Aspects of a compliant bitstream may be defined according to a video coding standard.

When generating a compliant bitstream video encoder 106 may compress video data.

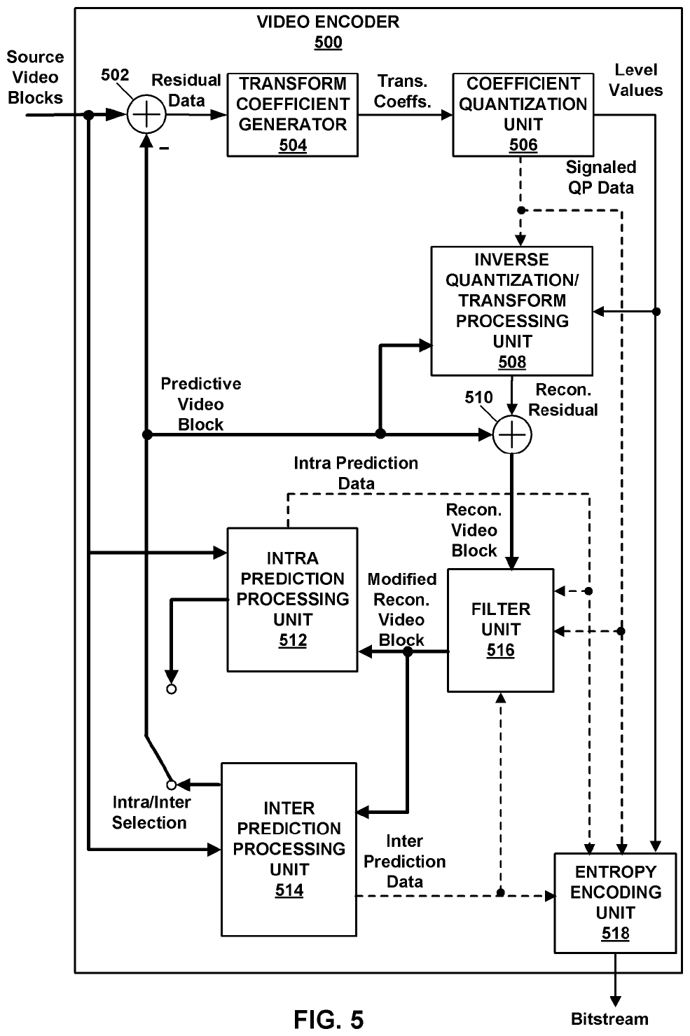

Compression may be lossy (discernible or indiscernible to a viewer) or lossless. FIG. 5 is a block diagram illustrating an example of video encoder 500 that may implement the techniques for encoding video data described herein. It should be noted that although example video encoder 500 is illustrated as having distinct functional blocks, such an illustration is for descriptive purposes and does not limit video encoder 500 and/or sub-components thereof to a particular hardware or software architecture, Functions of video encoder 500 may be realized using any combination of hardware, firmware, and/or software implementations.

Video encoder 500 may perform intra prediction coding and inter prediction coding of picture areas, and, as such, may be referred to as a hybrid video encoder. In the example illustrated in FIG. 5, video encoder 500 receives source video blocks. In some examples, source video blocks may include areas of picture that has been divided according to a coding structure. For example, source video data may include macroblocks, CTUs, CBs, sub-divisions thereof, and/or another equivalent coding unit. In some examples, video eneoder 500 may be configured to perform additional sub-divisions of source video blocks. It should be noted that the techniques described herein are generally applicable to video coding, regardless of how source video data is partitioned prior to and/or during encoding. In the example illustrated in FIG. 5, video encoder 500 includes summer 502, transform coefficient generator 504, coefficient quantization unit 506, inverse quantization and transform coefficient processing unit 508, summer 510, intra prediction processing unit 512, inter prediction processing unit 514, filter unit 516, and entropy encoding unit 518. As illustrated in FIG. 5, video encoder 500 receives source video blocks and outputs a bitstream.

In the example illustrated in FIG. 5, video encoder 500 may generate residual data by subtracting a predictive video block from a source video block. The selection of a predictive video block is described in detail below. Summer 502 represents a component configured to perform this subtraction operation. In one example, the subtraction of video blocks occurs in the pixel domain. Transform coefficient generator 504 applies a transform, such as a discrete cosine transform (DCT), a discrete sine transform (DST), or a conceptually similar transform, to the residual block or sub-divisions thereof (e.g., four 8×8 transforms may be applied to a 16×16 array of residual values) to produce a set of residual transform coefficients. Transform coefficient generator 504 may be configured to perform any and all combinations of the transforms included in the family of discrete trigonometric transforms, including ap-proximations thereof. Transform coefficient generator 504 may output transform cocf-ficients to coefficient quantization unit 506. Coefficient quantization unit 506 may be configured to perform quantization of the transform coefficients. The quantization process may reduce the bit depth associated with some or all of the coefficients. The degree of quantization may alter the rate-distortion (i.e., bit-rate vs. quality of video) of encoded video data. The degree of quantization may be modified by adjusting a quantization parameter (QP). A quantization parameter may be determined based on slice level values and/or CU level values (e.g., CU delta QP values). QP data may include any data used to determine a QP for quantizing a particular set of transform coefficients. As illustrated in FIG. 5, quantized transform coefficients (which may be referred to as level values) are output to inverse quantization and transform coefficient processing unit 508. Inverse quantization and transform coefficient processing unit 508 may be configured to apply an inverse quantization and an inverse transformation to generate reconstructed residual data. As illustrated in FIG. 5, at summer 510, reconstructed residual data may be added to a predictive video block. In this manner, an encoded video block may be reconstructed and the resulting reconstructed video block may be used to evaluate the encoding quality for a given prediction, transformation, and/or quantization. Video encoder 500 may be configured to perform multiple coding passes (e.g., perform encoding while varying one or more of a prediction, transformation parameters, and quantization parameters). The rate-distortion of a bitstream or other system parameters may be optimized based on evaluation of reconstructed video blocks. Further, reconstructed video blocks may be stored and used as reference for predicting subsequent blocks.

Referring again to FIG. 5, intra prediction processing unit 512 may be configured to select an intra prediction mode for a video block to be coded. Intra prediction processing unit 512 may be configured to evaluate a frame and determine an intra prediction mode to use to encode a current block. As described above, possible intra prediction modes may include planar prediction modes, DC prediction modes, and angular prediction modes. Further, it should be noted that in some examples, a prediction mode for a chroma component may be inferred from a prediction mode for a luma prediction mode. Intra prediction processing unit 512 may select an intra prediction mode after performing one or more coding passes. Further, in one example, intra prediction processing unit 512 may select a prediction mode based on a rate-distortion analysis. As illustrated in FIG. 5, intra prediction processing unit 512 outputs intra prediction data (e.g., syntax elements) to entropy encoding unit 518 and transform coefficient generator 504. As described above, a transform performed on residual data may be mode dependent (e.g., a secondary transform matrix may be determined based on a prediction mode).

Referring again to FIG. 5, inter prediction processing unit 514 may be configured to perform inter prediction coding for a current video block. Inter prediction processing unit 514 may be configured to receive source video blocks and calculate a motion vector for PUs of a video block. A motion vector may indicate the displacement of a prediction unit of a video block within a current video frame relative to a predictive block within a reference frame. Inter prediction coding may use one or more reference pictures. Further, motion prediction may be uni-predictive (use one motion vector) or bi-predictive (use two motion vectors). Inter prediction processing unit 514 may be configured to select a predictive block by calculating a pixel difference determined by, for example, sum of absolute difference (SAD), sum of square difference (SSD), or other difference metrics. As described above, a motion vector may be determined and specified according to motion vector prediction. Inter prediction processing unit 514 may be configured to perform motion vector prediction, as described above. Inter prediction processing unit 514 may be configured to generate a predictive block using the motion prediction data. For example, inter prediction processing unit 514 may locate a predictive video block within a frame buffer (not shown in FIG. 5). It should be noted that inter prediction processing unit 514 may further be configured to apply one or more interpolation filters to a reconstructed residual block to calculate sub-integer pixel values for use in motion estimation. Inter prediction processing unit 514 may output motion prediction data for a calculated motion vector to entropy encoding unit 518.

Referring again to FIG. 5, filter unit 516 receives reconstructed video blocks and coding parameters and outputs modified reconstructed video data. Filter unit 516 may be configured to perform deblocking and/or Sample Adaptive Offset (SAO) filtering.

SAO filtering is a non-linear amplitude mapping that may be used to improve recon-struction by adding an offset to reconstructed video data. It should be noted that as illustrated in FIG. 5, intra prediction processing unit 512 and inter prediction processing unit 514 may receive modified reconstructed video block via filter unit 216. Entropy encoding unit 518 receives quantized transform coefficients and predictive syntax data (i.e., intra prediction data and motion prediction data). It should be noted that in some examples, coefficient quantization unit 506 may perform a scan of a matrix including quantized transform coefficients before the coefficients are output to entropy encoding unit 518. In other examples, entropy encoding unit 518 may perform a scan. Entropy encoding unit 518 may be configured to perform entropy encoding according to one or more of the techniques described herein. In this manner, video encoder 500 represents an example of a device configured to generate encoded video data according to one or more techniques of this disclosure.

Referring again to FIG. 1, data encapsulator 107 may receive encoded video data and generate a compliant bitstream, e.g., a sequence of NAL units according to a defined data structure. A device receiving a compliant bitstream can reproduce video data therefrom. Further, as described above, sub-bitstream extraction may refer to a process where a device receiving a ITU-T H.265 compliant bitstream forms a new ITU-T H.265 compliant bitstream by discarding and/or modifying data in the received bitstream. It should be noted that the term conforming bitstream may be used in place of the term compliant bitstream. In one example, data encapsulator 107 may be configured to generate syntax according to one or more techniques described herein. It should be noted that data encapsulator 107 need not necessary be located in the same physical device as video encoder 106. For example, functions described as being performed by video encoder 106 and data encapsulator 107 may be distributed among devices illustrated in FIG. 4.

As described above, the signaling of metadata that describes video coding properties provided in JVET-P2001 is less than ideal. In particular, as described above, in JVET-P2001, LMCS cannot be turned on or off on a per slice basis, if LMCS is enabled for the picture and a scaling list cannot be selected on a per slice basis. In one example, according to the techniques herein, LMCS is allowed to turned on or off on per slice basis if LMCS is enabled for the picture and/or scaling lists may be selected on a per slice basis. That is, in one example, according to the techniques herein, the relevant syntax of a slice header syntax structure used in conjunction with a picture header, e.g., a picture header based on the picture header illustrated in Table 5, may be based on the syntax provided in Table 10.

TABLE 10

| | Descriptor |
|---|---|
| slice_header( ) { | |
| ... | |
| if( deblocking_filter_override_enabled_flag && | |
| !pic_deblocking_filter_override_present_flag ) | |
| slice_deblocking_filter_override_flag | u(1) |
| if( slice_deblocking_filter_override_flag ) { | |
| slice_deblocking_filter_disabled_flag | u(1) |
| if( !slice_deblocking_filter_disabled_flag ) { | |
| slice_beta_offset_div2 | se(v) |
| slice_tc_offset_div2 | se(v) |
| } | |
| } | |
| if( pic_lmcs_enabled_flag ) | |
| slice_lmcs_enabled_flag | u(1) |
| if( pic_scaling_list_present_flag ) | |
| slice_scaling_list_present_flag | u(1) |
| if( entry_point_offsets_present_flag && NumEntryPoints > 0 ) { | |
| offset_len_minus1 | ue(v) |
| for( i = 0; i < NumEntryPoints; i++ ) | |
| entry_point_offset_minus1[ i ] | u(v) |
| } | |
| ... | |
| } | |

With respect to Table 10, the semantics of the syntax elements may be based on the semantics provided above with respec1 to Table 6 with the semantics of syntax elements slice_Imes_enabled_flag and slice_scaling_list_present_flag based on the following:

slice_Imes_enabled_flag equal to l specifies that luma mapping with chroma scaling is enabled for the current slice. slice_Jmucs_enabled_flag equal to 0) specifies that luma mapping with chroma scaling is not enabled for the current slice. When slice_Imcs_enabled_flag is not present, it is inferred to be equal to 0.

slice_scaling list_present_flag equal to 1 specifics that the scaling list data used for the current slice is derived based on the scaling list data contained in the referenced scaling list APS with aps_params_type equal to SCALING_APS and adaptation_parameter_set_id equal to pic_scaling_list_aps_id. slice_scaling_list_present_flag equal to 0 specifies that the scaling list data used for the current picture is the default scaling list data derived as specified. When not present, the value of slice_scaling_list_present_flag is inferred to be equal to 0.

As described above, in JVET-P2001, in cases where a picture has a single slice, syntax elements in the picture header which relate to specifying syntax which may be present at picture header or slice header level are redundant. In one example, according to the techniques herein, a flag may be signaled in the SPS and used in the picture header to control the presence of syntax in the picture header, for example RPL, SAO, ALF, and/or deblocking related syntax. This is useful and provides bit savings when the picture has only one slice. Additionally, in one example, the SPS flag may be used to control the presence of a picture header extension. Signaling such a flag in SPS allows specifying that each picture in the coded video sequence has this property. Al-ternatively, in one example, this flag may instead be signaled in a PPS or a picture header. In one example, according to the techniques herein, the relevant syntax of a sequence parameter sct syntax structure and a picture header syntax may be based on the syntax respectively provided in Table 11 and Table 12.

TABLE 11

| | Descriptor |
|---|---|
| seq_parameter_set_rbsp( ) { | |
| ... | |
| if( ChromaArrayType != 0 ) { | |
| same_qp_table_for_chroma | u(1) |
| for( i = 0; i < same_qp_table_for_chroma ? 1 : 3; i++ ) { | |
| num_points_in_qp_table_minus1[ i ] | ue(v) |
| for( j = 0; j <= num_points_in_qp_table_minus1[ i ]; j++ ) { | |
| delta_qp_in_val_minus1[ i ][ j ] | ue(v) |
| delta_qp_out_val[ i ][ j ] | ue(v) |
| } | |
| } | |
| } | |
| sps_ph_flags_present_flag | u(1) |
| sps_sao_enabled_flag | u(1) |
| sps_alf_enabled_flag | u(1) |
| ... | |
| } | |

TABLE 12

| | Descriptor |
|---|---|
| picture_header_rbsp( ) { | |
| ... | |
| if(sps_ph_flags_present_flag) | |
| pic_rpl_present_flag | u(1) |
| if( pic_rpl_present_flag ) { | |
| for( i = 0; i < 2; i++ ) { | |
| if( num_ref_pic_lists_in_sps[ i ] > 0 && !pps_ref_pic_list_sps_idc[ i ] && | |
| ( i = = 0 \| \| ( i = = 1 && rpl1_idx_present_flag ) ) ) | |
| pic_rpl_sps_flag[ i ] | u(1) |
| if( pic_rpl_sps_flag[ i ] ) { | |
| if( num ref pic lists in sps[ i ] > 1 && | |
| ( i = = 0 \| \| ( i = = 1 && rpl1_idx_present_flag ) ) ) | |
| pic_rpl_idx[ i ] | u(v) |
| } else | |
| ref_pic_list_struct( i, num_ref_pic_lists_in_sps[ i ] ) | |
| for( j = 0; j < NumLtrpEntries[ i ][ RplsIdx[ i ] ]; j++ ) { | |
| if( ltrp_in_slice_header_flag[ i ][ RplsIdx[ i ] ] ) | |
| pic_poc_lsb_lt[ i ][ j ] | u(v) |
| pic_delta_poc_msb_present_flag[ i ][ j ] | u(1) |
| if( pic_delta_poc_msb_present_flag[ i ][ j ] ) | |
| pic_delta_poc_msb_cycle_lt[ i ][ j ] | ue(v) |
| } | |
| } | |
| } | |
| ... | |
| if( sps_sao_enabled_flag ) { | |
| if(sps_ph_flags_present_flag) | |
| pic_sao_enabled_present_flag | u(1) |
| if( pic_sao_enabled_present_flag ) { | |
| pic_sao_luma_enabled_flag | u(1) |
| if(ChromaArrayType != 0 ) | |
| pic_sao_chroma_enabled_flag | u(1) |
| } | |
| } | |
| if( sps_alf_enabled_flag ) { | |
| if(sps_ph_flags_present_flag) | |
| pic_alf_enabled_present_flag | u(1) |
| if( pic_alf_enabled_present_flag ) { | |
| pic_alf_enabled_flag | u(1) |
| if( pic_alf_enabled_flag ) { | |
| pic_num_alf_aps_ids_luma | u(3) |
| for( i = 0; i < pic_num_alf_aps_ids_luma; i++ ) | |
| pic_alf_aps_id_luma[ i ] | u(3) |
| if( ChromaArrayType != 0 ) | |
| pic_alf_chroma_idc | u(2) |
| if( pic_alf_chroma_idc ) | |
| pic_alf_aps_id_chroma | u(3) |
| } | |
| } | |
| } | |
| if ( !pps_dep_quant_enabled_flag ) | |
| pic_dep_quant_enabled_flag | u(1) |
| if( !pic_dep_quant_enabled_flag ) | |
| sign_data_hiding_enabled_flag | u(1) |
| if( deblocking_filter_override_enabled_flag ) { | |
| if(sps_ph_flags_present_flag) | |
| pic_deblocking_filter_override_present_flag | u(1) |
| if( pic_deblocking_filter_override_present_flag ) { | |
| pic_deblocking_filter_override_flag | u(1) |
| if( pic_deblocking_filter_override_flag ) { | |
| pic_deblocking_filter_disabled_flag | u(1) |
| if( !pic_deblocking_filter_disabled_flag ) { | |
| pic_ beta_offset_div2 | se(v) |
| pic_tc_offset_div2 | se(v) |
| } | |
| } | |
| } | |
| } | |
| if( sps_lmcs_enabled_flag ) { | |
| pic_lmcs_enabled_flag | u(1) |
| if( pic_lmcs_enabled_flag ) { | |
| pic_lmcs_aps_id | u(2) |
| if( ChromaArrayType != 0 ) | |
| pic_chroma_residual_scale_flag | u(1) |
| } | |
| } | |
| if( sps_scaling_list_enabled_flag ) { | |
| pic_scaling_list_present_flag | u(1) |
| if( pic_scaling_list_present_flag ) | |
| pic_scaling_list_aps_id | u(3) |
| } | |
| if( picture_header_extension_present_flag && sps_ph_flags_present_flag ) { | |
| ph_extension_length | ue(v) |
| for( i = 0; i < ph_extension_length; i++) | |
| ph_extension_data_byte[ i ] | u(8) |
| } | |
| rbsp_trailing_bits( ) | |
| } | |

With respect to Table 11 and Table 12, the semantics of the syntax elements may be based on the semantics provided above with respect to Table 3 and Table 5 with the semantics of syntax elements sps_ph_flags_present_flag and pic_rpl_present_flag based on the following:

sps_ph_flags_present_flag equal to 1 specifies that flag syntax elements pic_tpl_present_flag. pic_sao_enabled_present_flag, pic alf enabled present_flag, andpic deblocking filter override present flag are present in the picture header and picture header extension may be present in the picture header. sps_alf_enabled_flag equal to 0 specifies that flag syntax elements pic_tpl_present_flag. pic_sao_enabled_present_flag, pic_all_enabled_present_flag, andpic_deblocking_filter_override_present_flag and picture header extension are not present in the picture header.

pic_rpl_present_flag equals 1 specifies that reference picture list signalling is present in the picture header. pic_rol present_flag equals 0 specifies that reference picture list signalling is not present in the picture header and may be present in slice headers of shees of the picture. When not present pic_rpl present_flag is inferred to be equal to 0.

It is a requirement of bitstream conformance that the value of pic_rpl present flag shall be equal to 0 when sps_id_rpl_present_flag is equal to 0 and the picture associated with the picture header is an IDR picture.

It should be noted that in one example, syntax element sps_ph_flags_present_flag is not used to control the presence of picture header extension. In this case, “&& sps_ph_flags_present_flag” is not included in the if (picture_header_extension_present_flag && sps_ph_flags_present_flag) condition and the semantics of syntax element sps_ph_flags_present_flag may be based on the following:
sps_ph_flags_present_flag equal to 1 specifies that flag syntax elements pic_rpl_present_flag. pic_sao_enabled_present_flag, pic_alf_enabled_present_flag, and pic_deblocking_filter_override present_flag are present in the picture header. sps_all′ enabled_flag equal to 0 specifies that flag syntax elements pic rpl present_flag, pic_sao_enabled_present_flag, pic alf enabled_present_flag, and pic deblocking filter override present_flag are not present in the picture header.

It should be noted that in some cases, sps_ph_flags_present_flag may be described as a flag indicating whether a picture includes a single slice. As such, according to the techniques herein. in general, an indication of whether a picture includes a single slice may be used to indicate whether sytnax is included in a picture header or a corresponding slice header. That is, for example, whether it is necessary to indicate in a picture header whether syntax will be present in a slice header may be based on an indication of whether a picture includes a single slice. For example, according to the techniques herein, when a picture includes a single slice, by default. redundant sytnax between a picture header and a corresponding slice header will be included in the slice header and the picture header will not include syntax indicating (i.e., presence indicating sytnax) whether the sytnax which is included in a picture header or a slice header as it is included in the slice header by default. It should be noted that an indication of whether a picture includes a single slice may be based on syntax in a PPS, for example, a flag, or a condition indicated by PPS syntax, e.g., and num_slices_in_pic_minust is equal to 0 or based on no_pic_partition_flag being equal to 1.

In another example a flag may be signaled in SPS, for example sps_ph_flags_present_flag and another flag may be signaled in PPS, for example pps_ph_flags_present_flag Further, the flag in SPS, e.g., sps_ph_flags_present_flag may be used to control the presence of pic_rpl_present_flag, pic_sao_enabled_present_flag. pic_alf_enabled_present_flag, and the flag in PPS. e.g., pps_ph_flags_present_flag may be used to control the presence of pic_deblocking_filter_override_present_flag and used in the condition if (picture_header_extension_present_flag && pps_ph_flags_present_flag) to control the presence of picture header extension.

In one example, according to the techniques herein, picture header extension data may be signaled using the more_rbsp_data( ) function instead of explicitly indicating the length of the extension, e.g., as provided in Table 12. That is, in one example, according to the techniques herein, the relevant syntax of a picture header syntax for signaling picture header extension data may be based on the syntax provided in Table 12A or, in one example, the syntax provided in Table 12B.

TABLE 12A

| | Descriptor |
|---|---|
| picture_header_rbsp( ) { | |
| ... | |
| if( sps_scaling_list_enabled_flag ) { | |
| pic_scaling_list_present_flag | u(1) |
| if( pic_scaling_list_present_flag ) | |
| pic_scaling_list_aps_id | u(3) |
| } | |
| ph_extension_flag | u(1) |
| if( ph_extension_flag ) { | |
| while( more_rbsp_data( ) ) | |
| ph_extension_data_flag | u(1) |
| } | |
| rbsp_trailing_bits( ) | |
| } | |

TABLE 12B

| | Descriptor |
|---|---|
| picture_header_rbsp( ) { | |
| ... | |
| if( sps_scaling_list_enabled_flag ) { | |
| pic_scaling_list_present_flag | u(1) |
| if( pic_scaling_list_present_flag ) | |
| pic_scaling_list_aps_id | u(3) |
| } | |
| if( picture_header_extension_present_flag ) { | |
| ph_extension_flag | u(1) |
| if( ph_extension_flag ) { | |
| while( more_rbsp_data( ) ) | |
| ph_extension_data_flag | u(1) |
| } | |
| rbsp_trailing_bits( ) | |
| } | |

With respect to Tables 12.A-12B, the semantics of the syntax elements may be based on the semantics provided above with the semantics of syntax elements ph_extension_flag and ph_extension_data_flag based on the following:
ph_extension_flag equal to 0 specifies that no ph_extension_data_flag syntax elements are present in the picture header RBSP syntax structure. phs extension flag equal to 1 specifies that there are ph extension data flag syntax elements present in the picutre header RBSP syntax structure.
ph_extension_data_flag may have any value. Its presence and value do not affect decoder conformance to profiles specified in this version of this Specification. Decoders conforming to this version of this Specification shall ignore all ph_extension_data_flag syntax elements.

It should be noted that in the example corresponding to Table 12A syntax element picture_header_extension present_flag may be removed from the PPS and in the example corresponding to Table 12B, syntax element picture_header_extension_present_flag may be included in the PPS so that no flag is required to be sent in the picture header when there is no extension.

As described above, in JVET-P2001 the signaling of syntax element sps_subpic_id_len_minus1 in the SPS and the signaling of syntax element ph_subpic_id_len_minus1 in each picture header is inefficient. In one example, according to the techniques herein, the subpicture ID length is not signaled in a picture header and instead a signaled length from a parameter set is used. That is, in one example. according to the techniques herein, syntax element ph_subpic_id_len_minus1 is not included in the picture header syntax structure and in one example, the semantics of ph_subpic_id [i] may be based on the following:
ph_subpic_id [i] specifics that subpicture Id of the i-th subpicture. The length of the ph_subpic_id [i] syntax element is sps_subpic_id_len_minus1+1 bits.

Where syntax element sps_subpic_id_len_minus1 is conditionally signaled in the SPS based on if (sps_subpics_id_present_flag) and not based on if (sps_subpics_id_signalling_present_flag). That is, syntax element sps_subpic_id_len_minus1 may immediately follow if (sps_subpics_id_present_flag} {.

In one example, the semantics of ph_subpic_id [i] may be based on the following:
ph_subpic_id [i] specifies that subpicture Id of the i-th subpicture. The length of the ph_subpic_id [i] syntax element is pps_or_ph_subpic_id_len_minus1+1 bits.

In this case, in one example, according to the techniques herein, the the relevant syntax of a picture parameter set syntax structure may be based on the syntax provided in Table 13.

TABLE 13

| | Descriptor |
|---|---|
| pic_parameter_set_rbsp( ) { | |
| ... | |
| mixed_nalu_types_in_pic_flag | u(1) |
| pps_or_ph_subpic_id_signalling_present_flag | u(1) |
| if( pps_or_ph_subpics_id_signalling_present_flag ) | |
| pps_or_ph_subpic_id_len_minus1 | ue(v) |
| pps_subpic_id_signalling_present_flag | u(1) |
| if( pps_subpics_id_signalling_present_flag ) { | |
| pps_num_subpics_minus1 | ue(v) |
| for( i = 0; i <= pps_num_subpic_minus1; i++ ) | |
| pps_subpic_id[ i ] | u(v) |
| } | |
| ... | |
| } | |

With respect to Table 13, the semantics of the syntax elements may be based on the semantics provided above with respect to Table 4 with the semantics of syntax elements pps_or_ph_subpic_id_signalling_present_flag and pps_or_ph_subpic_id_len_miausi based on the following:
pps_or_ph_subpic_id_signalling_present_flag equal to 1 specifies that pps_or_ph_subpic_id_len_minus1 is signalled in the PPS. pps_or_ph_subpic_id_signalling_present_flag equal 10 0 specifies that pps_or_ph_subpic_id_len_minus1 is not signalled in the PPS.

It is a requirement of bitstream conformance that when sps_subpic_id_present_flag is 0 or sps_subpic_id_signalling_present_flag is equal to 1, pps_or_ph_subpic_id_signalling_present_flag shall be equal to 0.

pps_or ph_subpic_id_len_minus1 plus 1 specifies the number of bits used to represent the syntax element pps_subpic_id [i] if present and ph subpic_id [i] if present. The value of pps_or ph_subpic_id_len_minus1 shall be in the range of 0 to 15. inclusive.

It is a requirement of bitstream conformance that the value of pps_or_phsubpic_id_len_minus1 shall be the same for all PPSs that are referred to by coded pictures in a CVS.

In one example, according to the techniques herein, one of more of the techniques described above with respect to Tables 10-13 may be combined. For example, I.MCS to be allowed to tumed on or off on per slice basis if LMCS is enabled for the picture and/or scaling lists may be selected on a per slice basis, and/or a flag may be signaled in the SPS and used in the picture header to control the presence of syntax in the picture header and/or syntax element ph_subpic_id_len_minust is not included in the picture header syntax structure.

It should be noted that in JVET-P2001, each coded picture is required to have exactly one picture header. There are benefits to having a slice be a self-contained entity, i.e., not depending on any other NAL unit of the same access unit (assuming parameter sets are already available). For example, this improves error robustness, as a slice can be processed independently, even if a picture header is lost and thus, is not received. In one example, according to the techniques herien, a picture header syntax structure may be repeated in each slice header instead of being sent in a picture header NAL unit. In one example, this may be controlled based on a new flag which indicates if the picture header is included in a slice header.

As provided above with respect to Table 2, a NAL unit may include a PH_NUT. A NAL unit marked as PH_NUT is a picture header NAL unit and it is required that each picture contains exactly one PH_NUT and the PH_NUT needs to precede all VCL NAL units of the picture. In earlier drafts of VVC and earlier standards (i.e., HEVC and AVC) there has not been a picture header, so picture properties, for example, picture properties related to random access have been repeated in all slices of a picture even though the value has been required to be the same in all slices of the picture. In one example, according to the techniques herein, in order to provide a cleaner design, the corresponding picture level information may be provided in the picture header NAL unit instead of repeating it in all slices of the picture. Such a design also improves processing and analysis of Access Units since random access properties can be determined at the picture header NAL unit which precedes all slice NAL units, instead of having to parse information from one of the slice NAL units to make this determination. Thus, according to the techniques herein, in one example, the various slice NAL unit types, for example, those in Table 2, may be changed to picture header NAL unit types and there may be only one NAL unit type for a coded slice. Table 14 illustrates an example of NAL unit types according to the techniques herein where the various slice NAL unit types are changed to picture header NAL unit types and there is only one NAL unit type for a coded slice. It should be noted, according to the techniques herein, when NAL units from two different bitstreams are combined to form a new access unit of a new bitstream, the combined access unit should (i.e., may be required to) use the least restrictive picture header, if the picture header types are different in the two bitstreams. For example, in one example, if the picture header in one bitstream is trailing picture and the picture header in the other bitstream is IDR picture, than the combined bitstream should use a trailing picture picture header in order to allow all slice types and prediction structures.

TABLE 14

| | Name of | Content of NAL unit and RBSP syntax | NAL unit |
|---|---|---|---|
| nal_unit_type | nal_unit_type | structure | type class |
| 0 | SLICE_NUT | Coded slice | VCL |
| | | slice_layer_rbsp( ) | |
| 1 . . . 5 | RSV_VCL_1 . . . | Reserved VCL NAL unit types | VCL |
| | RSV_VCL_5 | | |
| 6 | TRAIL_NUT | Picture Header of a trailing picture | non-VCL |
| | | picture_header_rbsp( ) | |
| 7 | STSA_NUT | Picture Header of an STSA picture | non-VCL |
| | | picture_header_rbsp( ) | |
| 8 | RADL_NUT | Picture Header of a RADL picture | non-VCL |
| | | picture_header_rbsp( ) | |
| 9 | RASL_NUT | Picture Header of a RASL picture | non-VCL |
| | | picture_header_rbsp( ) | |
| 10 | IDR_W_RADL | Picture Header of an IDR picture | non-VCL |
| 11 | IDR_N_LP | slice_layer_rbsp( ) | |
| 12 | CRA_NUT | Picture Header of a CRA picture | non-VCL |
| | | silce_layer_rbsp( ) | |
| 13 | GDR_NUT | Picture Header of a GDR picture | non-VCL |
| | | slice_layer_rbsp( ) | |
| 14 | DPS_NUT | Decoding parameter set | non-VCL |
| | | decoding_parameter_set_rbsp( ) | |
| 15 | VPS_NUT | Video parameter set | non-VCL |
| | | video_parameter_set_rbsp( ) | |
| 16 | SPS_NUT | Sequence parameter set | non-VCL |
| | | seq_parameter_set_rbsp( ) | |
| 17 | PPS_NUT | Picture parameter set | non-VCL |
| | | pic_parameter_set_rbsp( ) | |
| 18 | PREFIX_APS_NUT | Adaptation parameter set | non-VCL |
| 19 | SUFFIX_APS_NUT | adaptation_parameter_set_rbsp( ) | |
| 20 | AUD_NUT | AU delimiter | non-VCL |
| | | access_unit_delimiter_rbsp( ) | |
| 21 | EOS_NUT | End of sequence | non-VCL |
| | | end_of_seq_rbsp( ) | |
| 22 | EOB_NUT | End of bitstream | non-VCL |
| | | end_of_bitstream_rbsp( ) | |
| 23 | PREFIX_SEI_NUT | Supplemental enhancement information | non-VCL |
| 24 | SUFFIX_SEI_NUT | sei_rbsp( ) | |
| 25 | PD_NUT | Filler data | non-VCL |
| | | filler_data_rbsp( ) | |
| 26 | RSV_NVCL_26 | Reserved non-VCL NAL unit types | non-VCL |
| 27 | RSV_NVCL_27 | | |
| 28 . . . 31 | UNSPEC_28 . . . | Unspecified non-VCL NAL unit types | non-VCL |
| | UNSPEC_31 | | |

In another example, according to the techniques herein, the slice type may be moved from the slice header and provided in the NAL unit header instead, using different values of nal_unit_type. Table 15 illustrates an example of NAL unit types according to the techniques herein where the slice type is moved from the slice header and provided in the NAL unit header. It should be noted that one benefit of including slice type information in NAL unit header instead of the slice header is to make it easier for extractors and other network entities to identify regions that are independently decodable. Another benefit of including slice type information in the NAL unit header instead of the slice header is that it is more bit-efficient to use available values of nal_unit_type instead of having a separate syntax element in the slice header which currently consumes between one and three bits depending on the slice type.

TABLE 15

| | Name of | Content of NAL unit and RBSP syntax | NAL unit |
|---|---|---|---|
| nal_unit_type | nal_unit_ type | structure | type class |
| 0 | B_SLICE_NUT | Coded B slice | VCL |
| | | slice_layer_rbsp( ) | |
| 1 | P_SLICE_NUT | Coded P slice | VCL |
| | | slice_layer_rbsp( ) | |
| 2 | I_SLICE_NUT | Coded I slice | VCL |
| | | slice_layer_rbsp( ) | |
| 3 . . . 5 | RSV_VCL_3 . . . | Reserved VCL NAL unit types | VCL |
| | RSV_VCL_5 | | |
| 6 | TRAIL_NUT | Picture Header of a trailing picture | non-VCL |
| | | picture_header_rbsp( ) | |
| 7 | STSA_NUT | Picture Header of an STSA picture | non-VCL |
| | | picture_header_rbsp( ) | |
| 8 | RADL_NUT | Picture Header of a RADL picture | non-VCL |
| | | picture_header_rbsp( ) | |
| 9 | RASL_NUT | Picture Header of a RASL picture | non-VCL |
| | | picture_header_rbsp( ) | |
| 10 | IDR_W_RADL | Picture Header of an IDR picture | non-VCL |
| 11 | IDR_N_LP | | |
| 12 | CRA_NUT | Picture Header of a CRA picture | non-VCL |
| 13 | GDR_NUT | Picture Header of a GDR picture | non-VCL |
| 14 | DPS_NUT | Decoding parameter set | non-VCL |
| | | decoding_parameter_set_rbsp( ) | |
| 15 | VPS_NUT | Video parameter set | non-VCL |
| | | video_parameter_set_rbsp( ) | |
| 16 | SPS_NUT | Sequence parameter set | non-VCL |
| | | seq_parameter_set_rbsp( ) | |
| 17 | PPS_NUT | Picture parameter set | non-VCL |
| | | pic_parameter_set_rbsp( ) | |
| 18 | PREFIX_APS_NUT | Adaptation parameter set | non-VCL |
| 19 | SUFFIX_APS_NUT | adaptation_parameter_set_rbsp( ) | |
| 20 | AUD_NUT | AU delimiter | non-VCL |
| | | access_unit_delimiter_rbsp( ) | |
| 21 | EOS_NUT | End of sequence | non-VCL |
| | | end_of_seq_rbsp( ) | |
| 22 | EOB_NUT | End of bitstream | non-VCL |
| | | end_of_bitstream_rbsp( ) | |
| 23 | PREFIX_SEI_NUT | Supplemental enhancement information | non-VCL |
| 24 | SUFFIX_SEI_NUT | sei_rbsp( ) | |
| 25 | FD_NUT | Filler data | non-VCL |
| | | filler_data_rbsp( ) | |
| 26 | RSV_NVCL_26 | Reserved non-VCL NAL unit types | non-VCL |
| 27 | RSV_NVCL_27 | | |
| 28 . . . 31 | UNSPEC_28 . . . | Unspecified non-VCL NAL unit types | non-VCL |
| | UNSPEC_31 | | |

With respect to Table 15, it should be noted that the syntax element slice_type is removed from slice header( ) the variable SliceType is used to replace all occurrences of slice type, and the following may be added to the semantics of syntax element nal_unit type:

When nal_unit_type is less than or equal to 2, the variable SliceType is derived as follows:

$$SliceType = nal\_unit \_type$$

Further with respect to Table 15, the corresponding relevant picture header syntax may be as provided in Table 16:

TABLE 16

| | Descriptor |
|---|---|
| picture_header_rbsp( ) { | |
| non_reference_picture_flag | u(1) |
| if( nal_unit_type = = IDR_W_RADL \|\| nal_unit_type = = IDR_N_LP \|\| | |
| nal_unit_type = = CRA_NUT \|\| nal_unit_type = = GDR_NUT ) | |
| no_output_of_prior_pics_flag | u(1) |
| if(nal_unit_type = = GDR_NUT ) | |
| recovery_poc_cnt | ue(v) |
| ph_pic_parameter_set_id | ue(v) |
| if( sps_poc_msb_flag ) { | |
| ph_poc_msb_present_flag | u(1) |
| if( ph_poc_msb_present_flag ) | u(v) |
| poc_msb_val | |
| } | |
| if( sps_subpic_id_present_flag && !sps_subpic_id_signalling_flag ) { | |
| ph_subpic_id_signalling_present_flag | u(1) |
| if( ph_subpics_id_signalling_present_flag ) { | |
| ph_subpic_id_len_minus1 | ue(v) |
| for( i = 0; i <= sps_num_subpics_minus1; i++ ) | |
| ph_subpic_id[ i ] | u(v) |
| } | |
| } | |
| if( !sps_loop_filter_across_virtual_boundaries_disabled_present_flag ) { | |
| ph_loop_filter_across_virtual_boundaries_disabled_present_flag | u(1) |
| if( ph_loop_filter_across_virtual_boundaries_disabled_present_flag ) { | |
| ph_num_ver_virtual_boundaries | u(2) |
| for( i = 0; i < ph_num_ver_virtual_boundaries; i++ ) | |
| ph_virtual_boundaries_pos_x[ i ] | u(13) |
| ph_num_hor_virtual_boundaries | u(2) |
| for( i = 0; i < ph_num_hor_virtual_boundaries; i++ ) | |
| ph_virtual_boundaries_pos_y[ i ] | u(13) |
| } | |
| } | |
| if( separate_colour_plane_flag = = 1 ) | |
| colour_plane_id | u(2) |
| if( output_flag_present_flag ) | |
| pic_output_flag | u(1) |
| if( nal_unit_type != IDR_W_RADL && nal_unit_type != IDR_N_LP ) | |
| pic_rpl_present_flag | u(1) |
| if( pic_rpl_present_flag ) { | |
| for( i = 0; i < 2; i++ ) { | |
| if( num_ref_pic_lists_in_sps[ i ] > 0 && !pps_ref_pic_list_sps_idc[ i ] && | |
| ( i = = 0 \|\| ( i = = 1 && rpl1_idx_present_flag ) ) ) | |
| pic_rpl_sps_flag[ i ] | u(1) |
| if( pic_rpl_sps_flag[ i ] ) { | |
| if( num_ref_pic_lists_in_sps[ i ] > 1 && | |
| ( i = = 0 \|\| ( i = = 1 && rpl1_idx_present_flag ) ) ) | |
| pic_rpl_idx[ i ] | u(v) |
| } else | |
| ref_pic_list_struct( i, num_ref_pic_lists_in_sps[ i ] ) | |
| for( j = 0; j < NumLtrpEntries[ i ][ RplsIdx[ i ] ]; j++ ) { | |
| if( ltrp_in_slice_header_flag[ i ][ RplsIdx[ i ] ] ) | |
| pic_poc_lsb_lt[ i ][ j ] | u(v) |
| pic_delta_poc_msb_present_flag[ i ][ j ] | u(1) |
| if( pic_delta_poc_msb_present_flag[ i ][ j ] ) | |
| pic_delta_poc_msb_cycle_lt[ i ][ j ] | ue(v) |
| } | |
| } | |
| } | |
| ... | |
| } | |

With respect to Table 16, the semantics of the syntax elements may be based on the semantics provided above with the semantics of syntax element pic_rpl_present_flag based on the following:
pic_rpl_present_flag equals I specifies that reference picture list signalling is present in the PH. pic_rpl_present_flag equals 0 specifies that reference picture list signalling is not present in the PH and may be present in slice headers of slices of the picture. When pic_rol present_fag is not present, it is inferred to be equal to D.

Further, the following text can be removed from the semantics of nal_unit_type:

For VCL NAL units of any particular picture, the following applies:
If mixed_nalu_types_in_pic_flag is equal to 0, the value of nal_unit_type shall be the same for all coded slice NAL units of a picture. A picture or a PU is referred to as having the same NAL unit type as the coded slice NAL units of the picture or PU.
Otherwise (mixed_nalu_types_in_pic_flag equal to 1). one or more of the VCL NAL units shall all have a particular value of nal_unit_type in the range of HOR_W_RADI, to CRA NUT. inclusive, and the other VCI, NAL units shall all have a particular value of nal_unit_type in the range of TRAIL NUT to RSV_VCL_6, inclusive, or equal to GRA NUT.

Also, the syntax element mixed_nalu_types_in_pic_flag can be removed from the PPS since there is no longer different picture types indicated in the NAL unit headers of the slices and it is therefore always possible to mix NAL units from different bitsurcams (if they otherwise fulfill all requirements needed to enable merging).

In one example, according to the techniques herein, in order to support CRA pictures in mixed Access Units, in addition to making it possible to extract subpictures from a bitstream and decode subpictures as an independent bitstream by appropriate rewriting of parameter sets. the following may apply to slices and PUs: For each slice with a nal_unit_type value nalUnitTypeA in the range of IDR_W_RADL to CRA_NUT, inclusive, in a picture picA that also contains one or more slices with another value of nal_unit_type (i.e., the value of mixed_nalu_types_in_pic_flag for the picture picA is equal to 1), the following applies:
The slice shall belong to a subpicture subpicA. for which the value of the corresponding subpic treated as pic flag[i] is equal to 1.
The slice shall not belong to a subpicture of picA containing VCL NAL units with nal_init_type not equal to nalUnifTypeA.
For all the PUs in the CLVS following the current picture in decoding order and in output order, neither RefPicList [0] nor RefPicList [1] of a slice in subpicA shall include any picture preceding picA in decoding order in an active entry,

In another example, the following may apply to slices and PUs, where there are more strict constraints for IDR pictures, more relaxed constraints are allowed for CRA pictures only:

For each slice with a nal_unit_type value nalUnitTypeA in the range of IDR_W_RADL to CRA_NUT, inclusive, in a picture picA that also contains one or more slices with another value of nal_unit_type (i.e., the value of mixed_nalu_types_in_pic_flag for the picture picA is equal to 1), the following applies:
The slice shall belong to a subpicture subpicA for which the value of the corresponding subpic_treated_as_pic_flag[i] is equal to 1.
The slice shall not belong to a subpicture of picA containing VCL NAL units with nal_unit_type not equal to nalUnitTypeA.
If nalUnitTypeA is equal to CRA
   For all the PUs in the CLVS following the current picture in decoding order and in output order, neither RefPicList [0] nor RefPicList]]] of a slice in subpicA shall include any picture preceding picA in decoding order in an active entry.
Otherwise:
   For all the PUs in the CLVS following the current picture in decoding order, neither RefPicList|0] nor RefPicList[1] of a slice in subpicA shall include any picture preceding picA in decoding order in an active entry.

It should be noted that encoding with a single slice per picture is a common use case and it is highly desirable to be able to support this use case with as little overhead as possible. Specifically, for example, it is desirable to allow support for sending a single NAL unit per picture. According to the NAL unit types provided in Table 2, it is required that at least two NAL units are sent for each picture (i.e., one picture header NAL unit and at least one coded slice NAL unit). In order to more efficiently support the common use case where a single slice is included per picture, in one example, according to the techniques herein, a new NAL unit type for a coded picture may be defined and a coded picture may consists of a picture header, a slice header, and a slice data syntax structure plus a syntax element to indicate the picture type (e.g. IDR, CRA, trailing picture . . . ). This means that a coded picture with only one slice can be signaled in a single NAL unit, which significantly reduces overhead related to start codes (or NAL unit length field), NAL unit header byte, and rbsp_trailing_bits( ) Table 17 illustrates an example of NAL unit types according to the techniques herein where there is a NAL unit type for a coded picture.

TABLE 17

| | Name of | Content of NAL unit and RBSP syntax | NAL unit |
|---|---|---|---|
| nal_unit_type | nal_unit_type | structure | type class |
| 0 | TRAIL_NUT | Coded slice of a trailing picture | VCL |
| | | slice_layer_rbsp( ) | |
| 1 | STSA_NUT | Coded slice of an STSA picture | VCL |
| | | slice_layer_rbsp( ) | |
| 2 | RADL_NUT | Coded slice of a RADL picture | VCL |
| | | slice_layer_rbsp( ) | |
| 3 | RASL_NUT | Coded slice of a RASL picture | VCL |
| | | slice_layer_rbsp( ) | |
| 4 . . . 5 | RSV_VCL_4 . . . | Reserved non-TRAP VCL NAL unit types | VCL |
| | RSV_VCL_5 | | |
| 6 | CODED_PIC | Coded picture | VCL |
| | | picture_layer_rbsp( ) | |
| 7 | TDR_W_RADL | Coded slice of an IDR picture | VCL |
| 8 | IDR_N_LP | slice_layer_rbsp( ) | |
| 9 | CRA_NUT | Coded slice of a CRA picture | VCL |
| | | silce_layer_rbsp( ) | |
| 10 | GDR_NUT | Coded slice of a GDR picture | VCL |
| | | slice_layer_rbsp( ) | |
| 11 | RSV_IRAP_11 | Reserved IRAP VCL NAL unit types | VCL |
| 12 | RSV_IRAP_12 | | |
| 13 | DPS_NUT | Decoding parameter set | non-VCL |
| | | decoding_parameter_set_rbsp( ) | |
| 14 | VPS_NUT | Video parameter set | non-VCL |
| | | video_parameter_set_rbsp( ) | |
| 15 | SPS_NUT | Sequence parameter set | non-VCL |
| | | seq_parameter_set_rbsp( ) | |
| 16 | PPS_NUT | Picture parameter set | non-VCL |
| | | pic_parameter_set_rbsp( ) | |
| 17 | PREFIX_APS_NUT | Adaptation parameter set | non-VCL |
| 18 | SUFFIX_APS_NUT | adaptation_parameter_set_rbsp( ) | |
| 19 | PH_NUT | Picture header | non-VCL |
| | | picture_header_rbsp( ) | |
| 20 | AUD_NUT | AU delimiter | non-VCL |
| | | access_unit_delimiter_rbsp( ) | |
| 21 | EOS_NUT | End of sequence | non-VCL |
| | | end_of_seq_rbsp( ) | |
| 22 | EOB_NUT | End of bitstream | non-VCL |
| | | end_of_bitstream_rbsp( ) | |
| 23 | PREFIX_SEI_NUT | Supplemental enhancement information | non-VCL |
| 24 | SUFFIX_SEI_NUT | sei_rbsp( ) | |
| 25 | FD_NUT | Filler data | non-VCL |
| | | filler_data_rbsp( ) | |
| 26 | RSV_NVCL_26 | Reserved non-VCL NAL unit types | non-VCL |
| 27 | RSV_NVCL_27 | | |
| 28 . . . 31 | UNSPEC_28 . . . | Unspecified non-VCL NAL unit types | non-VCL |
| | UNSPEC_31 | | |

With respect to Table 17. Table 18 illustrates a corresponding picture_layer_rbsp( ) syntax structure, Table 19 illustrates a corresponding relevant portion of picture_header_structure( ) syntax structure, and Table 20 illustrates a corresponding slice_header( ) syntax structure.

TABLE 18

| | Descriptor |
|---|---|
| picture_layer_rbsp( ) { | |
| pic_nal_type | u(5) |
| picture_header_structure( ) | |
| slice_header( ) | |
| slice_data( ) | |
| rbsp_slice_trailing_bits( ) | |
| } | |

TABLE 19

| | Descriptor |
|---|---|
| picture_header_structure( ) { | |
| non_reference_picture_flag | u(1) |
| gdr_pic_flag | u(1) |
| no_output_of_prior_pics_flag | u(1) |
| if( gdr_pic_flag ) | |
| recovery_poc_cnt | ue(v) |
| ... | |
| if( picture_header_extension present_flag ) { | |
| ph_extension_length | ue(v) |
| for( i = 0; i < ph_extension_length; i++) | |
| ph_extension_data_byte[ i ] | u(8) |
| } | |
| } | |

TABLE 20

| | Descriptor |
|---|---|
| slice_header( ) { | |
| slice_pic_order_cnt_lsb | u(v) |
| if( subpics_present_flag ) | |
| slice_subpic_id | u(v) |
| if( rect_slice_flag \|\| NumTilesInPic > 1 ) | |
| slice_address | u(v) |
| if( !rect_slice_flag && NumTilesInPic > 1 ) | |
| num_tiles_in_slice_minus1 | ue(v) |
| slice_type | ue(v) |
| if( !pic_rpl_present_flag &&( ( NalType != IDR_W_RADL && NalType!= | |
| IDR_N_LP ) \|\| sps_idr_rpl_present_flag ) ) { | |
| for( i = 0; i < 2; i++ ) { | |
| if( num_ref_pic_lists_in_sps[ i ] > 0 && !pps_ref_pic_list_sps_idc[ i ] && | |
| ( i = = 0 \|\| ( i = = 1 && rpl1_idx_present_flag ) ) ) | |
| slice_rpl_sps_flag[ i ] | u(1) |
| if( slice_rpl_sps_flag[ i ] ) { | |
| if( num_ref_pic_lists_in_sps[ i ] > 1 && | |
| ( i = = 0 \|\| ( i = = 1 && rpl1_idx_present_flag ) ) ) | |
| slice_rpl_idx[ i ] | u(v) |
| } else | |
| ref_pic_list_struct( i. num_ref_pic_lists_in_sps[ i ] ) | |
| for( j = 0; j < NumLtrpEntries[ i ][ RplsIdx[ i ] ]; j++ ) { | |
| if( ltrp_in_slice_header_flag[ i ][ RplsIdx[ i ] ] ) | |
| slice_poc_lsb_lt[ i ][ j ] | u(v) |
| slice_delta_poc_msb_present_flag[ i ][ j ] | u(1) |
| if( slice_delta_poc_msb_present_flag[ i ][ j ] ) | |
| slice_delta_poc_msb_cycle_lt[ i ][ j ] | ue(v) |
| } | |
| } | |
| } | |
| if( pic_rpl_present_flag \|\| ( ( NalType!= IDR_W_RADL && NalType!= | |
| IDR_N_LP ) \|\| sps_idr_rpl_present_flag ) ) { | |
| if( ( slice_type != 1 && num_ref_entries[ 0 ][ RplsIdx[ 0 ] ] > 1 ) \|\| | |
| ( slice_type = = B && num_ref_entries[ 1 ][ RplsIdx[ 1 ] ] > 1 ) ) { | |
| num_ref_idx_active_override_flag | u(1) |
| if( num_ref_idx_active_override_flag ) | |
| for( i = 0; i < ( slice_type = = B ? 2: 1 ); i++ ) | |
| if( num_ref_entries[ i ][ RplsIdx[ i ] ] > 1 ) | |
| num_ref_idx_active_minus1[ i ] | ue(v) |
| } | |
| } | |
| if( slice_type != I ) { | |
| if( cabac_init_present_flag ) | |
| cabac_init_flag | u(1) |
| if( pic_temporal_mvp_enabled_flag ) { | |
| if( slice_type = = B && !pps_collocated_from_l0_idc ) | |
| collocated_from_l0_flag | u(1) |
| if( ( collocated_from_l0_flap && NumRefIdxActive[ 0 ] > 1 ) \|\| | |
| ( !collocated_from_l0_flag && NumRefIdxActive[ 1 ] > 1 ) ) | |
| collocated_ref_idx | ue(v) |
| } | |
| if( ( pps_weighted_pred_flag && slice_type = = P ) \|\| | |
| ( pps_weighted_bipred_flag && slice_type = = B ) ) | |
| pred_weight_table( ) | |
| } | |
| slice_qp_delta | se(v) |
| if( pps_slice_chroma_qp_offsets_present_flag ) { | |
| slice_cb_qp_offset | se(v) |
| slice_cr_qp_offset | se(v) |
| if( sps_joint_cbcr_enabled_flag ) | |
| slice_joint_cbcr_qp_offset | se(v) |
| } | |
| if( pps_cu_chroma_qp_offset_list_enabled_flag ) | |
| cu_chroma_qp_offset_enabled_flag | u(1) |
| if( sps_sao_enabled_flag && !pic_sao_enabled_present_flag ) { | |
| slice_sao_luma_flag | u(1) |
| if( ChromaArrayType != 0 ) | |
| slice_sao_chroma_flag | u(1) |
| } | |
| if( sps_alf_enabled_flag && !pic_alf_enabled_present_flag ) { | |
| slice_alf_enabled_flag | u(1) |
| if( slice_alf_enabled_flag ) { | |
| slice_num_alf_aps_ids_luma | u(3) |
| for( i = 0; i < slice_num_alf_aps_ids_luma; i++ ) | |
| slice_alf_aps_id_luma[ i ] | u(3) |
| if( ChromaArrayType != 0 ) | |
| slice_alf_chroma_idc | u(2) |
| if( slice_alf_chroma_idc ) | |
| slice_alf_aps_id_chroma | u(3) |
| } | |
| } | |
| if( deblocking_filter_override_enabled_flag && | |
| !pic_deblocking_filter_override_present_flag ) | |
| slice_deblocking_filter_override_flag | u(1) |
| if( slice_deblocking_filter_override_flag ) { | |
| slice_deblocking_filter_disabled_flag | u(1) |
| if( !slice_deblocking_filter_disabled_flag ) { | |
| slice_beta_offset_div2 | se(v) |
| slice_tc_offset_div2 | se(v) |
| } | |
| } | |
| if( entry_point_offsets_present_flag && NumEntryPoints > 0 ) { | |
| offset_len_minus1 | ue(v) |
| for( i = 0; i < NumEntryPoints; i++ ) | |
| entry_point_offset_minus1[ i ] | u(v) |
| } | |
| if( slice_header_extension_present_flag ) { | |
| slice_header_extension_length | ue(v) |
| for( i = 0; i < slice_header_extension_length, i++) | |
| slice_header_extension_data_byte[ i ] | u(8) |
| } | |
| byte_alignment( ) | |
| } | |

With respect to Tables 18-20, the semantics may be based on the semantics provided above, with the semantics of syntax element pic_nal_type based on the following:
pic_nal_type indicates the corresponding Nal Unit type of the picture.

The value of NalType is derived as follows:

$$NalType = ( nal\_unit \_type == CODED\_PIC ) ? pic\_nal \_type : nal\_unit \_type$$

In another example, Table 21 illustrates a corresponding relevant portion of picture_header_structure( ) syntax Structure.

TABLE 21

| | Descriptor |
|---|---|
| picture_header_structure( ) { | |
| non_reference_picture_flag | u(1) |
| if( NalType = = PH_NUT ) | |
| gdr_pic_flag | u(1) |
| if( NalType = = PH_NUT \|\| NalType = = IDR_W_RADL | |
| \|\| NalType = = IDR_N_LP | |
| \|\| NalType = = CRA_NUT \|\| NalType = = | |
| GDR_NUT ) | |
| no_output_of_prior_pics_flag | u(1) |
| if( gdr_pic_flag ) | |
| recovery_poc_cnt | ue(v) |
| ... | |
| if( picture_header_extension_present_flag ) { | |
| ph_extension_length | ue(v) |
| for( i = 0; i < ph_extension_length; i++) | |
| ph_extension_data_byte[ i ] | u(8) |
| } | |
| } | |

With respect to Table 21, the variable NalType is also used for more efficient signaling of the picture header With respect to Table 21, the semantics may be based on the semantics provided above, with the semantics of syntax element gdr_pic_flag based on the following:

gur_pic_flag equal to 1 specifies the picture associated with the PH is a GDR picture. gdr_pic_flag equal to 0 specifies that the picture associated with the PH is not a GDR picture. When not present, the value of gdr_pic_flag is inferred to be equal to (NalType==GDR_NUT?1:0).

It should be noted that in JVET-P2001, it is possible to signal ALF parameters and SAO parunciers in a PH or in a slice header, but not in both places for the same picture. It is asserted that it is sufficient to indicate at the PPS level whether to use signaling in picture header or in slice header. This provides bit savings since it will not be required to send information at each picture regarding where this information will be present. Table 22 illustrates a corresponding relevant portion of pic_parameter_set_rbsp( ) syntax structure, Table 23 illustrates a corresponding relevant portion of a picture_header_rbsp( ) syntax structure, and Table 24 illustrates a corresponding relevant portion of a slice_header( ) syntax structure where a PPS indicates whether to use signaling in picture header or in slice header for ALF parameters and SAO parameters.

TABLE 22

| | Descriptor |
|---|---|
| pic_parameter_set_rbsp( ) { | |
| ... | |
| pps_sao_enabled_present_in_pic_header_flag | u(1) |
| pps_alf_enabled_present_in_pic_header_flag | u(1) |
| ... | |
| } | |

TABLE 23

| | Descriptor |
|---|---|
| picture_header_rbsp( ) { | |
| .. | |
| if( sps_sao_enabled_flag && | |
| pps_sao_enabled_present_in_pic_header_flag) { | |
| pic_sao_luma_enabled_flag | u(1) |
| if(ChromaArrayType != 0 ) | |
| pic_sao_chroma_enabled_flag | u(1) |
| } | |
| if( sps_alf_enabled_flag && | |
| pps_alf_enabled_present_in_pic_header_flag) { | |
| pic_alf_enabled_flag | u(1) |
| if( pic_alf_enabled_flag ) { | |
| pic_num_alf_aps_ids_luma | u(3) |
| for( i = 0; i < pic_num_alf_aps_ids_luma; i++ ) | |
| pic_alf_aps_id_luma[ i ] | u(3) |
| if( ChromaArrayType != 0 ) | |
| pic_alf_chroma_idc | u(2) |
| if( pic_alf_chroma_idc ) | |
| pic_alf_aps_id_chroma | u(3) |
| } | |
| } | |
| ... | |
| } | |

TABLE 24

| | Descriptor |
|---|---|
| slice_header( ) { | |
| ... | |
| if( sps_sao_enabled_flag && | |
| !pps_sao_enabled_present_in_pic_header_flag ) { | |
| slice_sao_luma_flag | u(1) |
| if( ChromaArrayType != 0 ) | |
| slice_sao_chroma_flag | u(1) |
| } | |
| if( sps_alf_enabled_flag && | |
| !pps_alf_enabled_present_in_pic_header_flag ) { | |
| slice_alf_enabled_flag | u(1) |
| if( slice_alf_enabled_flag ) { | |
| slice_num_alf_aps_ids_luma | u(3) |
| for( i = 0; i < slice_num_alf_aps_ids_luma; i++ ) | |
| slice_alf_aps_id_luma[ i ] | u(3) |
| if( ChromaArrayType != 0 ) | |
| slice_alf_chroma_idc | u(2) |
| if( slice_alf_chroma_idc ) | |
| slice_all_aps_id_chroma | u(3) |
| } | |
| } | |
| ... | |
| } | |

With respect to Tables 22-24, the semantics of the syntax elements may be based on the semantics provided above with the semantics syntax of elements pps_san_enabled_present_in_pic_header_flag and pps_alf_enabled_present_in_pic_header_flag based on the following
pps_sao_enabled_present_in_pic_header_flag equal to 1 specifies that SAO related syntax elements may be present in picture header and are not present in the slice header. pps_sao_enabled_present_in_pic_header_flag equal to 0 specifies that SAO related syntax elements may be present in slice header and are not present in the picture header.
pps_alf_enabled_present_in_pic_header_flag equal to 1 specifies that ALF related syntax elements may be present in picture header and are not present in the slice header. pps_all_enabled_present_in_pic_header_flag equal to 0 specifies that ALF related syntax elements may be present in slice header and are not present in the picture header.

In one example, according to the techniques herein, an SPS level flag may be used to indicate if virtual boundaries are enabled (i.e., allowed) in the coded video sequence. When virtual boundaries are not enabled, there is no need to signal information related to virtual boundaries in the SPS or in the picture header. This provides bit savings when virtual boundaries are not used and makes it easy to detect if virtual boundaries are used or not. Table 25 illustrates a corresponding relevant portion of a seq_parameter_set_rbsp( ) syntax structure and Table 26 illustrates a corresponding relevant portion of a picture_header_rbsp( ) syntax structure where an SPS level flag is used to indicate if virtual boundaries are enabled in the coded video sequence.

TABLE 25

| | Descriptor |
|---|---|
| seq_parameter_set_rbsp( ) { | |
| .. | |
| sps_virtual_boundaries_enabled_flag | u(1) |
| if( sps_virtual_boundaries_enabled_flag ) { | |
| sps_loop_filter_across_virtual_boundaries_disabled_present_flag | u(1) |
| if( sps_loop_filter_across_virtual_boundaries_disabled_present_flag ) { | |
| sps_num_ver_virtual_boundaries | u(2) |
| for( i = 0; i < sps_num_ver_virtual_boundaries; i++ ) | |
| sps_virtual_boundaries_pos_x[ i ] | u(13) |
| sps_num_hor_virtual_boundaries | u(2) |
| for( i = 0; i < sps_num_hor_virtual_boundaries; i++ ) | |
| sps_virtual_boundaries_pos_y[ i ] | u(13) |
| } | |
| } | |
| ... | |
| } | |

TABLE 26

| | Descriptor |
|---|---|
| picture_header_rbsp( ) { | |
| ... | |
| if( sps_virtual_boundaries_enabled_flag && | |
| !sps_loop_filter_across_virtual_boundaries_disabled_present_flag ) { | |
| ph_loop_filter_across_virtual_boundaries_disabled_present_flag | u(1) |
| if( ph_loop_filter_across_virtual_boundaries_disabled_present_flag ) { | |
| ph_num_ver_virtual_boundaries | u(2) |
| for( i = 0; i < ph_num_ver_virtual_boundaries; i++ ) | |
| ph_virtual_boundaries_pos_x[ i ] | u(13) |
| ph_num_hor_virtual_boundaries | u(2) |
| for( i = 0; i < ph_num_hor_virtual_boundaries; i++ ) | |
| ph_virtual_boundaries_pos_y[ i ] | u(13) |
| } | |
| } | |
| ... | |
| } | |

With respect to Tables 25-26, the semantics of the syntax elements may be based on the semantics provided above with the semantics of syntax element sps_virtual_boundaries_enabled_flag based on the following:
sps_virtual_boundaries_enabled_flag equal to 1 specifies that virutal boundaries may be used and that syntax related to virtual boundaries is present in the SPS and may be present in picture headers referring to the SPS. sps_virtual_boundaries_enabled_flag equal to 0 specifies that vitutal boundaries are not used and that syntax related to virtual boundaries is not present in the SPS and not present in picture headers referring to the SPS.

It should be noted that in JVET-P2001, it is possible to signal reference-picture list (RPL) parameters in a PH or in a slice header (but not in both places for the same picture). It is asserted that it is sufficient to indicate at the PPS level whether to use signaling in picture header or in slice header for RPL parameters. This provides bit savings since it will not be required to send information at each picture regarding where this information will be present. Table 27 illustrates a corresponding relevant portion of a pic_parameter_set_rbsp( ) syntax structure, Table 28 illustrates a corresponding relevant portion of a picture_header_rbsp( ) syntax structure, and Table 29 illustrates a corresponding relevant portion of a slice_header( ) syntax structure, where a PPS level flag is use to indicate whether to use signaling in picture header or in slice header for RPL parameters.

TABLE 27

| | Descriptor |
|---|---|
| pic parameter sct rbsp( ) { | |
| ... | |
| pps_rpl_enabled_present_in_pic_header_flag | u(1) |
| ... | |
| } | |

TABLE 28

| | Descriptor |
|---|---|
| picture_header_rbsp( ) { | |
| ... | |
| if( pps_rpl_enabled_present_in_pic_header_flag) { | |
| for( i = 0; i < 2; i+− ) { | |
| if( num_ref_pic_lists_in_sps[ i ] > 0 && !pps_ref_pic_list_sps_idc[ i ] && | |
| ( i = = 0 \|\| ( i = = 1 && rpl1_idx_present_flag ) ) ) | |
| pic_rpl_sps_flag[ i ] | u(1) |
| if( pic_rpl_sps_flag[ i ] ) { | |
| if( num_ref_pic_lists_in_sps[ i ] > 1 && | |
| ( i − − 0 \|\| ( i − − 1 && rpl1_idx_present_flag ) ) ) | |
| pic_rpl_idx[ i ] | u(v) |
| } else | |
| ref_pic_list_struct( i, num_ref_pic_lists_in_sps[ i ] ) | |
| for( j = 0; j < NumLtrpEntries[ i ][ RplsIdx[ i ] ]; j++ ) { | |
| if( ltrp_in_slice_header_flag[ i ][ RplsIdx[ i ] ] ) | |
| pic_poc_lsb_lt[ i ][ j ] | u(v) |
| pic_delta_poc_msb_present_flag[ i ][ j ] | u(1) |
| if( pic_delta_poc_msb_present_flag[ i ][ j ] ) | |
| pic_delta_poc_msb_cycle_lt[ i ][ j ] | ue(v) |
| } | |
| } | |
| } | |
| ... | |
| } | |

TABLE 29

| | Descriptor |
|---|---|
| slice_header( ) { | |
| ... | |
| if( !pps_rpl_enabled_present_in_pic_header_flag && | |
| ( ( nal_unit_type != IDR_W_RADL && nal_unit_type != | |
| IDR_N_LP ) \|\| sps_idr_rpl_present_flag ) ) { | |
| for( i = 0; i < 2; i++ ) { | |
| if( num_ref_pic_lists_in_sps[ i ] > 0 && !pps_ref_pic_list_sps_idc[ i ] && | |
| ( i = = 0 \|\| ( i = = 1 && rpl1_idx_present_flag ) ) ) | |
| slice_rpl_sps_flag[ i ] | u(1) |
| if( slice_rpl_sps_flag[ i ] ) { | |
| if( num_ref_pic_lists_in_sps[ i ] > 1 && | |
| ( i = = 0 \|\| ( i = = 1 && rpl1_idx_present_flag ) ) ) | |
| slice_rpl_idx[ i ] | u(v) |
| } else | |
| ref_pic_list_struct( i, num_ref_pic_lists_in_sps[ i ] ) | |
| for( j = 0; j < NumLtrpEntries[ i ][ RplsIdx[ i ] ]; j++ ) { | |
| if( ltrp_in_slice_header_flag[ i ][ RplsIdx[ i ] ] ) | |
| slice_poc_lsb_lt[ i ][ j ] | u(v) |
| slice_delta_poc_msb_present_flag[ i ][ j ] | u(1) |
| if( slice_delta_poc_msb_present_flag[ i ][ j ] ) | |
| slice_delta_poc_msb_cycle_lt[ i ][ j ] | ue(v) |
| } | |
| } | |
| } | |
| if( pps_rpl_enabled_present_in_pic_header_flag \|\| ( ( nal_unit_type != IDR_W_RADL | |
| && nal_unit_type != | |
| IDR_N_LP ) \|\| sps_idr_rpl_present_flag ) ) { | |
| if( ( slice_type != I && num_ref_entries[ 0 ][ RplsIdx[ 0 ] ] > 1 ) \|\| | |
| ( slice_type = = B && num_ref_entries[ 1 ][ RplsIdx[ 1 ] ] > 1 ) ) { | |
| num_ref_idx_active_override_flag | u(1) |
| if( num_ref_idx_active_override_flag ) | |
| for( i = 0; i < ( slice_type = = B ? 2: 1 ); i++ ) | |
| if( num_ref_entries[ i ][ RplsIdx[ i ] ] > 1 ) | |
| num_ref_idx_active_minus1[ i ] | ue(v) |
| } | |
| } | |
| ... | |
| } | |

With respect to Tables 27-29, the semantics of the syntax elements may be based on the semantics provided above with the semantics of syntax element pps_rpl_enabled_present_in_pic_header_flag based on the following:
pps_rpl_enabled_present_in_pic_header_flag equal to 1 specifies that reference picture list related syntax elements (pic_rpl_sps_flag[i]. pic_rpl_idx[i]. pic_poc_Isb_It [i] [i], pic_delta_poc_msb_present_flag [a] [i]. pic_delta poc_msb_cycle Itfillil) may be present in picture header and corresponding reference picture list related syntax elements (slice_rpl_sps_flag[i], slice_rpl_idx[i], slice_poc_Isb_Ithilljj. slice_delta_poc_msb_present_flaglaJlil. slice delta poc insb_cycle_lifillit) are not present in the slice header. pps rpl enabled present in pic_header flag equal to 0 specifics that reference picture list related syntax elements (slice_rpl_sps_flag[i], slice_rpl_idx[i]. slice_poc_lsb_It [i] [i], slice_delta poc_msb_present_flag[i] [i], slice_delta_poc_msb_cycle_Itfilfj]) may be present in slice header and corresponding reference picture list related syntax elements (pic_rpl sps_flag[i]. pic_rpl_idx[i]. pic poc Isb ltfillit, pic della poc msb present Daglillil, pic delta poc msb cycle Itfillit) are not present in the pichire header.

In another example. Table 30 illustrates a corresponding relevant portion of a picture_header_rbsp( ) syntax structure where a PPS level flag is used to signal in picture header or in slice header for RPL parameters.

TABLE 30

| | Descriptor |
|---|---|
| picture_header_rbsp( ) { | |
| ... | |
| if( pps_rpl_enabled_present_in_pic_header_flag ) | |
| pic_rpl_present_flag | u(1) |
| if( pic_rpl_present_flag ) { | |
| for( i = 0; i < 2; i++ ) { | |
| if( num_ref_pic_lists_in_sps[ i ] > 0 && !pps_ref_pic_list_sps_idc[ i ] && | |
| ( i = = 0 \|\| ( i = = 1 && rpl1_idx_present_flag ) ) ) | |
| pic_rpl_sps_flag[ i ] | u(1) |
| if( pic_rpl_sps_flag[ i ] ) { | |
| if( num_ref_pic_lists_in_sps[ i ] > 1 && | |
| ( i = = 0 \|\| ( i = = 1 && rpl1_idx_present_flag ) ) ) | |
| pic_rpl_idx[ i ] | u(v) |
| } else | |
| ref_pic_list_struct( i, num_ref_pic_lists_in_sps[ i ] ) | |
| for( j = 0; j < NumLtrpEntries[ i ][ RplsIdx[ i ] ]; j++ ) { | |
| if( ltrp_in_slice_header_flag[ i ][ RplsIdx[ i ] ] ) | |
| pic_poc_lsb_lt[ i ][ j ] | u(v) |
| pic_delta_poc_msb_present_flag[ i ][ j ] | u(1) |
| if( pic_delta_poc_msb_present_flag[ i ][ j ] ) | |
| pic_delta_poc_msb_cycle_lt[ i ][ j ] | ue(v) |
| } | |
| } | |
| } | |
| ... | |
| } | |

It should be noted that in JVET-P2001, the indication of whether TMVP is used is provided in the picture header, but the information related to which reference picture to use for predicting motion vectors, the collocated picture, is provided in the slice headers, even though it is required to be the same collocated picture in all slice headers. In one example, according to the techniques herein, when RPL information is provided in a picture header, the collocated picture information is indicated in the picture header. Table 31 illustrates a corresponding relevant portion of a picture_header_rbsp( ) syntax structure and Table 32 illustrates a corresponding relevant portion of a slice_header( ) syntax structure where a PPS level flag is used to signal in picture header or in slice header for RPL parameters.

TABLE 31

| | Descriptor |
|---|---|
| picture_header_rbsp( ) { | |
| ... | |
| if( sps_temporal_mvp_enabled_flag ) { | |
| pic_temporal_mvp_enabled_flag | u(1) |
| if( pic_temporal_mvp_enabled_flag && pic_rpl_present_flag) { | |
| if( rpl1_idx_present_flag && !pps_collocated_from_l0_idc ) | |
| pic_collocated_from_l0_flag | u(1) |
| if( ( collocated_from_l0_flag && num_ref_entries[ 0 ][ PicRplsIdx[ 0 ] ] > 1 ) \| | |
| ( !collocated_from_l0_flag && num_ref_entries[ 1 ][ PicRplsIdx[ 1 ] ] [ 1 ] > 1 ) ) | |
| pic_collocated_ref_idx | ue(v) |
| } | |
| } | |
| ... | |
| } | |

TABLE 32

| | Descriptor |
|---|---|
| slice_header( ) { | |
| ... | |
| if( slice_type != I ) { | |
| if( cabac_init_present_flag ) | |
| cabac_init_flag | u(1) |
| if( !pic_rpl_present_flag && pic_temporal_mvp_enabled_flag ) { | |
| if( slice_type = = B && !pps_collocated_from_l0_idc ) | |
| slice_collocated_from_l0_flag | u(1) |
| if( ( collocated_from_l0_flag && NumRefIdxActive[ 0 ] > 1 ) \|\| | |
| ( !collocated_from_l0_flag && NumRefIdxActive[ 1 ] > 1 ) ) | |
| slice_collocated_ref_idx | ue(v) |
| } | |
| if( ( pps_weighted_pred_flag && slice_type = = P ) \|\| | |
| ( pps_weighted_bipred_flag && slice_type = = B ) ) | |
| pred_weight_table( ) | |
| } | |
| . . | |
| } | |

With respect to Table 31, the semantics of the syntax elements may be based on the semantics provided above with the semantics of syntax elements pic_collocated_from_10_flag and pic_collocated_ref_idx based on the following:

pic_collocated_from_10_flag equal to 1 specifics that the collocated picture used for temporal motion vector prediction is derived from reference picture list 0. pic_collocated_from_10_flag equal to 0 specifies that the collocated picture used for temporal motion vector prediction is derived from reference picture list 1.

When pic_collocated_from_10_flag is not present, the following applies:
If rpll_idx present flap is equal to 0, the value of pic collocated from 10_flag is inferred to be equal to 1.
Otherwise (pl_idx_present_is equal to 1). the value of pic_collocated_from_10_flag is inferred to be equal to pps_collocated_from_10_idc-1.
pic_collocated_ref_idx specifies the reference index of the collocated picture used for temporal motion vector prediction.
When pic_collocated_from_10_flag is equal to 1, pic_collocated_ref_idx refers to a picture in list 0, and the value of pic collocated ref idx shall be in the range of 0) to num_ref entries [0] PickpisIdx| 0}]-1, inclusive.

When pic collocated from_10_flag is equal to 0, collocated_ref_idx refers to a picture in list 1, and the value of pic_collocated_ref_idx shall be in the range of 0 to num_ref entries [1] ] Pickplsidx [1]]-1, inclusive.

When pic_collocated_ref_idx is not present, the value of pic_collocated_ref_idx is inferred to be equal to 0.

With respect to Table 32. the semantics of the syntax elements may be based on the semantics provided above with the semantics of syntax clemenis slice_collocated_from_10_flag and slice_collocated_ref_idx based on the following:
slice_collocated_from_10_flag equal to 1 specifies that the collocated picture used for temporal motion vector prediction is derived from reference picture list 0. slice_collocated_from_10)_flag equal to 0 specifies that the collocated picture used for temporal motion vector prediction is derived from reference picture list 1.
When slice_collocated_from_10_flag is not present, the following applies:
   If pic_rpl present_flag is equal to 1, slice_collocated_from_10_flag is inferred to be equal to pic_collocated_from_10_flag.
   Otherwise, if slice_type is not equal to B, the value of slice_collocated_from_10_flag is inferred to be equal to 1.
   Otherwise, the value of slice_collocated_from_10_flag is inferred to be equal to pps_collocated_from_10_ide−1.
slice_collocated_ref_idx specifies the reference index of the collocated picture used for temporal motion vector prediction.
When slice_type is equal to P or when slice_type is equal to B and slice_collocated_from_10_flag is equal to 1, slice_collocated_ref_idx refers to a picture in list 0, and the value of slice_collocated_ref_idx shall be in the range of 0 to NumRefldxActive {0}-1, inclusive.
When slice type is equal to B and slice_collocated_from_10_flag is equal to 0, slice_collocated_ref_idx refers to a picture in list 1, and the value of slice collocated_ref idx shall be in the range of 0 to NumRefldx Active [1]-1, inclusive.

When slicc_collocated_ref_idx is not present the following applies:
If pic_rpl_present_flag is equal to 1, slice_collocated_ref_idx is inferred to be equal to pic_collocated_ref_idx.
Otherwise, if, the value of slice_collocated_ref_idx is inferred to be equal to 0.

It is a requirement of bitstream conformance that the picture referred to by slice_collocated_ref_idx shall be the same for all slices of a coded picture.

It is a requirement of bitstream conformance that the resolutions of the reference picture referred to by slice_collocated_ref_idx and the current picture shall be the same and RefPicIsScaled [slice_collocated_from_10_flag?

0:1] [slice_collocated_ref_idx] shall be equal to 0.

It should be noted that in JVET-P2001, the signalling of partition constraints override in the picture header includes different parameters for intra slices and inter slices, and parameters for both intra slices and inter slices are present when partition_constraints_override_flag is equal to 1. It is very common to encode pictures using either only intra slices or only inter slices. One example is when a picture is encoded with a single slice. Another example is an IRAP picture which is required to only consist of intra slices. In one example, according to the techniques herein, two different flags may be used for indicating partitioning override: partition_constraints_override_intra_slice_flag which applies to intra slices and partition_constraints_override_inter_slice_flag which applies to inter slices. Table 33 illustrates a corresponding relevant portion of a picture_header_rbsp( ) syntax structure where two different flags are used for indicating partitioning override.

TABLE 33

| | Descriptor |
|---|---|
| picture_header_rbsp( ) { | |
| ... | |
| if( partition_constraints_override_enabled_flag ) { | |
| partition_constraints_override_intra_slice_flag | u(1) |
| if( partition_constraints_override_intra_slice_flag ) { | |
| pic_log2_diff_min_qt_min_cb_intra_slice_luma | ue(v) |
| pic_max_mtt_hierarchy_depth_intra_slice_luma | ue(v) |
| if( pic_max_mtt_hierarchy_depth_intra_slice_luma != 0 ) { | |
| pic_log2_diff_max_bt_min_qt_intra_slice_luma | ue(v) |
| pic_log2_diff_max_tt_min_qt_intra_slice_luma | ue(v) |
| } | |
| if( qtbtt_dual_tree_intra_flag ) { | |
| pic_log2_diff_min_qt_min_cb_intra_slice_chroma | ue(v) |
| pic_max_mtt_hierarchy_depth_intra_slice_chroma | ue(v) |
| if( pic_max_mtt_hierarchy_depth_intra_slice_chroma !− 0 ) { | |
| pic_log2_diff_max_bt_min_qt_intra_slice_chroma | ue(v) |
| pic_log2_diff_max_tt_min_qt_intra_slice_chroma | ue(v) |
| } | |
| } | |
| } | |
| partition_constraints_override_inter_slice_flag | u(1) |
| if( partition_constraints_override_inter_slice_flag ) { | |
| pic_log2_diff_min_qt_min_cb_inter_slice | ue(v) |
| pic_max_mtt_hierarchy_depth_inter_slice | ue(v) |
| if( pic_max_mtt_hierarchy_depth_inter_slice != 0 ) { | |
| pic_log2_diff_max_bt_min_qt_inter_slice | ue(v) |
| pic_log2_diff_max_tt_min_qt_inter_slice | ue(v) |
| } | |
| } | |
| } | |
| ... | |
| } | |

With respect to Table 33, the semantics of the syntax elements may be based on the semantics provided above with the semantics and of syntax elements partition_constraints_override_intra_slice_flag partition_constraints_override_inter_slice_flag based on the following:
partition_constraints_override_intra_slice_flag equal to 1 specifies that partition constraint parameters for intra slices are present in the PH. partition_constraints_override_intra_slice_flag equal to 0 specifics that partition constraint parameters for intra slices are not present in the PH. When not present, the value of partition_constraints_override_intra_slice_flag is inferred to be equal to 0.
partition_constraints_override_inter_slice_flag equal to 1 specifies that partition constraint parameters for inter slices are present in the PH. partition_constraints_override_inter_slice_flag equal to 0 specifics that partition constraint parameters for inter slices are not present in the PH. When not present, the value of partition_constraints_override_inter_slice_flag is inferred to be equal to 0.

In another example, the syntax in Table 33 can be combined with the syntax in Table 18-20 and the NalUnitType variable can be used to make partition_constraints_override_inter_slice_flag conditionally present, so that it is not signalled in pictures that are not allowed to contain inter slices. Table 34 illustrates a corresponding relevant portion of a picture_header_rbsp( ) syntax structure.

TABLE 34

| | Descriptor |
|---|---|
| picture_header_rbsp( ) { | |
| ... | |
| if( partition_constraints_override_enabled_flag ) { | |
| partition_constraints_override_intra_slice_flag | u(1) |
| if( partition_constraints_override_intra_slice_flag ) { | |
| pic_log2_diff_min_qt_min_cb_intra_slice_luma | ue(v) |
| pic_max_mtt_hierarchy_depth_intra_slice_luma | ue(v) |
| if( pic_max_mtt_hierarchy_depth_intra_slice_luma != 0 ) { | |
| pic_log2_diff_max_bt_min_qt_intra_slice_luma | ue(v) |
| pic_log2_diff_max_tt_min_qt_intra_slice_luma | ue(v) |
| } | |
| if( qtbtt_dual_tree_intra flag ) { | |
| pic_log2_diff_min_qt_min_cb_intra_slice_chroma | ue(v) |
| pic_max_mtt_hierarchy_depth_intra_slice_chroma | ue(v) |
| if( pic_max_mtt_hierarchy_depth_intra_slice_chroma != 0 ) { | |
| pic_log2_diff_max_bt_min_qt_intra_slice_chroma | ue(v) |
| pic_log2_diff_max_tt_min_qt_intra_slice_chroma | ue(v) |
| } | |
| } | |
| } | |
| if( NalType = = PH_NUT \|\| NalType = = TRAIL_NUT \| | |
| NalType = = STSA_NUT \|\| NalType = = RADL_NUT | |
| \|\| NalType = = RASL_NUT \|\| NalType = = GDR_NUT) | |
| partition_constraints_override_inter_slice_flag | u(1) |
| if( partition_constraints_override_inter_slice_flag ) { | |
| pic_log2_diff_min_qt_min_cb_inter_slice | ue(v) |
| pic_max_mtt_hierarchy_depth_inter_slice | ue(v) |
| if( pic_max_mtt_hierarchy_depth_inter_slice != 0 ) { | |
| pic_log2_diff_max_bt_min_qt_inter_slice | ue(v) |
| pic_log2_diff_max_tt_min_qt_inter_slice | ue(v) |
| } | |
| } | |
| } | |
| ... | |
| } | |

With respect to Table 34, the semantics of the syntax elements may be based on the semantics provided above.

It should be noted that in JVET-P2001, the signalling of qp delta and chroma qp offset in the picture header includes different parameters for intra slices and inter slices, and parameters for both intra slices and inter slices are present when cu_qp_delta_enabled_flag and pps_cu_chroma qp_offset list_enabled_flag is equal to 1, respectively. It is very common to encode pictures using either only intra slices or only inter slices. One example is when a picture is encoded with a single slice. Another example is an IRAP picture which is required to only consist of intra slices. These two occurrences together with the partition constraint override flag constitute three parts of the picture header in which it would be beneficial to know if the picture includes only intra slices, only intra slices or both intra slices and inter slices. In one example, according to the techniques herein, two flags for indicating if intra slices and inter slices may be present in the picture are included in a picture header. Table 35 illustrates a corresponding relevant portion of a picture_header_rbsp( ) syntax structure where two different flags are used for indicating if intra slices and inter slices may be present in the picture.

TABLE 35

| | Descriptor |
|---|---|
| picture_header_rbsp( ) { | |
| ... | |
| if( partition_constraints_override_enabled_flag \|\| cu_qp_delta_enabled_flag \|\| | |
| pps_cu_chroma_qp_offset_list_enabled_flag ) { | |
| no_intra_parameters_flag | u(1) |
| if( !no_intra_parameters_flag) | |
| no_inter_parameters_flag | u(1) |
| } | |
| if( partition_constraints_override_enabled_flag ) { | |
| if( !no_intra_parameters_flag ) { | |
| partition_constraints_override_intra_slice_flag | u(1) |
| if( partition_constraints_override_intra_slice_flag ) { | |
| pic_log2_diff_min_qt_min_cb_intra_slice_luma | ue(v) |
| pic_max_mtt_hierarchy_depth_intra_slice luma | ue(v) |
| if( pic_max_mtt_hierarchy_depth_intra_slice_luma != 0 ) { | |
| pic_log2_diff_max_bt_min_qt_intra_slice_luma | ue(v) |
| pic_log2_diff_max_tt_min_qt_intra_slice_luma | ue(v) |
| } | |
| if( qtbtt_dual_tree_intra_flag ) { | |
| pic_log2_diff_min_qt_min_cb_intra_slice_chroma | ue(v) |
| pic_max_mtt_hierarchy_depth_intra_slice_chroma | ue(v) |
| if( pic_max_mtt_hierarchy_depth_intra_slice_chroma != 0 ) { | |
| pic_log2_diff_max_bt_min_qt_intra_slice_chroma | ue(v) |
| pic_log2_diff_max_tt_min_qt_intra_slice_chroma | ue(v) |
| } | |
| } | |
| } | |
| if( !no_inter_parameters_flag ) | |
| partition_constraints_override_inter_slice_flag | u(1) |
| if( partition_constraints_override_inter_slice_flag ) { | |
| pic_log2_diff_min_qt_min_cb_inter_slice | ue(v) |
| pic_max_mtt_hierarchy_depth_inter_slice | ue(v) |
| if( pic_max_mtt_hierarchy_depth_inter_slice != 0 ) { | |
| pic_log2_diff_max_bt_min_qt_inter_slice | ue(v) |
| pic_log2_diff_max_tt_min_qt_inter_slice | ue(v) |
| } | |
| } | |
| } | |
| if( cu_qp_delta_enabled_flag ) { | |
| if( !no_intra_parameters_flag ) | |
| pic_cu_qp_delta_subdiv_intra_slice | ue(v) |
| if( !no_inlet_parameters_flag ) | |
| pic_cu_qp_delta_subdiv_inter_slice | ue(v) |
| } | |
| if( pps_cu_chroma_qp_offset_list_enabled_flag ) { | |
| if( !no_intra_parameters_flag ) | |
| pic_cu_chroma_qp_offset_subdiv_intra_slice | ue(v) |
| if( !no_inter_parameters_flag ) | |
| pic_cu_chroma_qp_offset_subdiv_inter_slice | ue(v) |
| } | |
| ... | |
| } | |

With respect to Table 35. the semantics of the syntax elements may be based on the semantics provided above with the semantics of syntax elements no_intra_parameters_flag and no_inter_parameters_flag based on the following:
no_intra_parameters_flag equal to 1 specifics that no parameters for partition constraints override. cu qp delta, and chroma qp offset for intra slices are not present in the PH. no_intra_parameters_flag equal to 0 specifies that parameters for partition constraints override, cu qp delta, and chroma qp offset for intra slices may be present in the PH.
no_inter_parameters_flag equal to 1 specifies that no parameters fot partition constraints override, cu qp delta, and chroma qp offset for inter slices are not present in the PH. no_inter_parameters_flag equal to 0 specifies that parameters for partition constraints override, cu qp delta, and chroma qp offset for inter slices may be present in the PH. When not present, the value of no_inter parameters_flag is inferred to be equal to 0.

In another example, no_intra_parameters_flag and no_inter_parameters_flag may be signalled unconditionally inside the if condition (i.e. not being conditioned on each other), as provided below.

| | |
|---|---|
| if( partition_constraints_override_enabled_flag \|\| cu_qp_delta_enabled_flag \|\| | |
| pps_cu_chroma_qp_offset_list_enabled_flag ) { | |
| no_intra_parameters_flag | u(1) |
| no_inter_parameters_flag | u(1) |
| } | |

In another example the order of no_intra parameters_flag and no_inter_parameters_flag may be swapped as follows:

| | |
|---|---|
| if( partition_constraints_override_enabled_flag \|\| cu_qp_delta_enabled_flag \|\| | |
| pps_cu_chroma_qp_offset_list_enabled_flag ) { | |
| no_inter_parameters_flag | u(1) |
| if( !no_inter_parameters_flag) | |
| no_intra_parameters_flag | u(1) |
| } | |

In this case when not present, the value of no_intra_parameters_flag is inferred to be equal to 0.

In another example, the syntax elements may be instead represented with their inverse. Table 36 illustrates a corresponding relevant portion of a picture_header_rbsp( ) syntax structure.

TABLE 36

| | Descriptor |
|---|---|
| picture_header_rbsp( ) { | |
| ... | |
| if( partition_constraints_override_enabled_flag \|\| cu_qp_delta_enabled_flag \|\| | |
| pps_cu_chroma_qp_offset_list_enabled_flag ) { | |
| intra_parameters_flag | u(1) |
| if( intra_parameters_flag) | |
| inter_parameters_flag | u(1) |
| } | |
| if( partition_constraints_override_enabled_flag ) { | |
| if( intra_parameters_flag ) { | |
| partition_constraints_override_intra_slice_flag | u(1) |
| if( partition_constraints_override_intra_slice_flag ) { | |
| pic_log2_diff_min_qt_min_cb_intra_slice_luma | ue(v) |
| pic_max_mtt_hierarchy_depth_intra_slice_luma | ue(v) |
| if( pic_max_mtt_hierarchy_depth_intra_slice_luma != 0 ) { | |
| pic_log2_diff_max_bt_min_qt_intra_slice_luma | ue(v) |
| pic_log2_diff_max_tt_min_qt_intra_slice_luma | ue(v) |
| } | |
| if( qtbtt_dual_tree_intra_flag ) { | |
| pic_log2_diff_min_qt_min_cb_intra_slice_chroma | ue(v) |
| pic_max_mit_hierarchy_depth_intra_slice_chroma | ue(v) |
| if( pic_max_mtt_hierarchy_depth_intra_slice_chroma != 0) { | |
| pic_log2_diff_max_bt_min_qt_intra_slice_chroma | ue(v) |
| pic_log2_diff_max_tt_min_qt_intra_slice_chroma | ue(v) |
| } | |
| } | |
| } | |
| if( inter_parameters_flag ) | |
| partition_constraints_override_inter_slice_flag | u(1) |
| if( partition_constraints_override_inter_slice_flag ) { | |
| pic_log2_diff_min_qt_min_cb_inter_slice | ue(v) |
| pic_max_mtt_hierarchy_depth_inter_slice | ue(v) |
| if( pic_max_mtt_hierarchy_depth_inter_slice != 0 ) { | |
| pic_log2_diff_max_bt_min_qt_inter_slice | ue(v) |
| pic_log2_diff_max_tt_min_qt_inter_slice | ue(v) |
| } | |
| } | |
| } | |
| if( cu_qp_delta_enabled_flag ) { | |
| if( intra_parameters_flag ) | |
| pic_cu_qp_delta_subdiv_intra_slice | ue(v) |
| if( inter_parameters_flag ) | |
| pic_cu_qp_delta_subdiv_inter_slice | ue(v) |
| } | |
| if( pps_cu_chroma_qp_offset_list_enabled_flag ) { | |
| if( intra_parameters_flag ) | |
| pic_cu_chroma_qp_offset_subdiv_intra_slice | ue(v) |
| if( inter_parameters_flag ) | |
| pic_cu_chroma_qp_offset_subdiv_inter_slice | ue(v) |
| } | |
| ... | |
| } | |

With respect to Table 36, the semantics of the syntax elements may be based on the semantics provided above with the semantics of syntax elements intra_parameters_flag and inter_parameters_flag based on the following:
intra_parameters_flag equal to 1 specifies that parameters for partition constraints override, cu qp della, and chroma qp offset for intra slices may be present in the PH. intra parameters_flag equal to 0) specifies that parameters for partition constraints override, cu qp della, and chroma qp offset for intra slices are not present in the PH.
inter_parameters_flag equal to 1 specifics that no parameters for partition constraints override, cu qp delta, and chroma qp offset for inter slices may be present in the PH. inter parameters_flag equal to 0 specifies that parameters for partition constraints override, cu qp delta, and chroma qp offset for inter slices are not present in the PH. When not present, the value of inter parameters_flag is inferred to be equal to 1.

In another example, intra_parameters_flag and inter_parameters_fag may be swapped. as provided below. In this case when not present. the value of intra_parameters_flag is inferred to be equal to 1.

| | |
|---|---|
| if( partition_constraints_override_enabled_flag \|\| cu_qp_delta_enabled_flag \|\| | |
| pps_cu_chroma_qp_offset_list_enabled_flag ) { | |
| inter_parameters_flag | u(1) |
| if( inter_parameters_flag) | |
| intra_parameters_flag | u(1) |
| } | |

Iu another example, intra_parameters_flag and inter_parameters_flag may be signaled unconditionally, inside the if condition (i.e. not being conditioned on each other) as provided below.

| | |
|---|---|
| if( partition_constraints_override_enabled_flag \|\| cu_qp_delta_enabled_flag \|\| | |
| pps_cu_chroma_qp_offset_list_enabled_flag ) { | |
| intra_parameters_flag | u(1) |
| inter_parameters_flag | u(1) |
| } | |

In another example, the syntax in Table 36 can be combined with the syntax in Table 18-20 and the inter parameters flag may only be present in pictures that can contain inter slices. Table 37 illustrates a corresponding relevant portion of a picture_header_rbsp( ) syntax structure.

TABLE 37

| | Descriptor |
|---|---|
| picture_header_rbsp( ) { | |
| ... | |
| if( partition_constraints_override_enabled_flag \|\| cu_qp_delta_enabled_flag \|\| | |
| pps_cu_chroma_qp_offset_list_enabled_flag ) { | |
| if( NalType - - PH_NUT \|\| NalType - - TRAIL_NUT \|\| | |
| NalType = = STSA_NUT NalType = = RADL_NUT | |
| \|\| NalType = = RASL_NUT \|\| NalType = = GDR_NUT) | |
| inter_parameters_flag | u(1) |
| if( inter_parameters_flag) | |
| intra_parameters_flag | u(1) |
| } | |
| if( partition_constraints_override_enabled_flag ) { | |
| if( intra_parameters_flag ) { | |
| partition_constraints_override_intra_slice_flag | u(1) |
| if( partition_constraints_override_intra_slice_flag ) { | |
| pic_log2_diff_min_qt_min_cb_intra_slice luma | ue(v) |
| pic_max_mtt_hierarchy_depth_intra_slice_luma | ue(v) |
| if( pic_max_mtt_hierarchy_depth_intra_slice_luma != 0 ) { | |
| pic_log2_diff_max_bt_min_qt_intra_slice_luma | ue(v) |
| pic_log2_diff_max_tt_min_qt_intra_slice_luma | ue(v) |
| } | |
| if( qtbtt_dual_tree_intra_flag ) { | |
| pic_log2_diff_min_qt_min_cb_intra_slice_chroma | ue(v) |
| pic_max_mtt_hierarchy_depth_intra_slice_chroma | ue(v) |
| if( pic_max_mtt_hierarchy_depth_intra_slice_chroma != 0 ) { | |
| pic_log2_diff_max_bt_min_qt_intra_slice_chroma | ue(v) |
| pic_log2_diff_max_tt_min_qt_intra_slice_chroma | ue(v) |
| } | |
| } | |
| } | |
| if( inter_parameters_flag ) | |
| partition_constraints_override_inter_slice_flag | u(1) |
| if( partition_constraints_override_inter_slice_flag ) { | |
| pic_log2_diff_min_qt_min_cb_inter_slice | ue(v) |
| pic_max_mtt_hierarchy_depth_inter_slice | ue(v) |
| if( pic_max_mtt_hierarchy_depth_inter_slice != 0 ) { | |
| pic_log2_diff_max_bt_min_qt_inter_slice | ue(v) |
| pic_log2_diff_max_tt_min_qt_inter_slice | ue(v) |
| } | |
| } | |
| } | |
| if( cu_qp_delta_enabled_flag ) { | |
| if( intra parameters flag ) | |
| pic_cu_qp_delta_subdiv_intra_slice | ue(v) |
| if( inter_parameters_flag ) | |
| pic_cu_qp_delta_subdiv_inter_slice | ue(v) |
| } | |
| if( pps_cu_chroma_qp_offset_list_enabled_flag ) { | |
| if( intra_parameters_flag ) | |
| pic_cu_chroma_qp_offset_subdiv_intra_slice | ue(v) |
| if( inter_parameters_flag ) | |
| pic_cu_chroma_qp_offset_subdiv_inter_slice | ue(v) |
| } | |
| ... | |
| } | |

With respect to Table 37, the semantics of the syntax elements may be based on the semantics provided above with the semantics of syntax elements intra_parameters_flag and inter_parameters_flag based on the following:
inter_parameters_flag equal to 1 specifies that no parameters fot partition constraints override, cu qp delta, and chroma qp offset for inter slices may be present in the PH. inter_parameters_flag equal to 0 specifies that parameters for partition constraints override, cu qp delta, and chroma qp offset for inter slices are not present in the PHI. When not present. the value of inter_parameters_flag is inferred to be equal to 0.
intra_parameters_flag equal to 1 specifies that parameters for partition constraints override, cu qp delta, and chroma qp offset for intra slices may be present in the PH. intra parameters flag equal to 0 specifies that parameters for partition constraints override, cu qp delta, and chroma qp offset for intra slices are not present in the PH. When not present, the value of intra_parameters_flag is inferred to be equal to 1.

In this manner, source device 102 represents an example of a device configured to signal an indication whether a coded picture includes exactly one slice, and when the indication indicates that the coded picture includes exactly one slice, signal one or more syntax elements in a slice header and not signal presence indicators in a picture header for redundant syntax elements in the picture header corresponding to the one or more syntax elements in the slice header.

Referring again to FIG. 1, interface 108 may include any device configured to receive data generated by data encapsulator 107 and transmit and/or store the data to a communications medium. Interface 108 may include a network interface card, such as an Ethernet card, and may include an optical transceiver, a radio frequency transceiver, or any other type of device that can send and/or receive information. Further, interface 108 may include a computer system interface that may enable a file to be stored on a storage device. For example, interface 108 may include a chipset supporting Peripheral Component Interconnect (PCI) and Peripheral Component Interconnect Express (PCIe) bus protocols, proprietary bus protocols, Universal Serial Bus (USB) protocols, I²C, or any other logical and physical structure that may be used to interconnect peer devices.

Referring again to FIG. 1, destination device 120 includes interface 122, data decapsulator 123, video decoder 124, and display 126. Interface 122 may include any device configured to receive data from a communications medium. Interface 122 may include a network interface card, such as an Ethernet card, and may include an optical transceiver, a radio frequency transceiver, or any other type of device that can receive and/or send information. Further, interface 122 may include a computer system interface enabling a compliant video bitstream to be retrieved from a storage device. For example, interface 122 may include a chipset supporting PCI and PCIe bus protocols, proprietary bus protocols, USB protocols, FC, or any other logical and physical structure that may be used to interconnect peer devices. Data decapsulator 123 may be configured to receive and parse any of the example syntax structures described herein.

Video decoder 124 may include any device configured to receive a bitstream (e.g., a sub-bitstream extraction) and/or acceptable variations thereof and reproduce video data therefrom. Display 126 may include any device configured to display video data. Display 126 may comprise one of a variety of display devices such as a liquid crystal display (LCD), a plasma display, an organic light emitting diode (OLED) display, or another type of display. Display 126 may include a High Definition display or an Ultra High Definition display. It should be noted that although in the example illustrated in FIG. 1, video decoder 124 is described as outputting data to display 126, video decoder 124 may be configured to output video data to various types of devices and/or sub-components thereof. For example, video decoder 124 may be configured to output video data to any communication medium, as described herein.

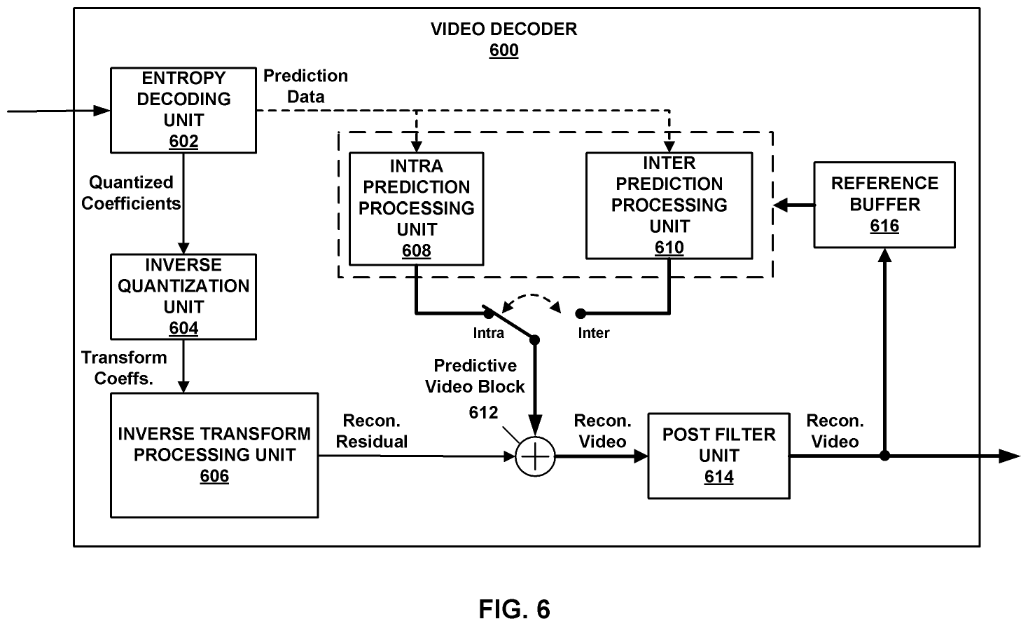

FIG. 6 is a block diagram illustrating an example of a video decoder that may be configured to decode video data according to one or more techniques of this disclosure (e.g., the decoding process for reference-picture list construction described above). In one example, video decoder 600 may be configured to decode transform data and re-construct residual data from transform coefficients based on decoded transform data. Video decoder 600 may be configured to perform intra prediction decoding and inter prediction decoding and, as such, may be referred to as a hybrid decoder. Video decoder 600 may be configured to parse any combination of the syntax elements described above in Tables 1-37. Video decoder 600 may decode a picture based on or according to the processes described above, and further based on parsed values in Tables 1-37.

In the example illustrated in FIG. 6, video decoder 600 includes an entropy decoding unit 602, inverse quantization unit 604, inverse transform processing unit 606, intra prediction processing unit 608, inter prediction processing unit 610, summer 612, post filter unit 614, and reference buffer 616. Video decoder 600 may be configured to decode video data in a manner consistent with a video coding system. It should be noted that although example video decoder 600 is illustrated as having distinct functional blocks, such an illustration is for descriptive purposes and does not limit video decoder 600 and/or sub-components thereof to a particular hardware or software architecture. Functions of video decoder 600 may be realized using any combination of hardware, firmware, and/or software implementations.

As illustrated in FIG. 6, entropy decoding unit 602 receives an entropy encoded bitstream. Entropy decoding unit 602 may be configured to decode syntax elements and quantized coefficients from the bitstream according to a process reciprocal to an entropy encoding process. Entropy decoding unit 602 may be configured to perform entropy decoding according any of the entropy coding techniques described above. Entropy decoding unit 602 may determine values for syntax elements in an encoded bitstream in a manner consistent with a video coding standard. As illustrated in FIG. 6, entropy decoding unit 602 may determine a quantization parameter, quantized coefficient values, transform data, and prediction data from a bitstream. In the example, illustrated in FIG. 6, inverse quantization unit 604 and transform processing unit 606 receives a quantization parameter, quantized coefficient values, transform data, and prediction data from entropy decoding unit 602 and outputs reconstructed residual data.

Referring again to FIG. 6, reconstructed residual data may be provided to summer 612. Summer 612 may add reconstructed residual data to a predictive video block and generate reconstructed video data. A predictive video block may be determined according to a predictive video technique (i.e., intra prediction and inter frame prediction). Intra prediction processing unit 608 may be configured to receive intra prediction syntax elements and retrieve a predictive video block from reference buffer 616. Reference buffer 616 may include a memory device configured to store one or more frames of video data. Intra prediction syntax elements may identify an intra prediction mode, such as the intra prediction modes described above. Inter prediction processing unit 610 may receive inter prediction syntax elements and generate motion vectors to identify a prediction block in one or more reference frames stored in reference buffer 616. Inter prediction processing unit 610 may produce motion com-pensated blocks, possibly performing interpolation based on interpolation filters.

Identifiers for interpolation filters to be used for motion estimation with sub-pixel precision may be included in the syntax elements. Inter prediction processing unit 610 may use interpolation filters to calculate interpolated values for sub-integer pixels of a reference block. Post filter unit 614 may be configured to perform filtering on reconstructed video data. For example, post filter unit 614 may be configured to perform deblocking and/or Sample Adaptive Offset (SAO) filtering, e.g., based on parameters specified in a bitstream. Further, it should be noted that in some examples, post filter unit 614 may be configured to perform proprietary discretionary filtering (e.g., visual enhancements, such as, mosquito noise reduction). As illustrated in FIG. 6, a reconstructed video block may be output by video decoder 600. In this manner, video decoder 600 represents an example of a device configured to parse an indication whether a coded picture includes exactly one slice and when the indication indicates that the coded picture includes exactly one slice, infer values of presence indicators in the picture header such that the inferred values indicate that one or more redundant syntax elements in the picture header are included in the slice header.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL.), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Moreover, each functional block or various features of the base station device and the terminal device used in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alter-natively, the processor may be a conventional processor, a controller, a microcontroller or a state machine. The general-purpose processor or each circuit described above may be configured by a digital circuit or may be configured by an analogue circuit. Further. when a technology of making into an integrated circuit superseding integrated circuits at the present time appears due to advancement of a semiconductor technology, the integrated circuit by this technology is also able to be used.

Various examples have been described. These and other examples are within the scope of the following claims.

### CROSS REFERENCE

This Nonprovisional application claims priority under 35 U.S.C. § 119 on provisional Applications No. 62/926,299 on Oct. 25, 2019, No. 62/944,217 on Dec. 5, 2019 and No. 62/952,255 on Dec. 21, 2019, the entire contents of which are hereby incorporated by reference.

1. A device comprising one or more processors configured to:
receive a picture header, wherein the picture header includes information that is common for all slices of one coded picture associated with the picture header included in a picture unit;
parse a first syntax element in the picture header, wherein the first syntax element specifies whether luma mapping with chroma scaling is enabled for a current picture;
receive a slice header, wherein the slice header includes a flag that indicates if the picture header is included in the slice header; and
conditionally parse a second syntax element in the slice header based on a value of the first syntax element, wherein the second syntax element specifies whether luma mapping with chroma scaling is enabled for a current slice.

2. A device comprising one or more processors configured to:
generate a picture header, wherein the picture header includes information that is common for all slices of one coded picture associated with the picture header included in a picture unit;
generate a first syntax element in the picture header, wherein the first syntax element specifies whether luma mapping with chroma scaling is enabled for a current picture;
generate a slice header, wherein the slice header includes a flag that indicates if the picture header is included in the slice header; and
conditionally generate a second syntax element in the slice header based on a value of the first syntax element, wherein the second syntax element specifies whether luma mapping with chroma scaling is enabled for a current slice.

3. A non-transitory computer-readable recoding medium storing a program for making a computer:
receive a picture header, wherein the picture header includes information that is common for all slices of one coded picture associated with the picture header included in a picture unit;
parse a first syntax element in the picture header, wherein the first syntax element specifies whether luma mapping with chroma scaling is enabled for a current picture;
receive a slice header, wherein the slice header includes a flag that indicates if the picture header is included in the slice header; and
conditionally parse a second syntax element in the slice header based on a value of the first syntax element, wherein the second syntax element specifies whether luma mapping with chroma scaling is enabled for a current slice.

4. The device of claim 1, wherein the device is a video decoder.

5. The device of claim 2, wherein the device is a video encoder.
